(19) United States
(12) Patent Application Publication
(10) Pub. No.: US 2026/0132913 A1
(43) Pub. Date: May 14, 2026

(54) ADAPTERS FOR STRUCTURAL CEILINGS OR FOR WOOD CEILINGS

(71) Applicant: AMP Plus, Inc., Vernon, CA (US)

(72) Inventor: Brandon Cohen, Vernon, CA (US)

(73) Assignee: AMP Plus, Inc., Vernon, CA (US)

(21) Appl. No.: 19/434,778

(22) Filed: Dec. 29, 2025

Related U.S. Application Data
(63) Continuation-in-part of application No. 19/057,375, filed on Feb. 19, 2025.
(63) Continuation-in-part of application No. 19/020,672, filed on Jan. 14, 2025.
(63) Continuation-in-part of application No. 29/894,010, filed on Jun. 5, 2023, now Pat. No. D1108685.
(63) Continuation-in-part of application No. 29/962,228, filed on Sep. 10, 2024, now Pat. No. D1108686.
(63) Continuation-in-part of application No. 29/981,337, filed on Dec. 30, 2024, now Pat. No. D1108687.
(63) Continuation-in-part of application No. 18/597,114, filed on Mar. 6, 2024.

(51) Int. Cl. F21V 21/04

(52) U.S. Cl. CPC F21V 21/049

(57) ABSTRACT

Adapters are used in recessed lighting applications with structural ceilings, such as, but not limited to, wood ceilings. The adapters are configured to be attached to a structural ceiling and to also be attached to a flangeless-trim-subassembly. A light module may be attached to the flangeless-trim-subassembly (that is attached to an adapter that is attached to a structural ceiling). The adapters are further configured to provide for some vertical adjustment as between the structural ceiling and the flangeless-trim-subassembly, which permits the adapters to be used on variety of ceilings with different thicknesses. The adapters may use vertical slots to achieve the vertical adjustability. One embodiment of the adapter may use vertically slotted L-brackets; and another adapter embodiment may use vertical slots in a collar. Adapters may have overall circular, cylindrical, or rectangular prism shapes.

### PRIORITY NOTICE

The present application, a continuation-in-part (CIP) application, claims priority under 35 U.S.C. § 120 to U.S. Non-Provisional patent application Ser. No. 19/412,241 filed on Dec. 8, 2025, the disclosure of which is incorporated herein by reference in its entirety.

The present application, a continuation-in-part (CIP) application, claims priority under 35 U.S.C. § 120 to U.S. Non-Provisional patent application Ser. No. 19/057,375 filed on Feb. 19, 2025, the disclosure of which is incorporated herein by reference in its entirety.

The present application, a continuation-in-part (CIP) application, claims priority under 35 U.S.C. § 120 to U.S. Non-Provisional patent application Ser. No. 19/020,672 filed on Jan. 14, 2025, the disclosure of which is incorporated herein by reference in its entirety.

The present application, a continuation-in-part (CIP) application, claims priority under 35 U.S.C. § 120 to U.S. Non-Provisional patent application Ser. No. 18/597,114 filed on Mar. 6, 2024, the disclosure of which is incorporated herein by reference in its entirety.

The present application, a continuation-in-part (CIP) application, claims priority under 35 U.S.C. § 120 to U.S. Non-Provisional patent application Ser. No. 29/894,010 filed on Jun. 5, 2023, the disclosure of which is incorporated herein by reference in its entirety.

The present application, a continuation-in-part (CIP) application, claims priority under 35 U.S.C. § 120 to U.S. Non-Provisional patent application Ser. No. 29/962,228 filed on Sep. 10, 2024, the disclosure of which is incorporated herein by reference in its entirety.

The present application, a continuation-in-part (CIP) application, claims priority under 35 U.S.C. § 120 to U.S. Non-Provisional patent application Ser. No. 29/981,337 filed on Dec. 30, 2024, the disclosure of which is incorporated herein by reference in its entirety.

### CROSS REFERENCE TO RELATED PATENTS

The disclosures and teachings of the following U.S. patents, by the same inventor as the present patent application, are all incorporated by reference as if fully set forth herein: D935082; U.S. Pat. Nos. 10,914,465; 11,092,326; 11,300,259; 11,466,849; 11,668,458; 11,662,084; 11,649,954; and 12,066,175.

### TECHNICAL FIELD OF THE INVENTION

The present invention relates in general to trimless recessed lighting applications/installations and more specifically to trimless recessed lighting applications/installations in wood ceilings (structural ceilings) by using adapters.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

A recessed lighting application is when a light module is installed above a given ceiling (so as to provide light below that ceiling); and such a recessed lighting application may be trimmed or trimless. A trimmed application is when there is a trim member that delineates and covers over a boundary between the given ceiling and a hole cut into that ceiling to install the light module. A given trim member is typically a flange, with a circular annulus shape or a rectangular annulus shape. And a trimless application is when there is no trim member delineating and covering over the boundary between the given ceiling and a hole cut into that ceiling to install the light module. A trimmed install can often hide imperfections created by the installer (e.g., cutting a hole in the ceiling that may be too large and/or of an unusual shape). Whereas, trimless installs require the installer to more careful, since there will not be a trim member to cover over imperfections. Additionally, when the given ceiling is drywall, imperfections in a given trimless recessed lighting installation may often be covered over by use of plaster (mud) (and sanding).

However, circa 2025, trimless recessed lighting installations in wood ceilings are notoriously difficult, requiring precise and accurate work by the installer, because with a wood ceiling then plaster (mud) will not be used to cover over imperfections; and because a given wood ceiling may have a different thickness from another wood ceiling (i.e., there is less ceiling thickness uniformity among wood ceiling as compared to drywall ceilings; whereas, drywall ceilings are typically uniform from one ceiling to another because of uniformity in drywall; e.g., drywall ceilings are often one of two different sizes [e.g., ⅝ of an inch or ½ an inch]).

There is a need in the art for an adapter - for use in trimless recessed lighting installations in wood ceilings (structural ceilings) - that may be attached to a top (upper) side (surface) of a given wood ceiling (structural ceiling), such that attachment of the adapter to the given wood ceiling (structural ceiling) is not visible from an observer located directly beneath that given wood ceiling (structural ceiling), wherein that adapter may also be attached to given flangeless-trim-subassembly (that may receive a light module), and wherein that adapter is configured to permit some vertical adjustability as between an attached flangeless-trim-subassembly and that given attached wood ceiling (structural ceiling); wherein that vertical adjustability feature of the adapter permits the adapter to accommodate to be used on different thicknesses of wood ceilings (structural ceilings) and/or of different sized flangeless-trim-subassemblies.

It is to these ends that the present invention has been developed.

### BRIEF SUMMARY OF THE INVENTION

To minimize the limitations in the prior art, and to minimize other limitations that will be apparent upon reading and understanding the present specification, the present invention may describe various embodiments of adapters that are configured for use in recessed lighting applications with structural ceilings, such as, but not limited to, wood ceilings; i.e., wherein structural ceilings may be ceilings capable of accepting direct attachment of objects used in recessed lighting applications without placing an undue strain upon the given ceiling. For example, a drywall ceiling would not be a structural ceiling in at least some embodiments. In some embodiments, the adapters are configured to be attached to a structural ceiling and the adapters are also configured to be attached to a flangeless-trim-subassembly. A light module may be attached to the flangeless-trim-subassembly (that is attached to an adapter that is attached to a structural ceiling). In some embodiments, a given adapter may be attached to a top (upper) side (surface) of a given structural ceiling, such that how the adapter is attached to that given structural ceiling would not be visible from an observer located directly beneath that given structural ceiling. In some embodiments, the adapters are further configured to provide for some vertical adjustment as between the structural ceiling and the flangeless-trim-subassembly, which permits the adapters to be used on a variety of ceilings with different thicknesses and/or provides use with a variety of different sized flangeless-trim-subassemblies. In some embodiments, the adapters may use vertical slots to achieve the vertical adjustability (and mechanical-fasteners, such as, but not limited to, screws, bolts, or the like). One embodiment of the adapter may use vertically slotted L-brackets; and another adapter embodiment may use vertical slots in a collar member that may be vertically adjusted against a flange-with-collar-member of that adapter. In some embodiments, adapters may have overall circular, cylindrical, or rectangular prism shapes (to accommodate and/or match the same or similar overall shapes of flangeless-trim-subassemblies).

In some embodiments, an adapter may be configured to be (removably) attached to a given flangeless-trim-subassembly; and/or that adapter may be configured to be (removably) attached to at least a section (region/portion) of a given structural-ceiling (e.g., by an access hole cut into that structural-ceiling). In some embodiments, the structural-ceiling may be at least partially made out of wood. In some embodiments, the structural-ceiling may be a wood ceiling. In some embodiments, the adapter may comprise one sleeve (cylindrical or rectangular prism shaped) and at least one L-bracket (with vertical slot). In some embodiments, the adapter may comprise one sleeve, at least one L-bracket, and at least one mechanical-fastener. In some embodiments, a portion (first-portion or horizontal-portion) of the L-bracket may be fixedly attached to a top (upper) side (surface) of the structural-ceiling.

In some embodiments, an adapter may be configured to be (removably) attached to a flangeless-trim-subassembly, wherein that adapter and that flangeless-trim-subassembly are vertically adjustable with respect to each other); and/or that adapter may be configured to be (removably and fixedly) attached to at least a section (region/portion) of a given structural-ceiling. In some embodiments, the adapter may comprise one flange-with-collar-member and one adjustable-collar-member. In some embodiments, the flange-with-collar-member and the adjustable-collar-member may be two separate and different component parts of a given adapter. In some embodiments, the adapter may comprise one flange-with-collar-member, one adjustable-collar-member, and at least one mechanical-fastener. In some embodiments, a flange-region, of the flange-with-collar-member, may be fixedly attached to a top (upper) side (surface) of the structural-ceiling (thus, the flange-with-collar-member may not move with respect to the structural-ceiling). In some embodiments, the adjustable-collar-member may comprise vertical-slot(s) used for attachment, and for some vertical adjustability, to a collar-region of the flange-with-collar-member (thus, the adjustable-collar-member may move vertically with respect to the flange-with-collar-member and/or with respect to the structural-ceiling, when the flange-with-collar-member is fixedly attached to the structural-ceiling). In some embodiments, the flange-with-collar-member and/or the adjustable-collar-member may have circular, cylindrical, and/or rectangular-prism shapes (to accommodate and/or match the same or similar overall shapes of flangeless-trim-subassemblies).

It is an objective of the present invention to provide adapters for use in trimless recessed lighting installations in wood ceilings and/or in structural ceilings.

It is another objective of the present invention to provide an adapter for use in trimless recessed lighting installations in wood ceilings and/or in structural ceilings, wherein the adapter is configured for vertical adjustability as between an attached structural ceiling and an attached flangeless-trim-subassembly.

It is another objective of the present invention to provide an adapter for use in trimless recessed lighting installations in wood ceilings and/or in structural ceilings, wherein the adapter is configured for vertical adjustability as between an attached structural ceiling and an attached flangeless-trim-subassembly, wherein the vertical adjustability is for accommodating structural ceilings of different thicknesses and/or for accommodating flangeless-trim-subassemblies of different sizes.

It is another objective of the present invention to provide an adapter for use in trimless recessed lighting installations in wood ceilings and/or in structural ceilings, wherein the adapter may have a round, circular, cylindrical, and/or rectangular prism shape (and/or form factor).

It is another objective of the present invention to provide an adapter for use in trimless recessed lighting installations in wood ceilings and/or in structural ceilings, wherein at least some portion of the adapter may serve (function) as a template for forming (cutting) an appropriately shaped and size hole in the given ceiling.

It is another objective of the present invention to provide an adapter for use in trimless recessed lighting installations in wood ceilings and/or in structural ceilings, wherein the adapter may be relatively easy and/or affordable to manufacture (e.g., as compared to prior art alternatives, if any).

It is yet another objective of the present invention to provide an adapter for use in trimless recessed lighting installations in wood ceilings and/or in structural ceilings, wherein the adapter may be relatively easy for an installer to utilize (e.g., as compared to prior art alternatives, if any).

These and other advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1A is bottom-up perspective view (bottom perspective view) of an assembly (with an adapter and with a flangeless-trim-subassembly) according to at least one embodiment.

FIG. 1B is a right-side view (or a left-side view) of the assembly of FIG. 1A.

FIG. 1C is a front-side view (or a rear-side view) of assembly of FIG. 1A.

FIG. 1D may be a top view of assembly of FIG. 1A.

FIG. 1E may be a bottom view of assembly of FIG. 1A.

FIG. 2A is a bottom perspective exploded view of the assembly of FIG. 1A that shows the flangeless-trim-subassembly (as its own assembly and in its assembled configuration) being removed from the adapter; and with showing the adapter in a dissembled configuration.

FIG. 2B is a front exploded view (or rear exploded view) of the assembly of FIG. 1A that shows the flangeless-trim-subassembly (as its own assembly and in its assembled configuration) being removed from the adapter; and with showing the adapter in the dissembled configuration.

FIG. 2C may be a top exploded view of the assembly of FIG. 1A that shows the flangeless-trim-subassembly (as its own assembly and in its assembled configuration) being removed from the adapter; and with showing the adapter in the dissembled configuration.

FIG. 3A is a right-side view (or left-side view) of the assembly of FIG. 1A wherein that assembly is shown fixedly attached to a section (portion and/or region) of a ceiling (a structural-ceiling or a wood-ceiling); and FIG. 3A also includes a sectional-line 3B-3B.

FIG. 3B is a cross-sectional view through the sectional-line 3B-3B of FIG. 3A.

FIG. 4A is a top-down perspective view (top perspective view) of the adapter of the assembly of FIG. 1A (and shown without any flangeless-trim-subassembly).

FIG. 4B is a top-down perspective exploded view (top perspective exploded view) of the adapter of FIG. 4A (and of FIG. 1A).

FIG. 4C is a cross-sectional view through the adapter of FIG. 4A (and of FIG. 1A).

FIG. 5A is top perspective view of an assembly (with an adapter and with a flangeless-trim-subassembly) according to at least one embodiment herein; wherein the assembly of FIG. 5A is different from the assembly of FIG. 1A.

FIG. 5B is bottom perspective view of the assembly of FIG. 5A.

FIG. 5C is right-side view (or a left-side view) of the assembly of FIG. 5A.

FIG. 5D is a front view (or a rear view) of the assembly of FIG. 5A.

FIG. 5E is a top view of the assembly of FIG. 5A.

FIG. 5F is a bottom view of the assembly of FIG. 5A.

FIG. 6A is top perspective exploded view of the assembly of FIG. 5A, showing the adapter separated from the flangeless-trim-subassembly, showing the adapter in a dissembled configuration, and showing the flangeless-trim-subassembly still in its assembled configuration.

FIG. 6B is a front exploded view (or a rear exploded view) of the assembly of FIG. 5A, showing the adapter separated from the flangeless-trim-subassembly, showing the adapter in the dissembled configuration, and showing the flangeless-trim-subassembly still in its assembled configuration.

FIG. 6C is a top exploded view of the assembly of FIG. 5A, showing the adapter separated from the flangeless-trim-subassembly, showing the adapter in the dissembled configuration, and showing the flangeless-trim-subassembly still in its assembled configuration.

FIG. 7A is a right-side view (or left-side view) of the assembly of FIG. 5A wherein the assembly is fixedly attached to a section (portion and/or region) of a ceiling (a structural-ceiling or a wood-ceiling); and FIG. 7A also includes a sectional-line 7B-7B.

FIG. 7B is a cross-sectional view through the sectional-line 7B-7B of FIG. 7A.

FIG. 8A is a top perspective view of an adapter-assembly according to at least one embodiment.

FIG. 8B is a top view of the adapter-assembly of FIG. 8A.

FIG. 8C is a right-side view (or a left-side view) of the adapter-assembly of FIG. 8A.

FIG. 9A is a top perspective exploded view of the adapter-assembly of FIG. 8A that shows an annular-disk (flange-with-collar-member), an adjustable-collar (adjustable-collar-member), mechanical-fastener(s), and/or a dust-cover separated (dissembled) from each other.

FIG. 9B is a right-side exploded view (or a left-side exploded view) of the adapter-assembly of FIG. 8A.

FIG. 9C is a front exploded view (or a rear exploded view) of the adapter-assembly of FIG. 8A.

FIG. 10A is a top perspective view of an assembly, with the adapter-assembly of FIG. 8A and with a flangeless-trim-subassembly, according to at least one embodiment.

FIG. 10B is a right-side view (or a left-side view) of the assembly of FIG. 10A.

FIG. 10C is a front view (or a rear view) of the assembly of FIG. 10A.

FIG. 10D is a top view of the assembly of FIG. 10A.

FIG. 11A is a top perspective exploded view of the assembly of FIG. 10A showing the adapter-assembly of FIG. 8A in a dissembled configuration (without a dust-cover) and showing the flangeless-trim-assembly of FIG. 10A in an assembled configuration but separated from the adapter-assembly of FIG. 8A components.

FIG. 11B is a front exploded view (or a rear exploded view) of the assembly of FIG. 10A showing the adapter-assembly of FIG. 8A in a dissembled configuration (without a dust-cover) and showing the flangeless-trim-assembly of FIG. 10A in an assembled configuration but separated from the adapter-assembly of FIG. 8A components.

FIG. 11C is a right-side exploded view (or a left-side exploded view) of the assembly of FIG. 10A showing the adapter-assembly of FIG. 8A in a dissembled configuration (without a dust-cover) and showing the flangeless-trim-assembly of FIG. 10A in an assembled configuration but separated from the adapter-assembly of FIG. 8A components.

FIG. 12A is a right-side view (or left-side view) of the assembly of FIG. 10A wherein this assembly is fixedly attached to a section (portion and/or region) of a ceiling (a structural ceiling and/or a wood ceiling); FIG. 12A also includes sectional-line 12B-12B.

FIG. 12B is a cross-sectional view through the sectional-line 12B-12B of FIG. 12A.

FIG. 13A is a top perspective view of an adapter-assembly according to at least one embodiment (wherein the adapter-assembly of FIG. 13A is different from the adapter-assembly of FIG. 8A).

FIG. 13B is a top view of the adapter-assembly of FIG. 13A.

FIG. 13C is a right-side view (or a left-side view) of the adapter-assembly of FIG. 13A.

FIG. 14A is a top perspective exploded view of the adapter-assembly of FIG. 13A that shows an annular-disk (flange-with-collar-member), an adjustable-collar (adjustable-collar-member), mechanical-fastener(s), and/or a dust-cover separated (dissembled) from each other.

FIG. 14B is a right-side exploded view (or a left-side exploded view) of the adapter-assembly of FIG. 13A.

FIG. 15A is a top perspective view of an assembly, with the adapter-assembly of FIG. 13A and with a flangeless-trim-subassembly, according to at least one embodiment.

FIG. 15B is a right-side view (or a left-side view) of the assembly of FIG. 15A.

FIG. 15C is a front view (or a rear view) of the assembly of FIG. 15A.

FIG. 15D is a top view of the assembly of FIG. 15A.

FIG. 16A is a top perspective exploded view of the assembly of FIG. 15A showing the adapter-assembly of FIG. 13A in a dissembled configuration (and without its optional dust-cover) and showing the flangeless-trim-assembly of FIG. 15A in an assembled configuration but separated from the adapter-assembly of FIG. 13A components.

FIG. 16B is a front exploded view (or a rear exploded view) of the assembly of FIG. 15A.

FIG. 16C is a right-side exploded view (or a left-side exploded view) of the assembly of FIG. 15A.

FIG. 17A is a right-side view (or left-side view) of the assembly of FIG. 15A wherein this assembly is fixedly attached to a section (portion and/or region) of a ceiling (a structural ceiling and/or a wood ceiling); FIG. 17A also includes sectional-line 17B-17B.

FIG. 17B is a cross-sectional view through the sectional-line 17B-17B of FIG. 17A.

### REFERENCE NUMERAL SCHEDULE

100 assembly 100
101 flangeless-trim-subassembly 101
103 reflector 103
105 spring-clip(s) 105
300 structural-ceiling (wood-ceiling) 300
301 thickness-of-ceiling 301
302 cutout/hole 302
303 mechanical-fastener(s) 303
400 adapter (adapter-for-structural-ceiling) 400
401 cylindrical-sleeve 401
403 L-bracket(s) 403
405 mechanical-fastener(s) 405
407 horizontal-slot(s) 407
409 vertical-slot(s) 409
411 top 411
413 bottom 413
415 sidewall 415
417 upper-sidewall 417
419 lower-sidewall 419
421 transition 421
423 horizontal-portion 423
425 vertical-portion 425
427 linkage-portion 427
429 through-hole 429
431 width 431
433 vertical-slot 433
500 assembly 500
501 adapter (adapter-for-structural-ceiling) 501
503 rectangular-prism-sleeve 503
505 top 505
507 bottom 507
509 sidewall(s) 509
511 internal-volume 511
513 aperture 513
514 aperture 514
515 L-bracket 515
517 horizontal-portion 517
519 through-hole 519
521 vertical-portion 521
523 width 523
525 vertical-slot 525
527 linkage-portion 527
529 mechanical-fastener(s) 529
551 flangeless-trim-subassembly 551
553 holder-for-light-module 553
555 reflector 555
557 connector(s) 557
800 adapter-assembly (adapter) 800
801 annular-disk (flange-with-collar-member) 801
802 largest-and-centered-hole 802
803 aperture 803
805 collar 805
807 tab 807
809 hole 809
811 mechanical-fastener(s) 811
813 adjustable-collar (adjustable-collar-member) 813
815 upper-sidewall 815
817 lower-sidewall 817
818 ledge (step) 818
819 tab (protrusion) 819
821 (vertical) slot 821
823 guide (fence) 823
825 dust-cover 825
827 at least mostly closed surface 827
829 prong(s) 829
831 hole 831
1000 assembly-of-adapter-and-trim 1000
1001 flangeless-trim-assembly 1001
1003 articulation-means 1003
1005 holder-for-light-module 1005
1007 connector(s) 1007
1201 reflector 1201
1300 adapter-assembly (adapter) 1300
1301 annular-disk (flange-with-collar-member) 1301
1302 largest-and-centered-hole 1302
1303 aperture 1303
1305 collar 1305
1307 tab (material extension/projection) 1307
1309 hole 1309
1311 mechanical-fastener 1311
1313 adjustable-collar (adjustable-collar-member) 1313
1315 upper-sidewall 1315
1317 lower-sidewall 1317
1318 ledge (step) 1318
1319 tab (protrusion) 1319
1321 (vertical) slot 1321
1323 guide (fence) 1323
1324 window (cutout) 1324
1325 dust-cover 1325
1327 at least mostly closed surface 1327
1329 prong(s) 1329
1331 hole 1331
1500 assembly-of-adapter-and-trim 1500
1501 flangeless-trim-assembly 1501
1503 articulation-means 1503
1505 holder-for-light-module 1505
1507 connector(s) 1507
1701 reflector 1701

### DETAILED DESCRIPTION OF THE INVENTION

In the following discussion that addresses a number of embodiments and applications of the present invention, reference is made to the accompanying drawings that form a part thereof, where depictions are made, by way of illustration, of specific embodiments in which the invention may be practiced. It is to be understood that other embodiments may be utilized and changes may be made without departing from the scope of the invention.

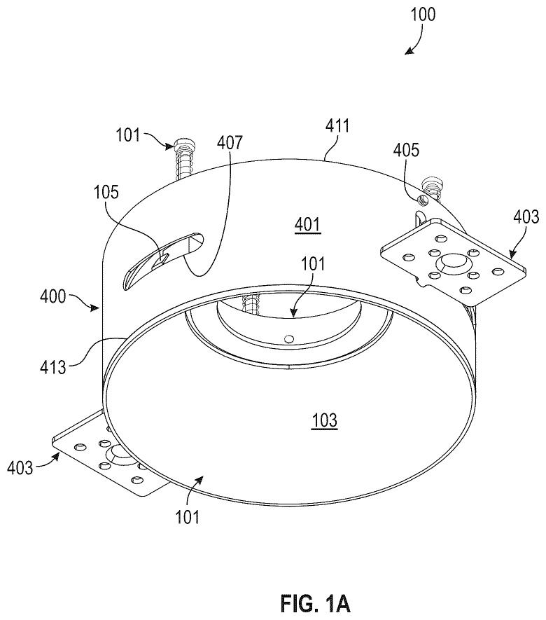

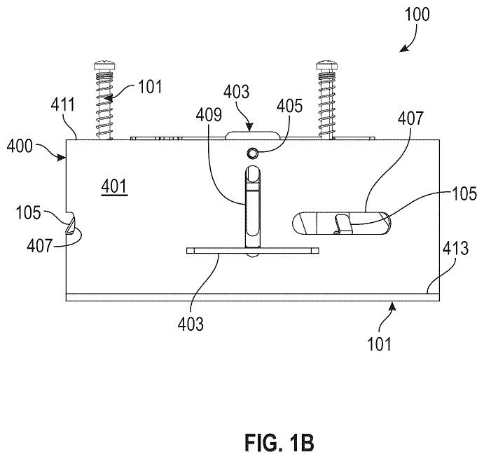

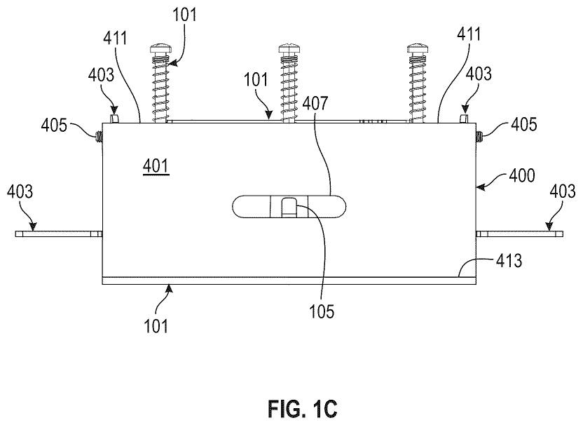

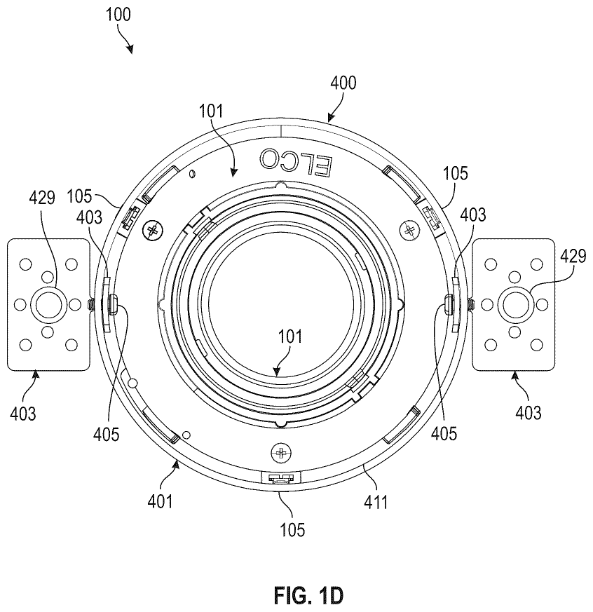

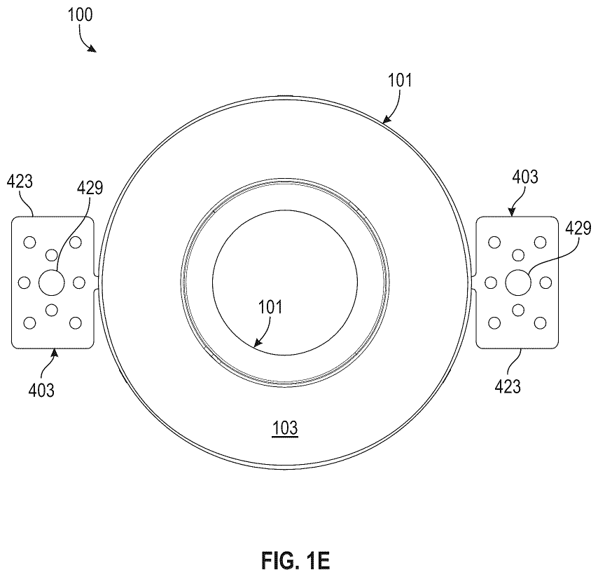

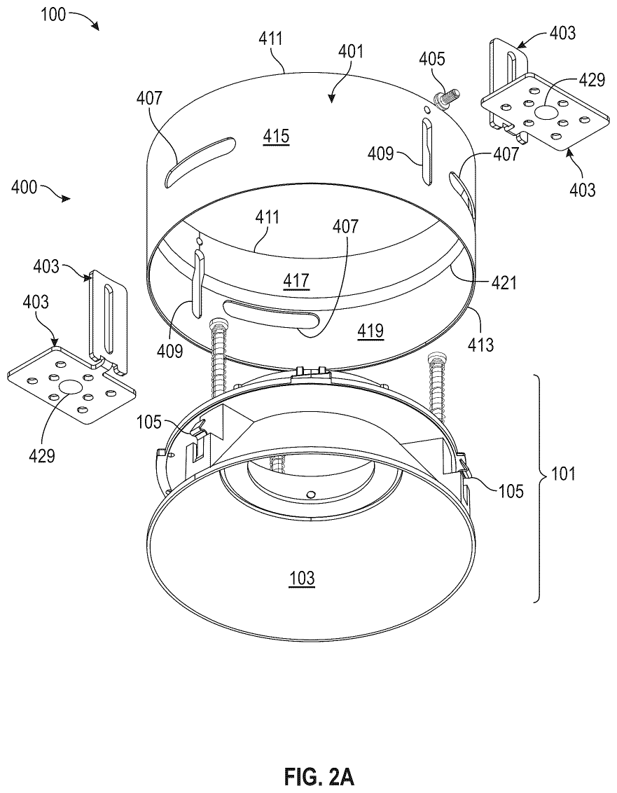

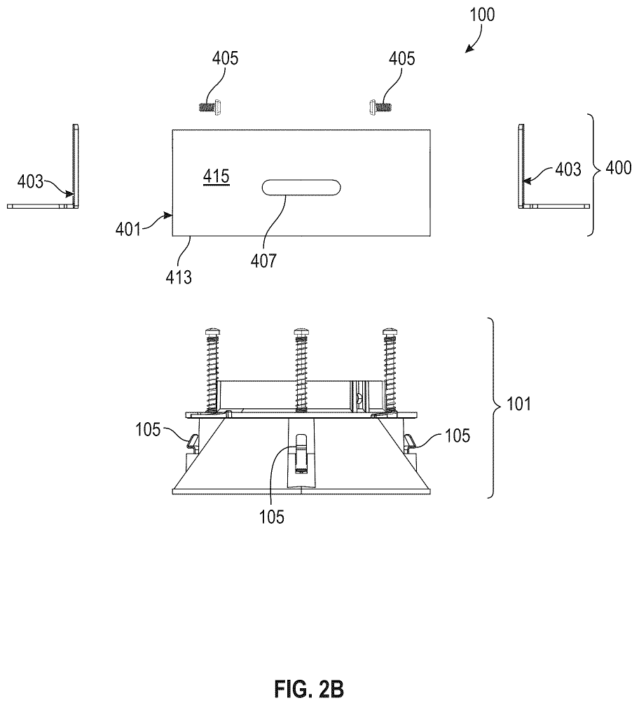

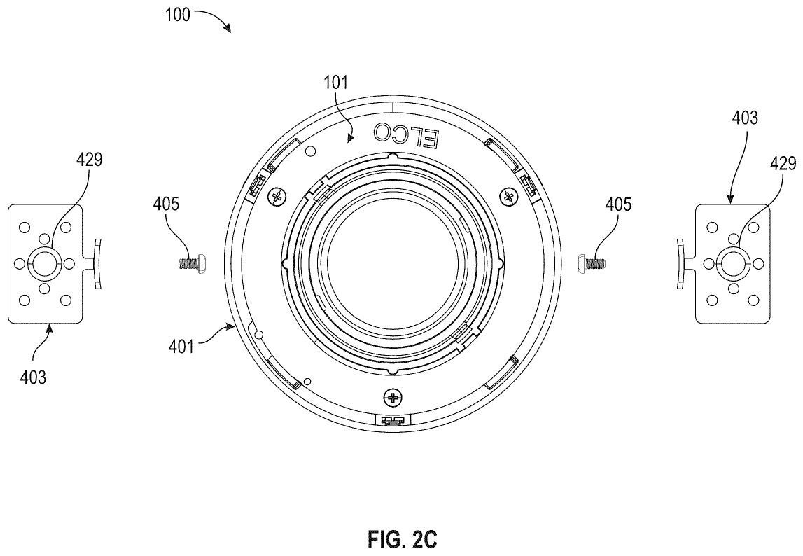

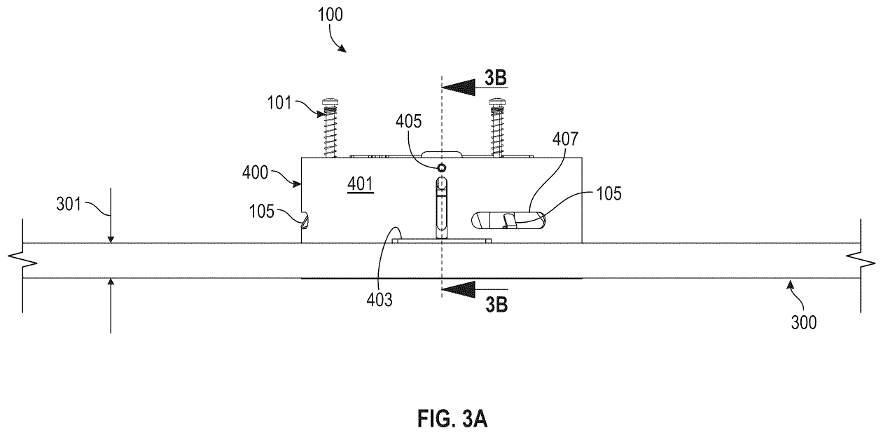

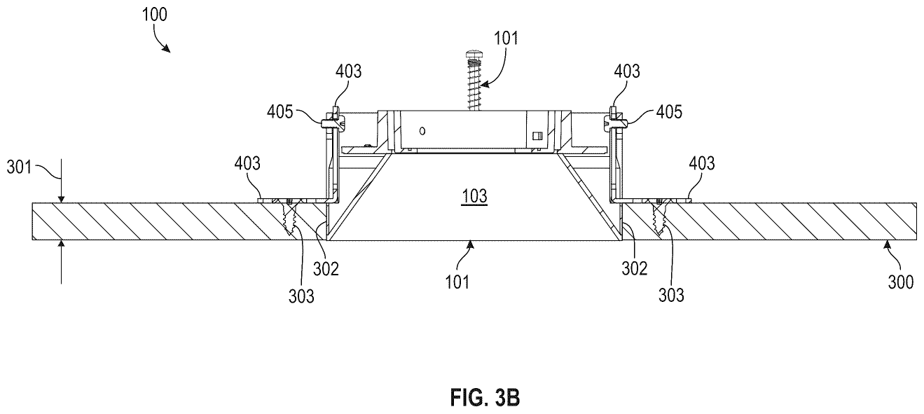

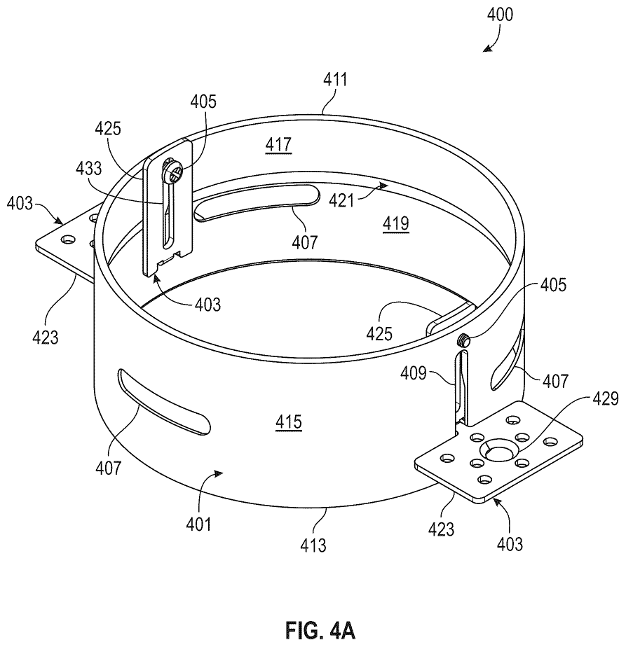

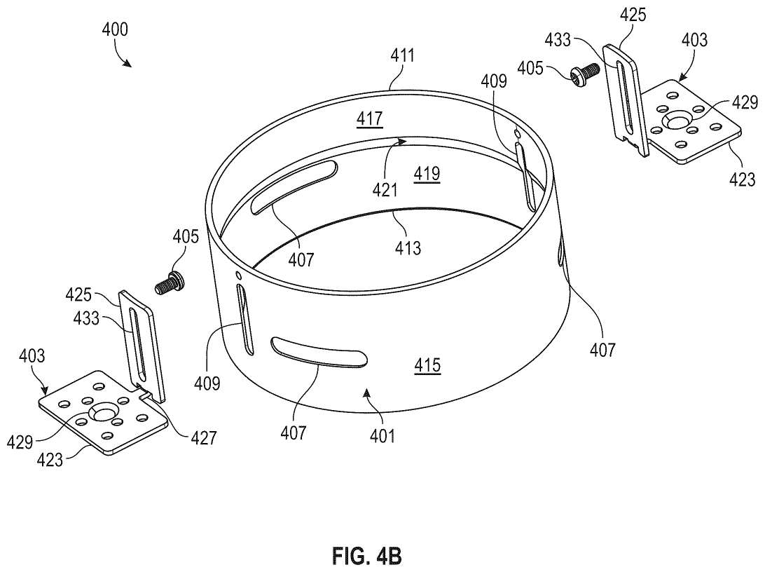

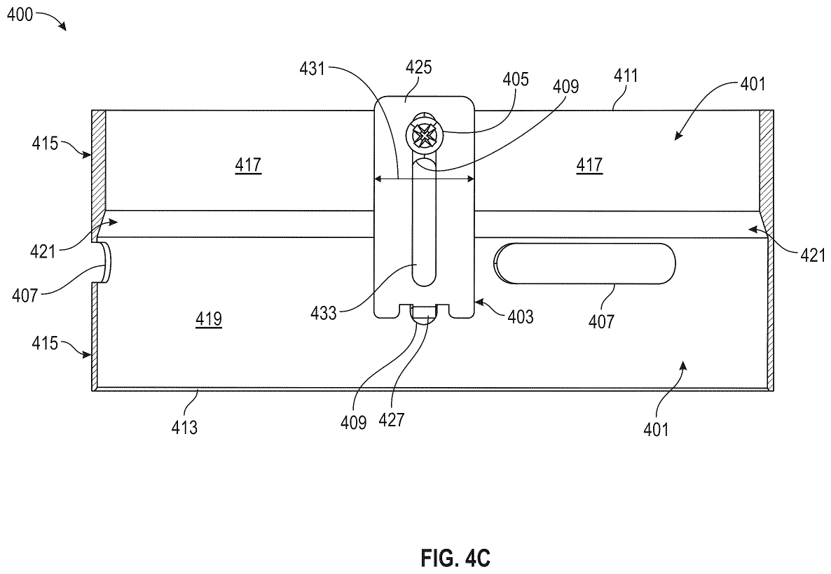

FIG. 1A is bottom-up perspective view (bottom perspective view) of an assembly 100 according to at least one embodiment. In some embodiments, assembly 100 may comprise a flangeless-trim-subassembly 101 and an adapter 400. In some embodiments, adapter 400 may be shown by itself in FIG. 4A to FIG. 4C. In some embodiments, adapter 400 may be an assembly itself. In some embodiments, adapter 400 may permit (facilitate) use of flangeless-trim-subassembly 101 on a given ceiling 300 that may be thicker than typical drywall ceiling and/or wherein ceiling 300 may comprise a structural sheet material (e.g., wood) as shown in FIG. 3A and in FIG. 3B. FIG. 2A to FIG. 2C may show assembly 100 in various exploded views.

Note in some embodiments, the “flangeless-trim-subassembly 101” shown and described in this present (instant) patent application may be a combination of a “reflector 223” and “holding-plate 241 (mounting-plate 241)” and/or may be a “trim 321” as shown and described in U.S. utility Pat. No. 11,662,084. U.S. utility Pat. No. 11,662,084 is incorporated by reference to the present (instant) patent application as if fully set-forth herein. In some embodiments, flangeless-trim-subassembly 101 may be used in ceiling recessed lighting applications when the desired installation finish is one of a flangeless-trim; that is, such that from an observer located below a given ceiling only the ceiling, a reflector, and at least a portion of a light-source (or lens or the like) may be visible, and without there being a flanged-trim member present or visible. In some embodiments, flangeless-trim-subassembly 101 may be configured to receive and/or to be attached to a given light-source (such as, but not limited to, “lighting module assembly 500” from U.S. utility Pat. No. 11,662,084). In some embodiments, flangeless-trim-subassembly 101 may be an assembly by itself. In some embodiments, adapter 400 may replace a “spackle-frame 201” from U.S. utility Pat. No. 11,662,084.

Continuing discussing FIG. 1A, in some embodiments, flangeless-trim-subassembly 101 may comprise reflector 103 and spring-clips 105. In some embodiments, the spring-clips 105 of flangeless-trim-subassembly 101 may be how flangeless-trim-subassembly 101 may be (removably) attached to adapter 400 to form assembly 100. In some embodiments, the spring-clips 105 of flangeless-trim-subassembly 101 may be “clips 239” of U.S. utility Pat. No. 11,662,084. In some embodiments, adapter 400 may comprise at least one horizontal slot horizontal-slot(s) 407 that may be configured to receive (removable) attachment from at least one spring-clip 105 of flangeless-trim-subassembly 101. In some embodiments, adapter 400 may comprise at least two L-brackets 403. In some embodiments, L-bracket 403 may be configured to be fixedly attached to ceiling 300 and to be slidingly attached to cylindrical-sleeve 401 of adapter 400, wherein adapter 400 may comprise cylindrical-sleeve 401. In some embodiments, it may be the cylindrical-sleeve 401 portion of adapter 400 that may comprise at least one horizontal slot horizontal-slot(s) 407.

FIG. 1B may be a right-side view (or a left-side view) of assembly 100. In some embodiments, a given L-bracket 403 may engage (physically interact) with cylindrical-sleeve 401 (of adapter 400) via a given vertical-slot 409 of cylindrical-sleeve 401 (and/or of adapter 400); wherein adapter 400 and/or cylindrical-sleeve 401 may comprise a vertical-slot 409 for each L-bracket 403 of adapter 400. FIG. 1B may show two separate and distinct horizontal-slots 407 (of cylindrical-sleeve 401), that may be (removably) receiving a separate and distinct spring-clip 105 of flangeless-trim-subassembly 101. In some embodiments, cylindrical-sleeve 401 may be constructed (manufacturer) with a quantity of horizontal-slot(s) 407 to match a quantity of spring-clips 105 in a given flangeless-trim-subassembly 101 (on a 1:1 correspondence basis).

FIG. 1C may be a front-side view (or a rear-side view) of assembly 100. In some embodiments, a given L-bracket 403 may be (removably) attached to cylindrical-sleeve 401 (of adapter 400) via at least one mechanical-faster 405; wherein adapter 400 may comprise at least one mechanical-fastener 405 for each L-bracket 403 and/or for each vertical-slot 409. FIG. 1C also shows that a portion of each L-bracket 403 may reside within an interior-volume of cylindrical-sleeve 401 and/or that a portion of a given L-bracket 403 may extend beyond a top 411 of cylindrical-sleeve 401. In some embodiments, when a given mechanical-fastener 405 is not completely tightened, a L-bracket 403, that is in direct physical communication with that given mechanical-fastener 405, may slide up and down in its associated vertical-slot 409 of cylindrical-sleeve 401, which may permit (facilitate and/or enable) adapter 400 to be adjusted for fixed attachment to ceiling(s) 300 of different thicknesses.

FIG. 1D may be a top view of assembly 100. In FIG. 1D, flangeless-trim-subassembly 101 may have three separate and distinct spring-clips 105; and as such, then adapter 400 and/or cylindrical-sleeve 401 may comprise three separate and distinct horizontal-slots 407, one horizontal-slot 407 for each spring-clip 105 of flangeless-trim-subassembly 101. In some embodiments, when adapter 400 and/or cylindrical-sleeve 401 may comprise three separate and distinct horizontal-slots 407, then each (center of) horizontal-slot 407 may be separated from a center of a nearest horizontal-slot 407 by about 120 degrees (e.g., plus or minus five degrees). FIG. 1D also shows that a portion of each L-bracket 403 may reside within an interior-volume of cylindrical-sleeve 401. In some embodiments, adapter 400 and/or cylindrical-sleeve 401 may comprise two L-brackets 403 that are disposed opposite from each other on cylindrical-sleeve 401. FIG. 1D may also show one mechanical-fastener 405 for each L-bracket 403 and/or each vertical-slot 409. FIG. 1D may also show at least portions of a given mechanical-fastener 405 passing through a section of a given L-bracket 403 and also passing through a section of cylindrical-sleeve 401 (namely a given vertical-slot 409).

FIG. 1E may be a bottom view of assembly 100. FIG. 1E and FIG. 1D may be opposing views from each other. Note, cylindrical-sleeve 401 (of adapter 400) may not be visible in FIG. 1E as a bottom portion of reflector 103 may cover over a bottom of cylindrical-sleeve 401. When ceiling 300 is not present, then exterior portion of L-bracket(s) 403 of adapter 400 may be visible from a bottom view of assembly 100; however, the portions of L-bracket(s) 403 that may reside within the interior volume of cylindrical-sleeve 401 may not be visible from a bottom view of assembly 100 because reflector 103 may block their visibility.

FIG. 2A may be a bottom perspective exploded view of assembly 100 that shows flangeless-trim-subassembly 101 (as its own assembly and in its assembled configuration) being removed from adapter 400; and with showing adapter 400 in a dissembled configuration.

FIG. 2B may be a front exploded view (or rear exploded view) of assembly 100 that shows flangeless-trim-subassembly 101 (as its own assembly and in its assembled configuration) being removed from adapter 400; and with showing adapter 400 in a dissembled configuration.

FIG. 2C may be a top exploded view of assembly 100 that shows flangeless-trim-subassembly 101 (as its own assembly and in its assembled configuration) being removed from adapter 400; and with showing adapter 400 in a dissembled configuration.

FIG. 3A may be a right-side view (or left-side view) of assembly 100 wherein assembly 100 may be fixedly attached to a section (portion and/or region) of a ceiling 300. FIG. 3A also includes sectional-line 3B-3B.

In some embodiments, ceiling 300 may be other than a drywall ceiling; or ceiling 300 may be a drywall ceiling plus with at least one structural sheet material, such as, but not limited to, wood, plywood, engineered wood, laminated wood, OSB, particle board, a tile member, a siding member, a laminate member, and/or the like. Drywall ceilings may be relatively strong at handling shear loads but relatively weak at handling forces orthogonal to a plane of a drywall ceiling (although drywall by itself is generally not considered a structural member). For example, pushing or pulling in a direction that is orthogonal to a plane of drywall may break that drywall, whereas if a same magnitude of force were applied parallel to that plane of drywall, the drywall may handle that shear load. For example, drywall may often be able to handle a shear load of 100 pounds; whereas, if that same 100 pounds were applied in an orthogonal direction to a plane of the drywall member, that drywall member may easily break. Thus, in above drywall ceiling recessed lighting applications, light-fixtures, housings, frames, hanger-bars, and the like are typically not only directly mounted to drywall, but instead to structural members, such as, joists just above the given ceiling. In some embodiments, ceiling 300 may be configured to handle forces orthogonal to a plane in a manner that is a significant improvement over drywall ceilings. In some embodiments, ceiling 300 may comprise at least one structural component and/or material. Because ceiling 300 may comprise at least one structural component and/or material, such as, but not limited to, wood (and/or a wood product), ceiling 300 may be configured to accept loads (forces) that are orthogonal to a plane of ceiling 300 that a given drywall ceiling could not handle. Because ceiling 300 may comprise at least one structural component and/or material, such as, but not limited to, wood (and/or a wood product), ceiling 300 may accept direct attachment of at least one of trims, flangeless-trim-assemblies, light-fixtures, adapters (such as, but not limited to, adapter 400) and/or the like.

Discussing FIG. 3A, in some embodiments, adapter 400 may be configured to be (fixedly) attached to ceiling 300. In some embodiments, L-bracket(s) 403 may be configured to be (fixedly) attached to ceiling 300. In some embodiments, a bottom surface portion of L-bracket(s) 403 may be configured to be (fixedly) attached to a top surface of ceiling 300. In some embodiments, a bottom surface portion of L-bracket(s) 403 may be in direct physical contact with a top surface of ceiling 300. FIG. 3A shows a L-bracket 403 that is fixedly attached to ceiling 300. FIG. 3A shows a bottom surface portion of a given L-bracket 403 that is fixedly attached to a top portion of ceiling 300. FIG. 3A shows a bottom surface portion of a given L-bracket 403 is in direct physical contact with a top portion of ceiling 300. FIG. 3A shows a bottom surface portion of a given L-bracket 403 (of a given horizontal-portion 423) is in direct physical contact with a top portion of ceiling 300. Ceiling 300 may comprise a thickness 301. In some embodiments, thickness 301 (of ceiling 300) may be a same thickness as a drywall ceiling. In some embodiments, thickness 301 (of ceiling 300) may be similar to a thickness of a drywall ceiling. In some embodiments, thickness 301 (of ceiling 300) may be different to a thickness of a drywall ceiling. In some embodiments, thickness 301 (of ceiling 300) may be greater than a thickness of a drywall ceiling. In some embodiments, thickness 301 (of ceiling 300) may be less than a thickness of a drywall ceiling. In some embodiments, thickness 301 (of ceiling 300) may be the same, similar, or different than a drywall ceiling thickness. In the U.S. (circa 2025) common thicknesses for ceiling drywall are ½ inch or ⅝ inch (nominally). In some embodiments, thickness 301 (of ceiling 300) may be greater than ½ inch or greater than ⅝ inch.

FIG. 3B may be a cross-sectional view through sectional-line 3B-3B of FIG. 3A. FIG. 3B may show a cross-sectional view through assembly 100 and through a portion (section and/or region) of ceiling 300. FIG. 3B shows a bottom surface portion of a given L-bracket 403 is in direct physical contact with a top portion of ceiling 300. FIG. 3B shows a bottom surface portion of a given L-bracket 403 that is fixedly attached to a top portion of ceiling 300 using a mechanical-fastener 303. In some embodiments, assembly 100, flangeless-trim-subassembly 101, and/or adapter 400 may comprise at least one mechanical-fastener 303 per a quantity of L-bracket(s) 403 of adapter 400 and/or of cylindrical-sleeve 401. In some embodiments, mechanical-fastener 303 may fixedly attach a bottom surface portion of a given L-bracket 403 to a top portion of ceiling 300. In some embodiments, at least a portion of mechanical-fastener 303 may pass through the bottom portion of the given L-bracket 403; and another portion of mechanical-fastener 303 may pass into material of ceiling 300. In some embodiments, a total length of mechanical-fastener 303 may be configured to be less than thickness 301. In some embodiments, mechanical-fastener 303 may enter L-bracket 403 and ceiling 300 from a top (upper) side of ceiling 300. FIG. 3B shows mechanical-fasteners 303 are used to secure horizontal-portions 423 to a top portion of ceiling 300 (e.g., at least one mechanical-fastener 303 per each horizontal-portion 423). In some embodiments, mechanical-fastener 303 may not enter ceiling 300 and L-bracket 403 from a bottom (under) side of ceiling 300.

FIG. 3B may show cutout/hole 302, wherein cutout/hole 302 may be a cutout and/or a through hole cut into a given section (region and/or portion) of ceiling 300, by an installer, for a purpose of inserting adapter 400, flangeless-trim-subassembly 101, a light module, a portion thereof, combinations thereof, and/or the like, therein (through cutout/hole 302). In some embodiments, cutout/hole 302 may have a circular, cylindrical, and/or rectangular prism shape. In some embodiments, the installer may cut (form) cutout/hole 302 of a specific shape and/or size to specifically fit (accommodate) a given adapter, flangeless-trim-subassembly, a light module, a portion thereof, combinations thereof, and/or the like, therein. For example, and without limiting the scope of the present invention, cutout/hole 302 may be formed for fitting: assembly 100, flangeless-trim-subassembly 101, adapter 400, adapter 501, flangeless-trim-subassembly 551, adapter 800, assembly 1000, flangeless-trim-subassembly 1001, adapter 1300, assembly 1500, flangeless-trim-subassembly 1501, a light module, a portion thereof, combinations thereof, and/or the like, therein.

FIG. 4A is a top-down perspective view (top perspective view) of adapter 400 (and without showing flangeless-trim-subassembly 101). FIG. 4B is a top-down perspective exploded view (top perspective exploded view) of adapter 400 (and without showing flangeless-trim-subassembly 101). FIG. 4C is a cross-sectional view through adapter 400 (and without showing flangeless-trim-subassembly 101). In some embodiments, adapter 400 may be an assembly that comprise at least two different types of parts, namely, cylindrical-sleeve 401, and L-bracket(s) 403. In some embodiments, adapter 400 may be an assembly that comprise three different types of parts, namely, cylindrical-sleeve 401, L-bracket(s) 403, and mechanical-fastener(s) 405. In some embodiments, a given L-bracket 403 may be attached to cylindrical-sleeve 401. In some embodiments, L-bracket 403 may be attached to cylindrical-sleeve 401 using at least one mechanical-fastener 405.

Continuing discussing FIG. 4A, FIG. 4B, and FIG. 4C, in some embodiments, cylindrical-sleeve 401 may be a substantially (mostly) right-cylindrical member that is hollow, open at its top 411, and open at its bottom 413. In some embodiments, top 411 and bottom 413 may be disposed opposite from each other. In some embodiments, a surface of top 411 and a surface of bottom 413 may be parallel with from each other. In some embodiments, cylindrical-sleeve 401 may comprise a sidewall 415 that may be at least substantially (mostly) similar to a sidewall of a hollow right cylinder. In some embodiments, an exterior outside diameter of cylindrical-sleeve 401 and/or of sidewall 415 may be uniform, fixed, finite, and non-variable. In some embodiments, sidewall 415 may comprise an upper-sidewall 417 and a lower-sidewall 419 that are (integrally) joined (attached) to each other at transition 421. In some embodiments, upper-sidewall 417 may be located closer to top 411 than to bottom 413. In some embodiments, lower-sidewall 419 may be located closer to bottom 413 than to top 411. In some embodiments, upper-sidewall 417 may be cylindrical sidewall portion of cylindrical-sleeve 401 above transition 421 and/or above horizontal-slot(s) 407. In some embodiments, lower-sidewall 419 may be cylindrical sidewall portion of cylindrical-sleeve 401 below transition 421. In some embodiments, horizontal-slot(s) 407 may be located only (entirely) in the lower-sidewall 419; and not in the upper-sidewall 417. In some embodiments, upper-sidewall 417 and lower-sidewall 419 may have different heights from each other; however, each of their respective heights may be uniform, fixed, finite, predetermined, and/or non-variable. In some embodiments, lower-sidewall 419 may be taller than upper-sidewall 417. In some embodiments, an inside diameter of upper-sidewall 417 may be less than an inside diameter of lower-sidewall 419. In some embodiments, the inside diameter of upper-sidewall 417 may be different from the inside diameter of lower-sidewall 419; although, both inside diameters may be uniform, fixed, finite, predetermined, and non-variable. In some embodiments, the outside diameter of upper-sidewall 417 may be the same as the outside diameter of lower-sidewall 419; with both outside diameters being uniform, fixed, finite, predetermined, and non-variable. In some embodiments, transition 421 may be a region of sidewall 415 that transitions from lower-sidewall 419 to upper-sidewall 417. In some embodiments, transition 421 may be band of material of sidewall 415 where a thickness of sidewall 415 increases from lower-sidewall 419 to upper-sidewall 417. In some embodiments, transition 421 may be parallel with top 411 and/or with bottom 413. In some embodiments, transition 421 may not be visible on an exterior of sidewall 415; whereas, transition 421 may be visible on an interior of sidewall 415.

Continuing discussing FIG. 4A, FIG. 4B, and FIG. 4C, in some embodiments, cylindrical-sleeve 401 may comprise at least one horizontal-slot 407. In some embodiments, cylindrical-sleeve 401 may comprise a quantity of horizontal-slot(s) 407 that may match (equal) a quantity of spring-clips 105 of flangeless-trim-subassembly 101. For example, and without limiting the scope of the present invention, if flangeless-trim-subassembly 101 has three spring-clips 105, then cylindrical-sleeve 401 may have three horizontal-slots 407; whereas, if flangeless-trim-subassembly 101 has two spring-clips 105, then cylindrical-sleeve 401 may have two horizontal-slots 407. In some embodiments, horizontal-slots 407 may be spaced apart equally from each other on sidewall 415. In some embodiments, a given horizontal-slot 407 may be a slot of cylindrical-sleeve 401 (and/or of sidewall 415) that passes entirely through a thickness of cylindrical-sleeve 401, sidewall 415, and/or lower-sidewall 419. In some embodiments, horizontal-slot 407 is not located in upper-sidewall 417 nor in transition 421. In some embodiments, horizontal-slot 407 may not physically touch upper-sidewall 417 nor transition 421. In some embodiments, a given horizontal-slot 407 in its linear direction (length) may be perpendicular to a direction (length) of vertical-slot(s) 409. In some embodiments, horizontal-slot(s) 407 may be located entirely and/or only in lower-sidewall 419. In some embodiments, horizontal-slot(s) 407 may be located entirely below transition 421 and/or entirely below upper-sidewall 417. In some embodiments, a given horizontal-slot 407 may run linearly straight in a direction that is parallel with: a surface of bottom 413, a surface of top 411, and/or transition 421; but without physically touching: bottom 413, top 411, upper-sidewall 417, and/or transition 421. In some embodiments, a given horizontal-slot 407 may be configured to (removably) receive at least a portion of a given spring-clip 105 therein. In some embodiments, horizontal-slot 407 may provide a surface and/or structure for spring-clip 105 to anchor (grab) onto. In some embodiments, the slot form factor of horizontal-slot 407 versus a hole form factor, makes installation easier on the installer as there is more surface for spring-clips 105 to find and latch onto with the slots form factor versus a hole form factor.

Continuing discussing FIG. 4A, FIG. 4B, and FIG. 4C, in some embodiments, cylindrical-sleeve 401 may comprise at least one vertical-slot 409. In some embodiments, cylindrical-sleeve 401 may comprise two separate and distinct vertical-slots 409 that are separated from each other by 180 degrees on sidewall 415. In some embodiments, a given vertical-slot 409 may be a slot of cylindrical-sleeve 401 (and/or of sidewall 415) that passes entirely through a thickness of cylindrical-sleeve 401, sidewall 415, upper-sidewall 417, and/or lower-sidewall 419. In some embodiments, a given vertical-slot 409 in its linear direction (length) may be perpendicular to a direction (length) of horizontal-slot(s) 407. In some embodiments, a given vertical-slot 409 may run linearly straight in a direction from bottom 413 to top 411, but without touching bottom 413 and without touching top 411. In some embodiments, a given vertical-slot 409 may be configured to receive at least a portion of a given mechanical-fastener 405 therein. In some embodiments, a given vertical-slot 409 may be configured to receive at least a portion of a given L-bracket 403 (linkage 427) therein. In some embodiments, a given vertical-slot 409 may be located in both lower-sidewall 419 and in upper-sidewall 417. In some embodiments, no vertical-slot 409 may physically touch a given horizontal-slot 407.

Continuing discussing FIG. 4A, FIG. 4B, and FIG. 4C, in some embodiments, a given L-bracket 403 may comprise: a horizontal-portion 423, a vertical-portion 425, and a linkage-portion 427. In some embodiments, horizontal-portion 423 may be configured to being fixedly attached to ceiling 300 (e.g., via use of mechanical-fastener(s) 303). In some embodiments, horizontal-portion 423 may be at least substantially (mostly) horizontally oriented plate member with at least one through-hole 429. In some embodiments, a major plane of horizontal-portion 423 may be parallel with: a surface/plane of top 411, a surface/plane of bottom 413, a length of horizontal-slot(s) 407, and/or a top plane/surface of ceiling 300; although the major plane(s) of horizontal-portion 423 may not be coincident with: the surface/plane of top 411, the surface/plane of bottom 413, and/or the length of horizontal-slot(s) 407. In some embodiments, horizontal-portion 423 may comprise two major planes, namely, its top surface and its opposing bottom surface. In some embodiments, a major plane of horizontal-portion 423 may be perpendicular with the length of vertical-slot(s) 409. In some embodiments, horizontal-portion 423 may comprise at least one through-hole 429. In some embodiments, horizontal-portion 423 may comprise one or more through-holes 429. In some embodiments, through-hole 429 may be a through hole that passes entirely through a thickness of horizontal-portion 423. In some embodiments, through-hole 429 may be an entirely enclosed hole. In some embodiments, through-hole 429 may be configured to receive at least a portion of mechanical-fastener 303 therein. In some embodiments, when a given L-bracket 403 may be (removably) attached to cylindrical-sleeve 401, its horizontal-portion 423 may be located outside (exteriorly) of cylindrical-sleeve 401.

Continuing discussing FIG. 4A, FIG. 4B, and FIG. 4C, in some embodiments, vertical-portion 425 may be configured to being fixedly attached to sidewall 415 (e.g., via use of mechanical-fastener(s) 405); but when mechanical-fastener(s) 405 may be loose, vertical-portion 425 (and its L-bracket 403) may be vertically and slidingly adjusted with respect to sidewall 415. In some embodiments, vertical-portion 425 may be at least substantially (mostly) vertically oriented. In some embodiments, a length of vertical-portion 425 may be parallel with a length of vertical-slot(s) 409. In some embodiments, a length of vertical-portion 425 may be perpendicular (orthogonal) to a major plane of horizontal-portion 423. In some embodiments, when a given L-bracket 403 may be (removably) attached to cylindrical-sleeve 401, its vertical-portion 425 may be located inside of cylindrical-sleeve 401. In some embodiments, vertical-portion 425 may comprise a width 431 and may also comprise its own vertical-slot 433. In some embodiments, width 431 may be a width of vertical-portion 425. In some embodiments, width 431 may be uniform, fixed, finite, predetermined, and/or non-variable. In some embodiments, width 431 may be greater than a width of vertical-slot(s) 409 of cylindrical-sleeve 401; and width 431 may be greater than a width of vertical-slot 433 of vertical-portion 425. In some embodiments, vertical-slot 433 may be a vertical slot of vertical-portion 425. In some embodiments, vertical-slot 433 may be located entirely within vertical-portion 425. In some embodiments, a length of vertical-slot 433 may be parallel with a length of vertical-slot(s) 409. In some embodiments, when a given L-bracket 403 may be (fixedly) attached to a given cylindrical-sleeve 401, a length of vertical-slot 433 may be parallel with a length of vertical-slot(s) 409; and the length of vertical-slot 433 and the length of vertical-slot(s) 409 may be in vertical alignment with each other. In some embodiments, vertical-slot 433 may be configured to (removably) receive at least a portion of mechanical-fastener 405 therein.

Continuing discussing FIG. 4A, FIG. 4B, and FIG. 4C, in some embodiments, linkage-portion 427 may be configured to fixedly (and integrally) join horizontal-portion 423 to vertical-portion 425. In some embodiments, linkage-portion 427 may be located a bottom (and center) of a given L-bracket 403. In some embodiments, linkage-portion 427 may be a run of material that fixedly (and integrally) and physically joins the horizontal-portion 423 to the vertical-portion 425. In some embodiments, a width of linkage-portion 427 may be less than width 431. In some embodiments, horizontal-portion 423, vertical-portion 425, and linkage-portion 427 may be a single integral article of manufacture. In some embodiments, horizontal-portion 423, vertical-portion 425, and linkage-portion 427 may be all made from a same material(s) of construction as each other. In some embodiments, horizontal-portion 423, vertical-portion 425, and linkage-portion 427 may be all be rigid.

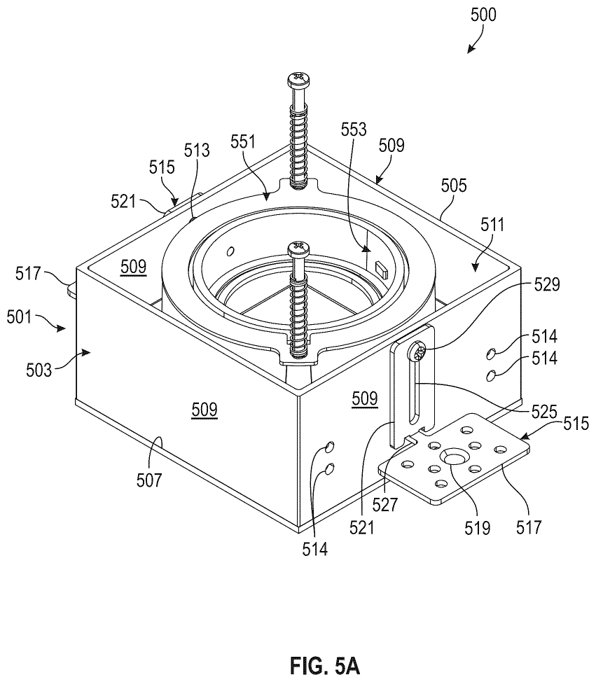

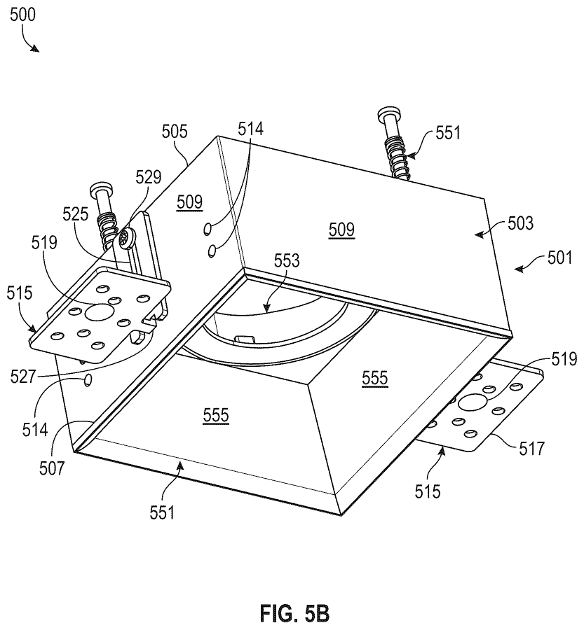

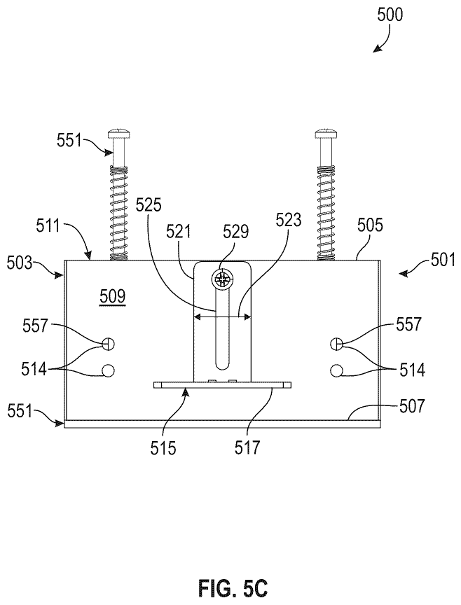

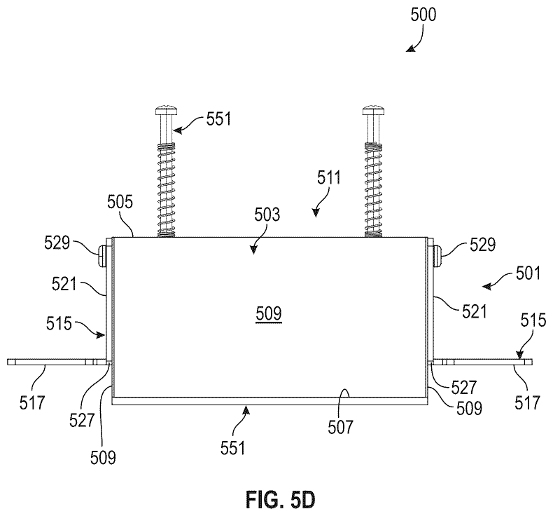

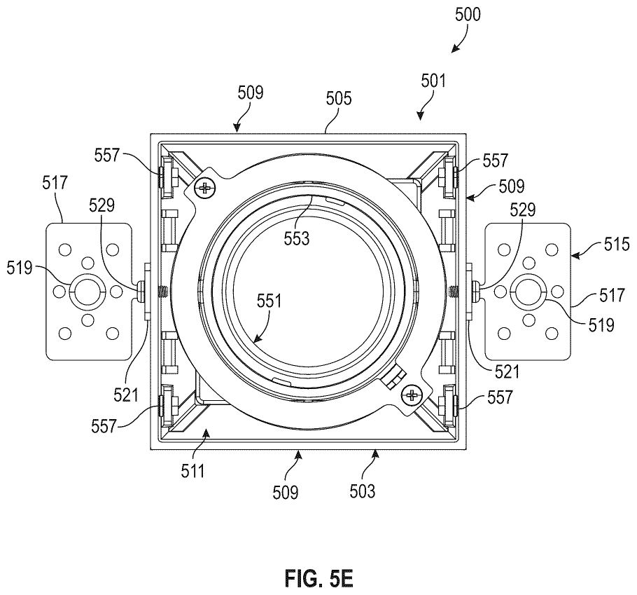

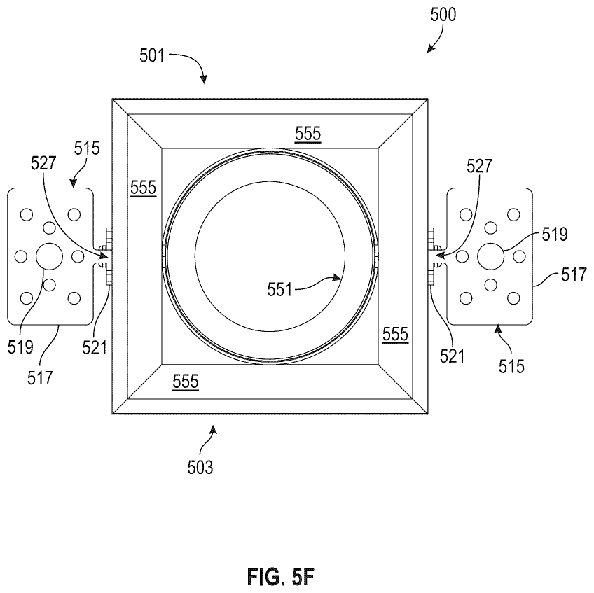

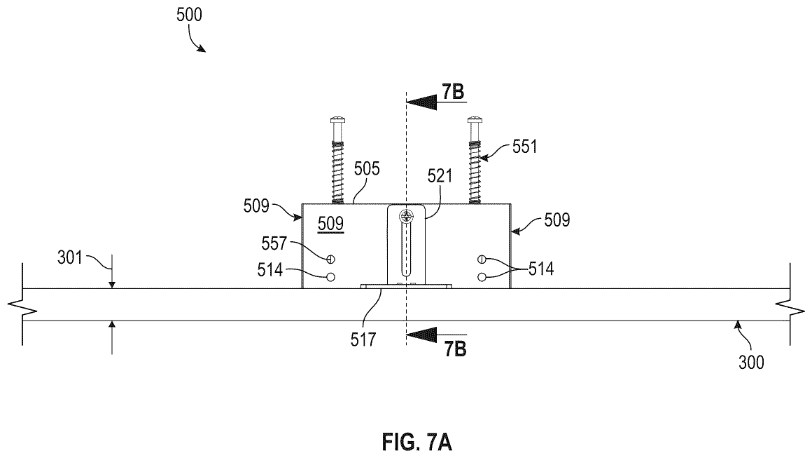

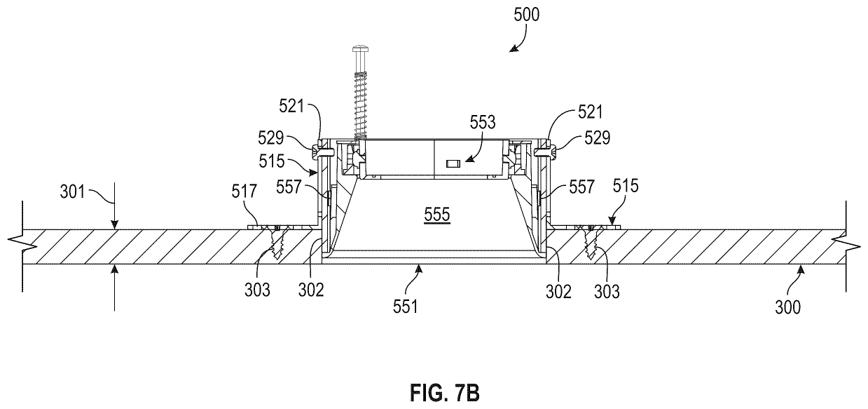

FIG. 5A is top perspective view of an assembly 500 according to at least one embodiment herein. FIG. 5B is bottom perspective view of assembly 500. FIG. 5C is right-side view (or a left-side view) of assembly 500. FIG. 5D is a front view (or a rear view) of assembly 500. FIG. 5E is a top view of assembly 500. FIG. 5F is a bottom view of assembly 500. In some embodiments, assembly 500 may comprise one (1) adapter 501 (adapter-for-structural-ceiling 501) and one (1) flangeless-trim-subassembly 551. In some embodiments, one (1) adapter 501 and one (1) flangeless-trim-subassembly 551 may be (removably and/or fixedly) attached to each other to form a given assembly 500. In some embodiments, adapter 501 may be fixedly attached to ceiling 300 and to flangeless-trim-subassembly 551 (see e.g., FIG. 7A and FIG. 7B for assembly 500 engagement with ceiling 300). In some embodiments, flangeless-trim-subassembly 551 may be attached to adapter 501 and to a light-module (light-fixture/light-source).

Continuing discussing FIG. 5A to FIG. 5F, in some embodiments, adapter 501 may serve a same function, purpose, and/or goal as of adapter 400, except adapter 501 and adapter 400 may have different shapes (and dimensions) from each other. For example, and without limiting the scope of the present invention, where adapter 400 may have a generally cylindrical and/or circular form factor (shape), adapter 501 may have a generally rectangular prism form factor (shape). In some embodiments, adapter 501 may permit (facilitate) use of flangeless-trim-subassembly 551 on a given ceiling 300 that may be thicker than typical drywall ceiling and/or wherein ceiling 300 may comprise a structural sheet material (e.g., wood) as shown in FIG. 7A and in FIG. 7B. In some embodiments, adapter 501 may comprise one (1) rectangular-prism-sleeve 503 and at least one L-bracket 515. In some embodiments, adapter 501 may comprise one (1) rectangular-prism-sleeve 503, at least one L-bracket 515, and at least one mechanical-fastener 529. In some embodiments, adapter 501 may comprise one (1) rectangular-prism-sleeve 503 and at least two L-brackets 515. In some embodiments, adapter 501 may comprise one (1) rectangular-prism-sleeve 503, at least two L-brackets 515, and mechanical-fastener(s) 529. In some embodiments, a given L-bracket 515 may be removably and fixedly attached to a given rectangular-prism-sleeve 503 using at least one mechanical-fastener 529; however, if that mechanical-fastener 529 is loosened then that given L-bracket 515 may be vertically adjusted with respect to that given rectangular-prism-sleeve 503.

Continuing discussing FIG. 5A to FIG. 5F, in some embodiments, rectangular-prism-sleeve 503 may be rectangular-prism shaped member that is open at its top 505 and also open at its bottom 507, where it is defined and bound around its sides and periphery by sidewall 509 that is substantially (mostly) closed (aside from some apertures like aperture 513 and/or aperture 514). In some embodiments, top 505 may be a top of rectangular-prism-sleeve 503. In some embodiments, bottom 507 may be a bottom of rectangular-prism-sleeve 503. In some embodiments, top 505 and bottom 507 may be oppositely disposed from each other. In some embodiments, sidewall 509 may be sidewalls of rectangular-prism-sleeve 503. In some embodiments, because rectangular-prism-sleeve 503 may comprise (have) a rectangular prism shape, then there may be four (4) separate and distinct sidewalls 509. In some embodiments, a height of sidewall 509 may be uniform, fixed, finite, predetermined, and/or non-variable. In some embodiments, a thickness of sidewall 509 may be uniform, fixed, finite, predetermined, and/or non-variable. In some embodiments, within rectangular-prism-sleeve 503 may be a hollow void space of internal-volume 511. In some embodiments, internal-volume 511 may be bound around its sides and/or periphery by sidewalls 509, but internal-volume 511 may be open at its top and at its bottom; and as such, internal-volume 511 may also have a rectangular-prism shape. In some embodiments, internal-volume 511 may be configured to receive therein at least a portion of flangeless-trim-subassembly 551. In some embodiments, when assembly 500 may be assembled, then at least most of flangeless-trim-subassembly 551 may fit entirely within internal-volume 511 of rectangular-prism-sleeve 503. In some embodiments, when assembly 500 may be assembled, some portion(s) of flangeless-trim-subassembly 551 protrude above top 505 of rectangular-prism-sleeve 503 and some region(s) of flangeless-trim-subassembly 551 may protrude below bottom 507 of rectangular-prism-sleeve 503.

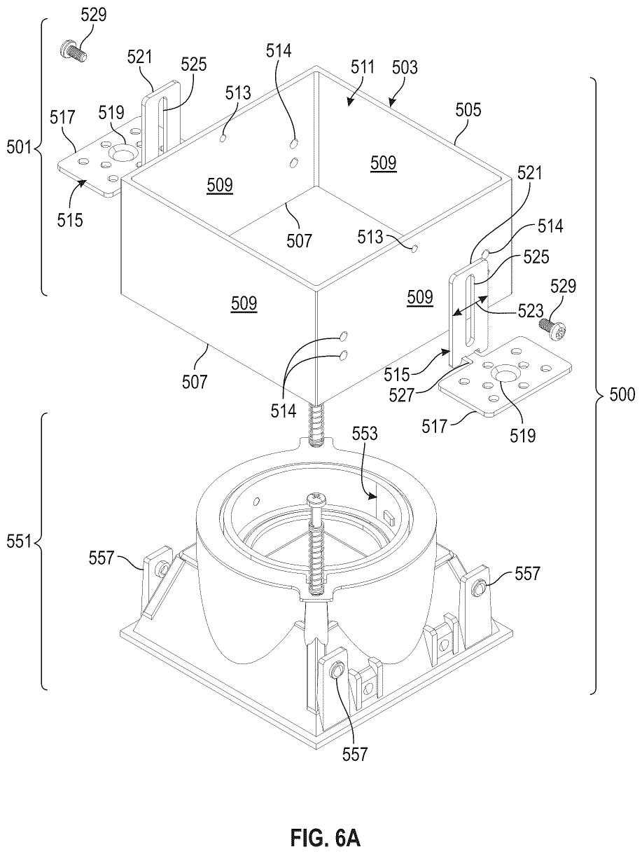

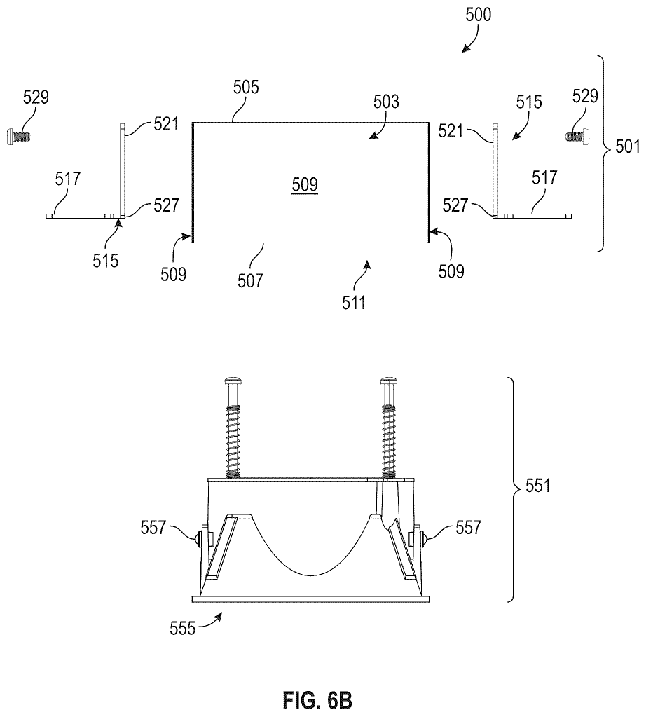

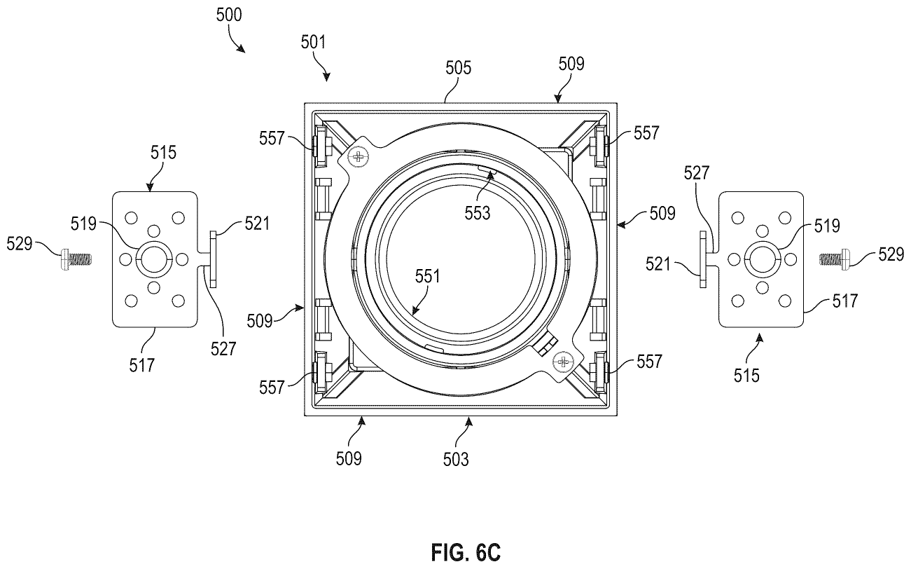

Continuing discussing FIG. 5A to FIG. 5F, in some embodiments, rectangular-prism-sleeve 503 may comprise at least one aperture 513. Note aperture(s) 513 may be more visible in FIG. 6A. In some embodiments, rectangular-prism-sleeve 503 may comprise at least two apertures 513. In some embodiments, when rectangular-prism-sleeve 503 may comprise two apertures 513, those two apertures 513 may be oppositely disposed from each other, located on separate and opposite sidewalls 509. In some embodiments, rectangular-prism-sleeve 503 may comprise a quantity of aperture(s) 513 to match (equal) a quantity of L-bracket(s) 515. In some embodiments, a given aperture 513 may be located on an upper sidewall 509, located closer to top 505 than to bottom 507. In some embodiments, a given aperture 513 may be located in a center of an upper sidewall 509, located closer to top 505 than to bottom 507. In some embodiments, aperture(s) 513 may not be located lower portions of sidewall 509. In some embodiments, a given aperture 513 may be through hole that passes entirely through a thickness of the given sidewall 509 where that given aperture 513 is located. In some embodiments, given aperture 513 may be configured to receive a portion of a mechanical-fastener 529 therein. In some embodiments, given aperture 513 may be used for fixedly securing (attaching) a given sidewall 509 to a given L-bracket 515 using a given mechanical-fastener 529.

Continuing discussing FIG. 5A to FIG. 5F, in some embodiments, rectangular-prism-sleeve 503 may comprise at least one aperture 514. In some embodiments, aperture(s) 514 may be located on sidewall(s) 509. In some embodiments, at least one sidewall 509 may comprise: at least one aperture 514; at least two apertures 514; or at least four apertures 514. In some embodiments, each sidewall 509, selected from a pair of opposing sidewalls 509, may comprise: at least one aperture 514; at least two apertures 514; or at least four apertures 514. In some embodiments, aperture(s) 514 may be located closer to bottom 507 than to top 505. In some embodiments, with respect to aperture(s) 514 of a given sidewall 509, those aperture(s) 514 may be located off a vertical line that equally bisects that given sidewall 509. In some embodiments, with respect to aperture(s) 514 of a given sidewall 509, those aperture(s) 514 may be located closer to side edge of that given sidewall 509 and further from a vertical line that equally bisects that given sidewall 509. In some embodiments, when a given sidewall 509 may comprise four apertures 514, those four apertures 514 may be grouped in two pairs of apertures 514, wherein in each pair of apertures 514 those paired apertures 514 are in vertical alignment with each other. In some embodiments, rectangular-prism-sleeve 503 may comprise a quantity of aperture(s) 514 to match (equal) or to double a quantity of connector(s) 557 of flangeless-trim-subassembly 551. In some embodiments, aperture(s) 514 may not be located upper portions of sidewall 509. In some embodiments, a given aperture 514 may be through hole that passes entirely through a thickness of the given sidewall 509 where that given aperture 514 is located. In some embodiments, given aperture 513 may be configured to receive therein a portion of a connector 557 of flangeless-trim-subassembly 551. In some embodiments, given aperture 514 may be used for fixedly securing (attaching) a given sidewall 509 to a given connector 557 of flangeless-trim-subassembly 551. In some embodiments, a given aperture 514 may be a locational site and may also be receiving geometry for a given connector 557 of flangeless-trim-subassembly 551 to attach to. In some embodiments, when a given aperture 514 and a given connector 557 (of flangeless-trim-subassembly 551) are physically engaged with each other, a nature of the engagement may be substantially (mostly) like a ball and socket configuration. In some embodiments, rectangular-prism-sleeve 503 may comprise at least one of: top 505, bottom 507, sidewall 509, internal-volume 511, aperture(s) 513, and/or aperture(s) 514.

Continuing discussing FIG. 5A to FIG. 5F, in some embodiments, L-bracket(s) 515 may be how rectangular-prism-sleeve 503 is fixedly attached to a top of a given ceiling 300 (e.g., as shown in FIG. 7A and/or FIG. 7B). In some embodiments, a bottom (horizontal) portion of a given L-bracket 515 may be configured for fixed attachment to a top of a given ceiling 300; and an upper (vertical) portion of that given L-bracket 515 may be configured for adjustable and fixed attachment to a given sidewall 509 of rectangular-prism-sleeve 503. In some embodiments, adapter 501 may comprise at least one L-bracket 515. In some embodiments, adapter 501 may comprise at least two L-brackets 515. In some embodiments, when adapter 501 may comprise two L-brackets 515, then those two L-brackets 515 may be fixedly (and vertically adjustably) attached on opposite sidewalls 509 of rectangular-prism-sleeve 503 such that those two L-brackets 515 are also oppositely disposed from each other. In some embodiments, a given L-bracket 515 may comprise two main regions, namely, a horizontal-portion 517 and a vertical-portion 521; wherein the horizontal-portion 517 and vertical-portion 521 are linked (connected) to each other via a linkage-portion 527. In some embodiments, a given L-bracket 515 may comprise horizontal-portion 517, vertical-portion 521, and linkage-portion 527. In some embodiments, horizontal-portion 517 may be a horizontal plate member of L-bracket 515. In some embodiments, horizontal-portion 517 may comprise at least one through-hole 519. In some embodiments, through-hole 519 may be a through hole that passes entirely through a thickness of horizontal-portion 517. In some embodiments, through-hole 519 may be configured to receive at least a portion of a mechanical-fastener 303 for a purpose of fixedly securing (attaching) horizontal-portion 517 to a top surface of ceiling 300 (e.g., as shown in FIG. 7A).

Continuing discussing FIG. 5A to FIG. 5F, in some embodiments, vertical-portion 521 (of a given L-bracket 515) may be configured to being fixedly attached to a given sidewall 509, with an aperture 513, (e.g., via use of mechanical-fastener(s) 529); but when mechanical-fastener(s) 529 may be loose, vertical-portion 521 (and its L-bracket 515) may be vertically and slidingly adjusted with respect to that given sidewall 509. In some embodiments, vertical-portion 521 may be at least substantially (mostly) vertically oriented (when that vertical-portion 521 may be attached to a sidewall 509). In some embodiments, a length of vertical-portion 521 may be parallel with a height of sidewall 509 (when that vertical-portion 521 may be attached to that sidewall 509). In some embodiments, a length of vertical-portion 521 may be perpendicular (orthogonal) to a major plane of horizontal-portion 517. In some embodiments, when a given L-bracket 515 may be (removably) attached to a given sidewall 509, with an aperture 513 (of rectangular-prism-sleeve 503), that given L-bracket 515 may be located entirely outside of rectangular-prism-sleeve 503. In some embodiments, vertical-portion 421 may comprise a width 523 and may also comprise a vertical-slot 525. In some embodiments, width 523 may be a width of vertical-portion 521. In some embodiments, width 523 may be uniform, fixed, finite, predetermined, and/or non-variable. In some embodiments, width 523 may be greater than a width of vertical-slot(s) 525. In some embodiments, vertical-slot 525 may be a vertical slot of vertical-portion 521. In some embodiments, vertical-slot 525 may be located entirely within vertical-portion 521. In some embodiments, a length of vertical-slot 525 may be parallel with a length of vertical-portion 521. In some embodiments, when a given L-bracket 515 may be (fixedly) attached to a given sidewall 509, with an aperture 513 (of rectangular-prism-sleeve 503), a length of vertical-slot 525 may be parallel with a height of that sidewall 509. In some embodiments, vertical-slot 525 may be configured to (removably) receive at least a portion of mechanical-fastener 529 therein.

Continuing discussing FIG. 5A to FIG. 5F, in some embodiments, linkage-portion 527 may be configured to fixedly (and integrally) join horizontal-portion 517 to vertical-portion 521 of a given L-bracket 515. In some embodiments, linkage-portion 527 may be located a bottom (and center) of a given L-bracket 515. In some embodiments, linkage-portion 527 may be a run of material that fixedly (and integrally) and physically joins the horizontal-portion 517 to the vertical-portion 521. In some embodiments, a width of linkage-portion 527 may be less than width 523. In some embodiments, horizontal-portion 517, vertical-portion 521, and linkage-portion 527 may be a single integral article of manufacture. In some embodiments, horizontal-portion 517, vertical-portion 521, and linkage-portion 527 may be all made from a same material(s) of construction as each other. In some embodiments, horizontal-portion 517, vertical-portion 521, and linkage-portion 527 may be all be rigid.

Continuing discussing FIG. 5A to FIG. 5F, in some embodiments, assembly 500 and/or adapter 501 may comprise at least one mechanical-fastener 529. In some embodiments, assembly 500 and/or adapter 501 may comprise a quantity of at least one mechanical-fastener(s) 529 that matches (equals) a quantity of: aperture(s) 513 and/or, L-bracket(s) 515. In some embodiments, a given mechanical-fastener 529 may be configured to fixedly secure (attach) a given vertical-slot 525 (of a given L-bracket 515) to a given aperture 513 (of a given sidewall 509). In some embodiments, mechanical-fastener 529 may be selected from: a screw, a bolt, a rivet, a pin, a dowel, a portion thereof, combinations thereof, and/or the like. In some embodiments, mechanical-fastener 529 may be configured to receive a nut and/or a wing-nut.

Continuing discussing FIG. 5A to FIG. 5F, in some embodiments, a portion of a given flangeless-trim-subassembly 551 (e.g., its connector(s) 557) may removably and fixedly attach to sidewalls 509 of rectangular-prism-sleeve 503; and a region of that same given flangeless-trim-subassembly 551 (e.g., its holder 553) may removably and fixedly attach to a given light-module. In some embodiments, flangeless-trim-subassembly 551 may be an assembly that forms a flangeless-trim in a ceiling recessed lighting application; such that when flangeless-trim-subassembly 551 may be installed in and mostly above a given ceiling, only its reflector 555 portions may be visible to an observer located below that ceiling with the installed flangeless-trim-subassembly 551. In some embodiments, flangeless-trim-subassembly 551 may comprise: holder 553, reflector 555, and connector(s) 557. In some embodiments, holder 553 may be located in an upper region of flangeless-trim-subassembly 551 and may be configured to removably and fixedly attach to a bottom portion of a given light-module via a twist-lock motion. In some embodiments, at least some lower portions of flangeless-trim-subassembly 551 may comprise its reflector 555. In some embodiments, reflector 555 may be configured to reflecting at least some light emitted by the light-module attach above at holder 553. In some embodiments, flangeless-trim-subassembly 551 may comprise one or more connector(s) 557. In some embodiments, connector(s) 557 may complementary, removably, and/or fixedly attach to aperture(s) 514 of sidewall(s) 509 (of rectangular-prism-sleeve 503). Note, connector(s) 557 may be best shown in FIG. 6A and/or in FIG. 6B. In some embodiments, at least a portion of a given connector 557 may be a solid and substantially hemispherical shape (e.g., formed from a rounded/curved screw/bolt head), that may fit into a given aperture 514. In some embodiments, a given connector 557 may be located on an upward extending protrusion of material and with the substantially hemispherical shape facing outwards. In some embodiments, to (removably) attach flangeless-trim-subassembly 551 to rectangular-prism-sleeve 503, the installer may only have to push flangeless-trim-subassembly 551 into the internal-volume 511 (of rectangular-prism-sleeve 503) until one or more connector(s) 557 seat into aperture(s) 514 of sidewall(s) 509 (of rectangular-prism-sleeve 503).

FIG. 6A is top perspective exploded view of assembly 500, showing adapter 501 separated from flangeless-trim-subassembly 551, showing adapter 501 in a dissembled configuration, and showing flangeless-trim-subassembly 551 still in its assembled configuration.

FIG. 6B is a front exploded view (or a rear exploded view) of assembly 500, showing adapter 501 separated from flangeless-trim-subassembly 551, showing adapter 501 in a dissembled configuration, and showing flangeless-trim-subassembly 551 still in its assembled configuration.

FIG. 6C is a top exploded view of assembly 500, showing adapter 501 separated from flangeless-trim-subassembly 551, showing adapter 501 in a dissembled configuration, and showing flangeless-trim-subassembly 551 still in its assembled configuration.

FIG. 7A may be a right-side view (or left-side view) of assembly 500 wherein assembly 500 may be fixedly attached to a section (portion and/or region) of ceiling 300. FIG. 7A also includes sectional-line 7B-7B. In some embodiments, adapter 501 may be configured to be (fixedly) attached to ceiling 300. In some embodiments, L-bracket(s) 515 may be configured to be (fixedly) attached to ceiling 300. In some embodiments, a bottom surface portion of L-bracket(s) 515 (of horizontal-portion(s) 517) may be configured to be (fixedly) attached to a top surface of ceiling 300. In some embodiments, a bottom surface portion of L-bracket(s) 515 (of horizontal-portion(s) 517) may be in direct physical contact with a top surface of ceiling 300. FIG. 7A shows a L-bracket 515 that is fixedly attached to ceiling 300. FIG. 7A shows a bottom surface portion of a given L-bracket 403 (of a given horizontal-portion 517) that is fixedly attached to a top portion of ceiling 300. FIG. 7A shows a bottom surface portion of a given L-bracket 515 (of a given horizontal-portion 517) is in direct physical contact with a top portion of ceiling 300.

FIG. 7B may be a cross-sectional view through sectional-line 7B-7B of FIG. 7A. FIG. 7B may show a cross-sectional view through assembly 500 and through a portion (section and/or region) of ceiling 300. FIG. 7B shows mechanical-fasteners 303 are used to secure horizontal-portions 517 to a top portion of ceiling 300 (e.g., at least one mechanical-fastener 303 per each horizontal-portion 517). FIG. 7B shows a bottom surface portion of a given L-bracket 515 is in direct physical contact with a top portion of ceiling 300. FIG. 7B shows a bottom surface portion of a given L-bracket 515 that is fixedly attached to a top portion of ceiling 300 using a mechanical-fastener 303. In some embodiments, assembly 500, flangeless-trim-subassembly 551, and/or adapter 501 may comprise at least one mechanical-fastener 303 per a quantity of L-bracket(s) 515 of adapter 501 and/or of rectangular-prism-sleeve 503. In some embodiments, assembly 500, flangeless-trim-subassembly 551, and/or adapter 501 may comprise at least one mechanical-fastener 303 per each L-bracket(s) 515 of adapter 501. In some embodiments, assembly 500, flangeless-trim-subassembly 551, and/or adapter 501 may comprise at least two mechanical-fasteners 303 per each rectangular-prism-sleeve 503. In some embodiments, mechanical-fastener 303 may fixedly attach a bottom surface portion of a given L-bracket 515 to a top portion of ceiling 300. In some embodiments, at least a portion of mechanical-fastener 303 may pass through the bottom portion (horizontal-portion 517) of the given L-bracket 515; and another portion of that mechanical-fastener 303 may pass into material of ceiling 300. In some embodiments, a total length of mechanical-fastener 303 may be configured to be less than thickness 301. In some embodiments, mechanical-fastener 303 may enter L-bracket 515 and ceiling 300 from a top (upper) side of ceiling 300. In some embodiments, mechanical-fastener 303 may not enter ceiling 300 and L-bracket 515 from a bottom (under) side of ceiling 300.

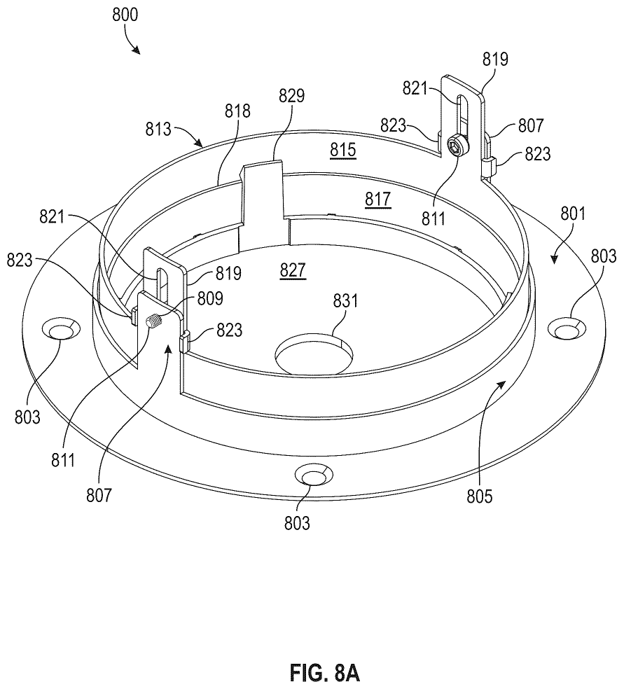

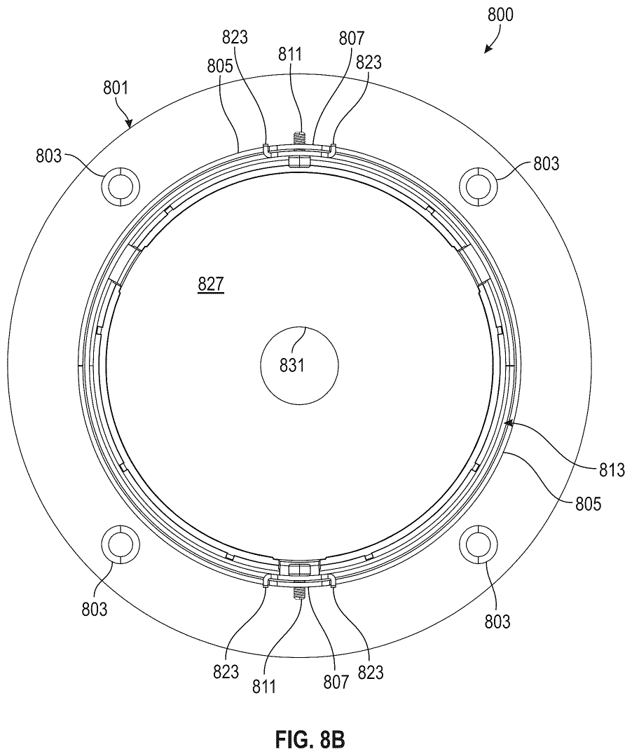

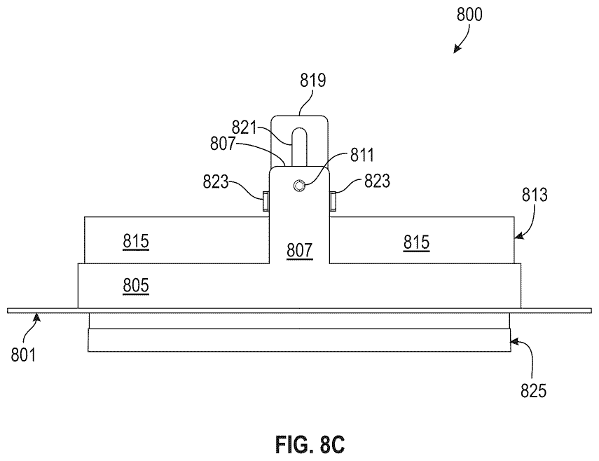

FIG. 8A is a top perspective view of an adapter-assembly 800 according to at least one embodiment. FIG. 8B is a top view of adapter-assembly 800. FIG. 8C is a right-side view (or a left-side view) of adapter-assembly 800. In some embodiments, adapter-assembly 800 may serve a same function, purpose, and/or goal as of adapter 400, except adapter-assembly 800 and adapter 400 may have different structures, shapes (and dimensions) from each other. For example, and without limiting the scope of the present invention, where adapter 400 may uses its L-brackets 403 for attachment to ceiling 300 of various thicknesses 301, adapter-assembly 800 may uses its annular-disk 801 for fixed and non-adjustable attachment to ceiling 300 and accounting for different thicknesses 301 of ceilings 300 may instead be done by adjustable-collar 813 of adapter-assembly 800, wherein adjustable-collar 813 may move vertically up or down with respect to annular-disk 801. In some embodiments, in terms of parts (components) adapter-assembly 800 may comprise an annular-disk 801 and an adjustable-collar 813. In some embodiments, in terms of parts (components) adapter-assembly 800 may comprise annular-disk 801, adjustable-collar 813, and at least one mechanical-fastener 811. In some embodiments, in terms of parts (components) adapter-assembly 800 may comprise annular-disk 801, adjustable-collar 813, and dust-cover 825. In some embodiments, in terms of parts (components) adapter-assembly 800 may comprise at least one of: annular-disk 801, adjustable-collar 813, mechanical-fastener 811, and/or dust-cover 825.

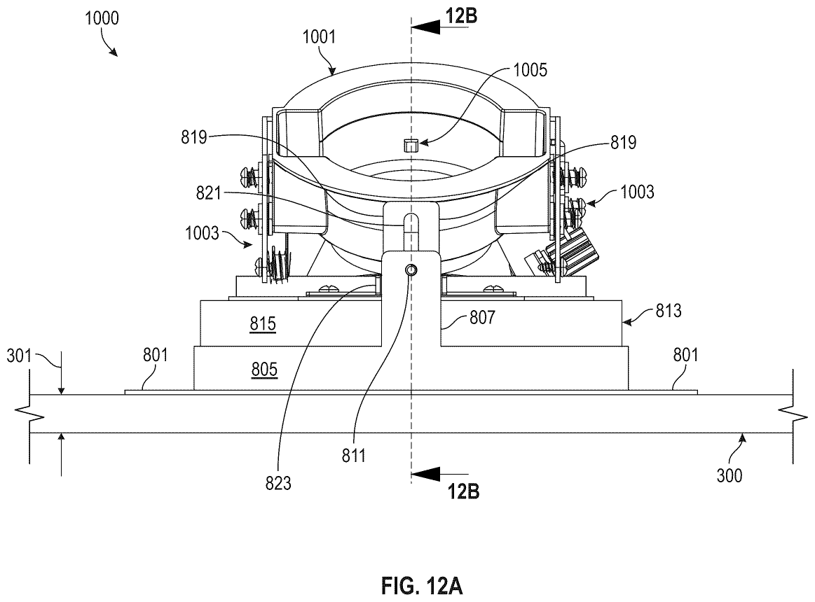

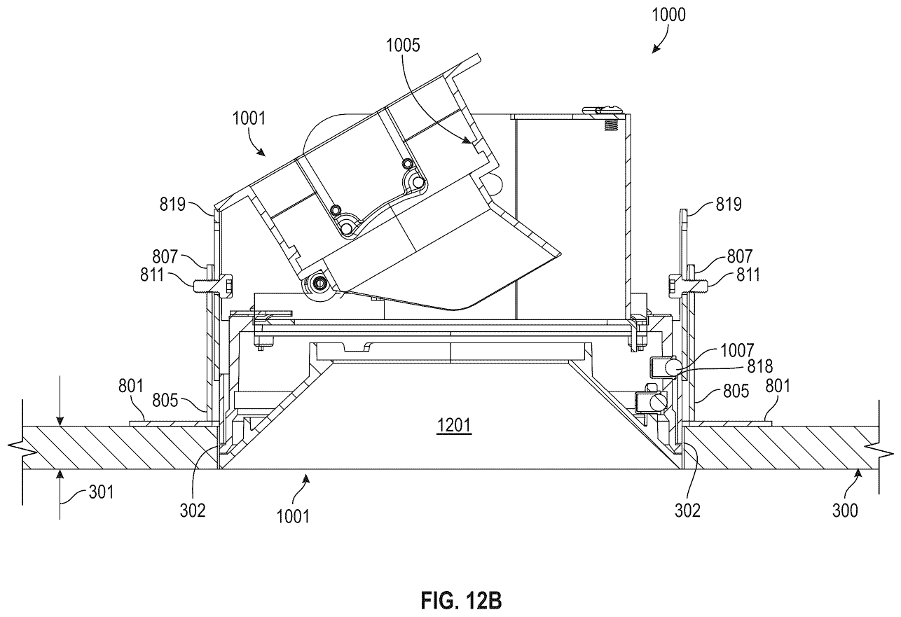

Continuing discussing FIG. 8A, FIG. 8B, and FIG. 8C, in some embodiments, annular-disk 801 (flange-with-collar-member 801) may be a part (component) that has a flat circular annular disk portion (flange-region) with a largest outside-diameter of adapter-assembly 800, wherein extending upwards from a largest and centered hole 802 of annular-disk 801 may be a collar 805. In some embodiments, located in the flat annular disk portion of annular-disk 801 may be at least one aperture 803. In some embodiments, aperture 803 may be through hole that extends all the way through a thickness of the flat annular disk portion of annular-disk 801. In some embodiments, aperture 803 may be to receive at least a portion of mechanical-fastener 303 therein for a purpose of fixedly attaching annular-disk 801 to a top (upper) portion of ceiling 300 (e.g., as shown in FIG. 12A and/or FIG. 12B).

Continuing discussing FIG. 8A, FIG. 8B, and FIG. 8C, in some embodiments, annular-disk 801 may comprise collar 805. In some embodiments, collar 805 may be a member of cylindrical sidewall that extends upwards from largest and centered hole 802 of annular-disk 801 by a uniform, fixed, finite, predetermined, and non-variably amount (aside from tab(s) 807 of collar 805). In some embodiments, collar 805 may have a height that is uniform, fixed, finite, predetermined, and non-variable (aside from tab(s) 807 of collar 805). In some embodiments, collar 805 may have a thickness that is uniform, fixed, finite, predetermined, and non-variable. In some embodiments, collar 805 may be free of holes, apertures, and/or slots. In some embodiments, extending from a top (upper side/upper surface) of collar 805 may be at least one tab 807. In some embodiments, extending from a top (upper side/upper surface) of collar 805 may be at least two tabs 807. In some embodiments, when collar 805 may have (comprise) two or more tabs 807, those tabs 807 may be spaced and/or located equidistant from each other around/on collar 805. In some embodiments, when collar 805 may have (comprise) two tabs 807, those tabs 807 may be oppositely disposed from each other around/on collar 805. In some embodiments, when collar 805 may have (comprise) two tabs 807, those tabs 807 may be spaced and/or located 180 degrees from each other around/on collar 805. In some embodiments, tab 807 may be protrusion of material extending from a top (upper side/upper surface) of collar 805. In some embodiments, tab 807 may have (comprise) a height that is uniform, fixed, finite, predetermined, and/or non-variable. In some embodiments, tab 807 may comprise at least one hole 809. In some embodiments, hole 809 may be located in tab 807. In some embodiments, hole 809 may be a through hole that passes entirely through a thickness of tab 807. In some embodiments, the thickness of tab 807 may be uniform, fixed, finite, predetermined, and/or non-variable. In some embodiments, hole 809 may be located in an upper (top) portion of tab 807 (disposed away from collar 805). In some embodiments, hole 809 may not be located in a lower (bottom) portion of tab 807 (closer to collar 805 than to a top of tab 807). In some embodiments, hole 809 may not be slot/slit. In some embodiments, hole 809 may be configured to receive at least a portion of a mechanical-fastener 811 therein. In some embodiments, annular-disk 801 may comprise at least one of: aperture(s) 803, collar 805, tab(s) 807, and/or hole(s) 809. In some embodiments, annular-disk 801 may comprise: aperture(s) 803, collar 805, tab(s) 807, and/or hole(s) 809.

Continuing discussing FIG. 8A, FIG. 8B, and FIG. 8C, in some embodiments, adapter-assembly 800, annular-disk 801, and/or adjustable-collar 813 may comprise at least one mechanical-fastener 811. In some embodiments, adapter-assembly 800, annular-disk 801, and/or adjustable-collar 813 may comprise a quantity of mechanical-fastener(s) 811 to match (equal) a quantity of hole(s) 809 and/or a quantity of slot(s) 821 (of adjustable-collar 813). In some embodiments, mechanical-fastener 811 may be selected from: a screw, a bolt, a rivet, a pin, a dowel, a portion thereof, combinations thereof, and/or the like. In some embodiments, mechanical-fastener 811 may be configured to receive a nut and/or a wing-nut. In some embodiments, adapter-assembly 800, annular-disk 801, and/or adjustable-collar 813 may comprise a quantity of wing nuts (or nuts) to match (equal) a quantity of mechanical-fastener(s) 811.

Continuing discussing FIG. 8A, FIG. 8B, and FIG. 8C, in some embodiments, adjustable-collar 813 may be configured to be fixedly attached to annular-disk 801, but may also be configured to vertically (up or down) adjust with respect to annular-disk 801 and when a desired vertical placement is made to then be fixedly attached to annular-disk 801 at that particular vertical placement using mechanical-fastener(s) 811, hole(s) 809, and slot(s) 821 (and optionally nuts/wing nuts). In some embodiments, adjustable-collar 813 may mostly (substantially) be a hollow cylindrical member. In some embodiments, the hollow cylindrical member of adjustable-collar 813 may comprise an upper-sidewall 815 and a lower lower-sidewall 817. In some embodiments, the top portion of lower-sidewall 817 may attach to (connect to) the bottom portion of upper-sidewall 815. In some embodiments, upper-sidewall 815 and lower-sidewall 817 are integrally connected to each other such that adjustable-collar 813 is a single article of manufacture. In some embodiments, upper-sidewall 815 may be a solid cylindrical sidewall located on an upper region of adjustable-collar 813. In some embodiments, lower-sidewall 817 may be a solid cylindrical sidewall located on a lower region of adjustable-collar 813. In some embodiments, upper-sidewall 815 and/or lower-sidewall 817 may be free from holes, apertures, and/or slots. In some embodiments, upper-sidewall 815 and lower-sidewall 817 may be oppositely disposed from each other, with upper-sidewall 815 on top of lower-sidewall 817 (or with lower-sidewall 817 beneath upper-sidewall 815). In some embodiments, upper-sidewall 815 may have a thickness that is uniform, finite, fixed, predetermined, and/or non-variable. In some embodiments, lower-sidewall 817 may have a thickness that is uniform, finite, fixed, predetermined, and/or non-variable. In some embodiments, the thickness of upper-sidewall 815 may be the same or different from the thickness of lower-sidewall 817. In some embodiments, an outside-diameter of upper-sidewall 815 may be larger than an outside-diameter of lower-sidewall 817. In some embodiments, an inside-diameter of upper-sidewall 815 may be larger than an inside-diameter of lower-sidewall 817. In some embodiments, the outside-diameter of upper-sidewall 815 may be uniform, fixed, finite, predetermined, and/or non-variable. In some embodiments, the inside-diameter of upper-sidewall 815 may be uniform, fixed, finite, predetermined, and/or non-variable. In some embodiments, the outside-diameter of upper-sidewall 815 may be larger than the inside-diameter of upper-sidewall 815. In some embodiments, the outside-diameter of lower-sidewall 817 may be uniform, fixed, finite, predetermined, and/or non-variable. In some embodiments, the inside-diameter of lower-sidewall 817 may be uniform, fixed, finite, predetermined, and/or non-variable. In some embodiments, the outside-diameter of lower-sidewall 817 may be larger than the inside-diameter of lower-sidewall 817. In some embodiments, with respect to inside (internal) surfaces of upper-sidewall 815 and lower-sidewall 817, where lower-sidewall 817 transitions into upper-sidewall 815 may be a step 818 or a ledge 818 (or a shelf). In some embodiments, this step 818 (or ledge 818), at an internal (interior) transition from lower-sidewall 817 to upper-sidewall 815, may be configured to receive (and/or support) a portion of a prong 829 (of dust-cover 825); and/or step 818 may be configured to receive (and/or support) a portion of connector(s) 1007 of flangeless-trim-assembly 1001.

Continuing discussing FIG. 8A, FIG. 8B, and FIG. 8C, in some embodiments, adjustable-collar 813, upper-sidewall 815, and/or adapter-assembly 800 may comprise at least one tab 819. In some embodiments, adjustable-collar 813, upper-sidewall 815, and/or adapter-assembly 800 may comprise at least two tabs 819. In some embodiments, extending from a top of upper-sidewall 815 may be at least one tab 819. In some embodiments, extending from a top of upper-sidewall 815 may be at least two tabs 819. In some embodiments, when upper-sidewall 815 may have (comprise) two or more tabs 819, those tabs 819 may be spaced and/or located equidistant from each other around/on upper-sidewall 815. In some embodiments, when upper-sidewall 815 may have (comprise) two tabs 819, those tabs 819 may be oppositely disposed from each other around/on upper-sidewall 815. In some embodiments, when upper-sidewall 815 may have (comprise) two tabs 819, those tabs 819 may be spaced and/or located 180 degrees from each other around/on upper-sidewall 815. In some embodiments, tab 819 may be a protrusion of material extending from a top of upper-sidewall 815. In some embodiments, tab 819 may have (comprise) a height that is uniform, fixed, finite, predetermined, and/or non-variable. In some embodiments, tab 819 may comprise at least one slot 821. In some embodiments, slot 821 may be located in tab 819. In some embodiments, slot 821 may be a through slot that passes entirely through a thickness of tab 819. In some embodiments, the thickness of tab 819 may be uniform, fixed, finite, predetermined, and/or non-variable. In some embodiments, slot 821 may be a vertical slot in tab 819, wherein a length of slot 821 may be parallel with a length (height) of tab 819. In some embodiments, slot 821 may be configured to receive at least a portion of a mechanical-fastener 811 therein. In some embodiments, a given slot 821 may be aligned with a given hole 809 (of a given tab 807) so that a given mechanical-fastener 811 may be used to fixedly fasten that tab 807 (with the given hole 809) to that tab 819 (with the given slot 821). In some embodiments, slot 821 may be entirely located within a given tab 819. In some embodiments, a periphery (perimeter) of a given slot 821 may be entirely enclosed by material of a given tab 819. In some embodiments, a length of each tab 819 may be vertically aligned and/or parallel with a length of a given tab 807. In some embodiments, each tab 819 may comprise a pair of guides 823 (fences 823). In some embodiments, a pair of guides 823 (fences 823) may be located on (attached to/connected to) to a given tab 819. In some embodiments, a pair of guides 823 (fences 823), of a given tab 819, may be spaced apart from each other by a width of given tab 819. In some embodiments, a pair of guides 823 (fences 823), of a given tab 819, may be spaced apart from each other by a width of a given tab 807 (of annular-disk 801). In some embodiments, a width of tab 819 may be at least substantially (mostly) similar to a width of tab 807 (of annular-disk 801). In some embodiments, a pair of guides 823 (fences 823), of a given tab 819, may be outwardly extending protrusions of material, that extend away from a center of adapter-assembly 800, annular-disk 801, and/or adjustable-collar 813. In some embodiments, a pair of guides 823 (fences 823), of a given tab 819, may be outwardly extending protrusions of material, that extend away from that given tab 819 and towards a given tab 807 of annular-disk 801. In some embodiment, a pair of guides 823 (fences 823), of a given tab 819, may be configured to vertically align (and to maintain that vertical alignment) a given tab 807 (of annular-disk 801) so that openings of hole 809 and slot 821 are in alignment with each other (for receiving mechanical-fastener 811 in those aligned openings). In some embodiments, a given tab 807 may fit in between a given pair of guides 823 (fences 823).

Continuing discussing FIG. 8A, FIG. 8B, and FIG. 8C, in some embodiments, dust-cover 825 may be a dust cover that removably (temporarily) overs over a main (largest and centered) bottom opening of adjustable-collar 813 and/or of annular-disk 801, until a flangeless-trim-assembly 1001 may be installed into adjustable-collar 813. In some embodiments, adapter-assembly 800 may be fixedly mounted (installed) onto a given ceiling 300 (e.g., as shown in FIG. 12A and/or in FIG. 12B); however, flangeless-trim-assembly 1001 may or may not be installed at a same time when adapter-assembly 800 is mounted to ceiling 300. If adapter-assembly 800 is mounted to ceiling 300 and a flangeless-trim-assembly 1001 is not yet installed into adjustable-collar 813, then under that scenario adapter-assembly 800 may optionally include dust-cover 825, with that dust-cover 825 attached to adjustable-collar 813 and covering over the main (largest and centered) bottom opening of adjustable-collar 813 and/or of annular-disk 801, to minimize dust intrusion into adapter-assembly 800. When flangeless-trim-assembly 1001 is to be installed into adjustable-collar 813, then dust-cover 825 (if present) is removed from adjustable-collar 813. In some embodiments, dust-cover 825 may comprise at least mostly closed surface 827 and at least one upward protruding (extending) prong 829. In some embodiments, at least mostly closed surface 827 may be at least substantially (mostly) flat, planar, and/or horizontal surface that is configured to minimize movement of dust past (through) at least mostly closed surface 827. In some embodiments, at least mostly closed surface 827 may comprise at least one hole 831. In some embodiments, hole 831 may be a through hole through a thickness of at least mostly closed surface 827. In some embodiments, the thickness of at least mostly closed surface 827 may be uniform, finite, fixed, predetermined, and/or non-variable. In some embodiments, hole 831 may be sized and/or configured to removably (temporarily) receive at least a portion of at least one finger (or thumb) of an installer and may be how the installed removes dust-cover 825 from adjustable-collar 813. In some embodiments, extending upwards from an outer region of dust-cover 825 may be at least one prong 829. In some embodiments, extending upwards from an outer region of dust-cover 825 may be one or more prongs 829. In some embodiments, extending upwards from an outer region of dust-cover 825 may be two or more prongs 829. In some embodiments, extending upwards from an outer region of dust-cover 825 may be three prongs 829. In some embodiments, when dust-cover 825 may have (comprise) two or more prongs 829, those prongs 829 may be spaced and/or located equidistant from each other around/on an outer region of dust-cover 825. In some embodiments, a portion of prong 829 may be configured to removably latch (grab) onto ledge 818 of adjustable-collar 813; and is thus how dust-cover 825 may be removably attached to adjustable-collar 813.

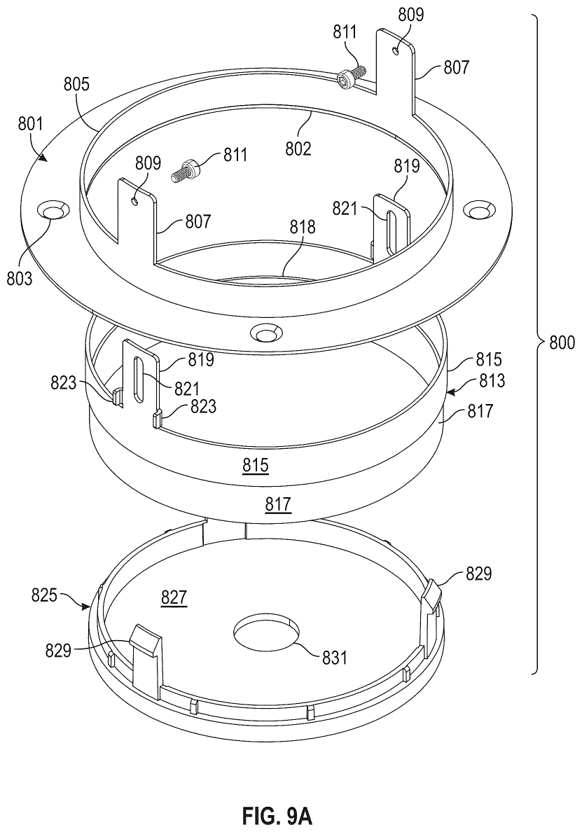

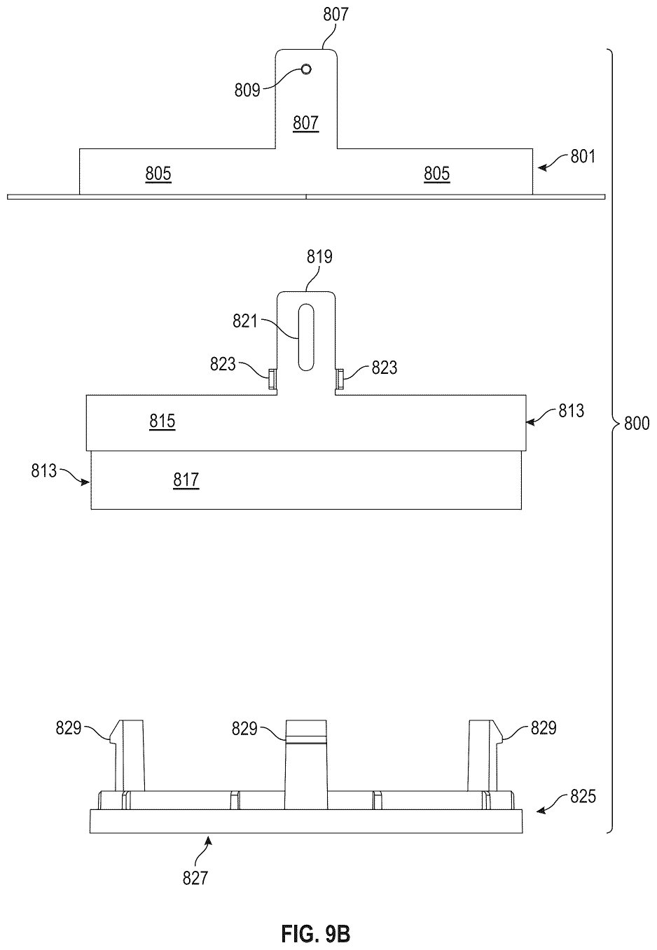

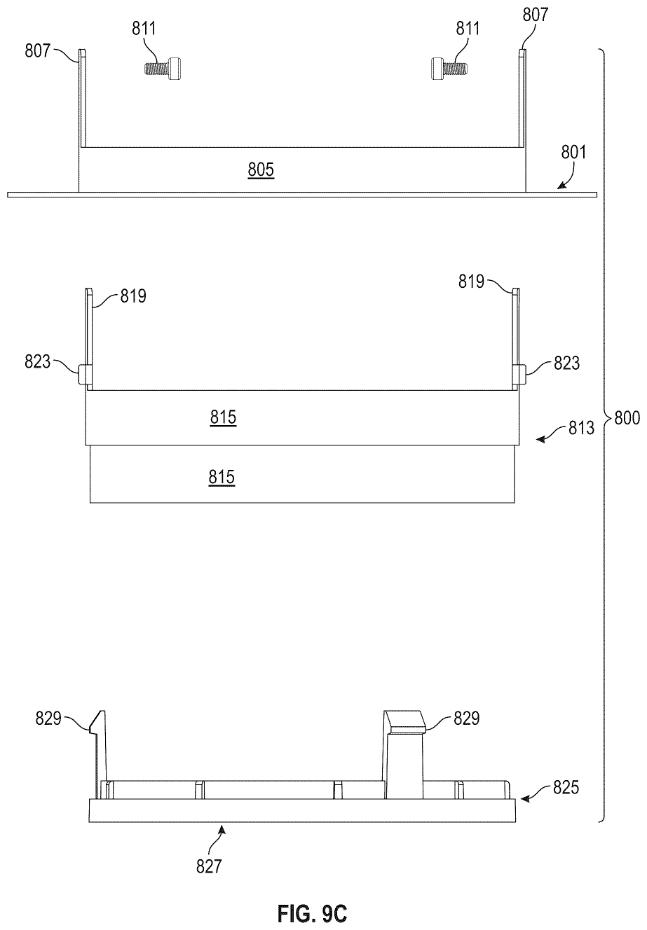

FIG. 9A is a top perspective exploded view of an adapter-assembly 800 that shows annular-disk 801, adjustable-collar 813, mechanical-fastener(s) 811, and/or dust-cover 825 separated (dissembled) from each other. FIG. 9B is a right-side exploded view (or a left-side exploded view) of adapter-assembly 800 that shows annular-disk 801, adjustable-collar 813, mechanical-fastener 811, and/or dust-cover 825 separated (dissembled) from each other. FIG. 9C is a front exploded view (or a rear exploded view) of adapter-assembly 800 that shows annular-disk 801, adjustable-collar 813, mechanical-fastener(s) 811, and/or dust-cover 825 separated (dissembled) from each other.

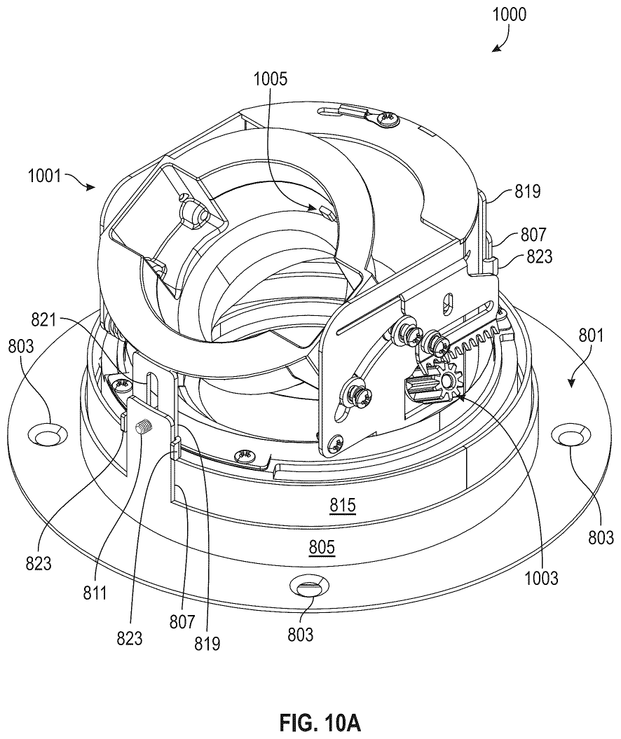

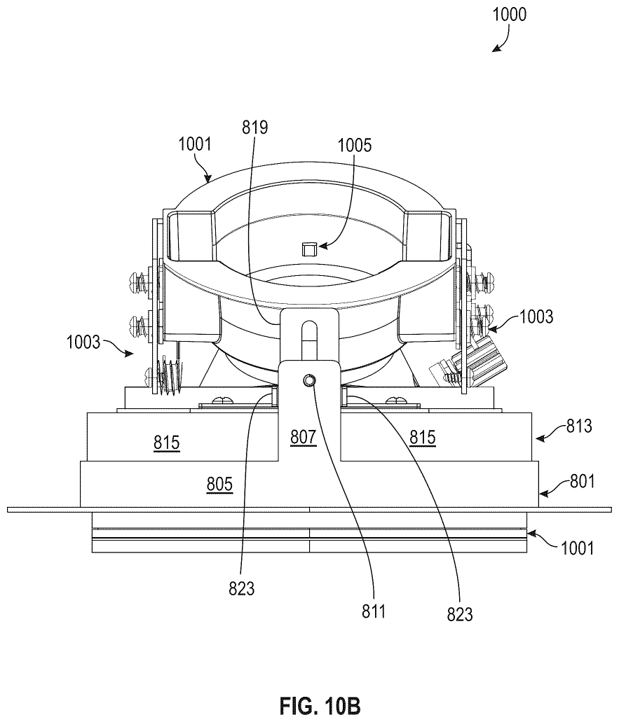

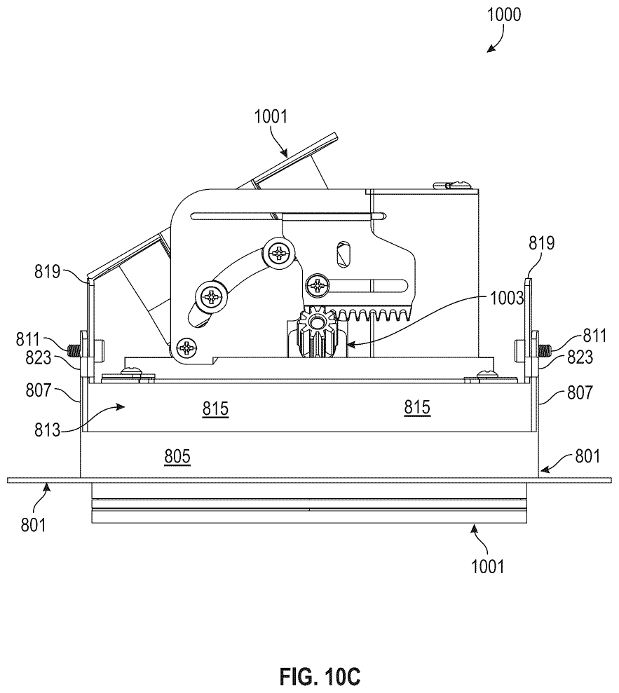

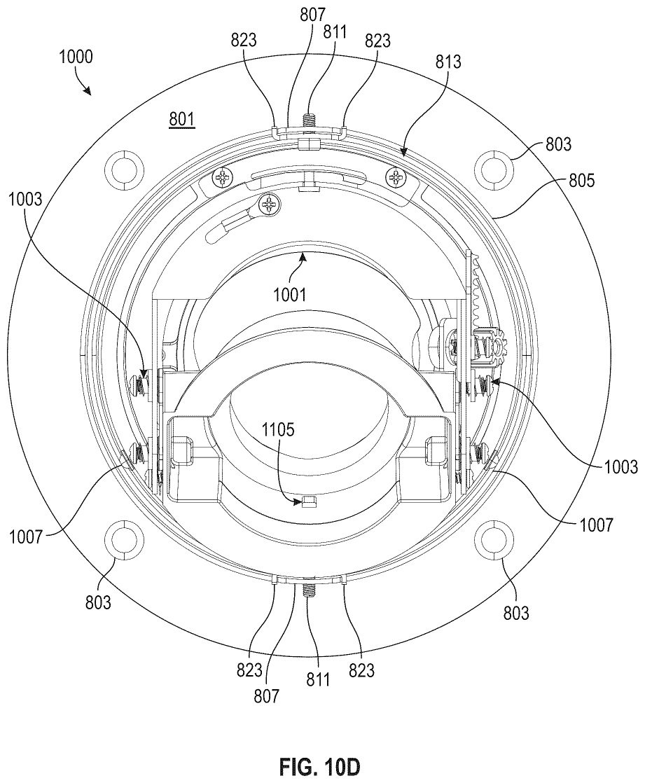

FIG. 10A is a top perspective view of an assembly 1000 according to at least one embodiment. FIG. 10B is a right-side view (or a left-side view) of assembly 1000. FIG. 10C is a front view (or a rear view) of assembly 1000. FIG. 10D is a top view of assembly 1000. In some embodiments, assembly 1000 may be assembly-of-adapter-and-trim 1000. In some embodiments, assembly 1000 may comprise one (1) adapter-assembly 800 (without dust-cover 825) and one (1) flangeless-trim-assembly 1001 that are (removably) attached to each other. In some embodiments, flangeless-trim-assembly 1001 may be similar to flangeless-trim-subassembly 101 and/or to flangeless-trim-subassembly 551, i.e., in functioning as a flangeless trim member and that may receive attachment of a given light-module and that may also attach to a given adapter; however, flangeless-trim-assembly 1001 may differ in that flangeless-trim-assembly 1001 may comprise means 1003 for adjusting a direction of how an attached light-module may shine light out from a bottom of flangeless-trim-assembly 1001. In some embodiments, flangeless-trim-assembly 1001 may comprise: articulation-means 1003, holder 1005, connector(s) 1007, and/or reflector 1201. In some embodiments, articulation-means 1003 may be one or more gear(s), pinion(s), and/or rack(s) system(s) that permit articulation, rotation, pitch, and/or tilt of an orientation of holder 1005 (and a light-module that may be mounted to holder 1005).

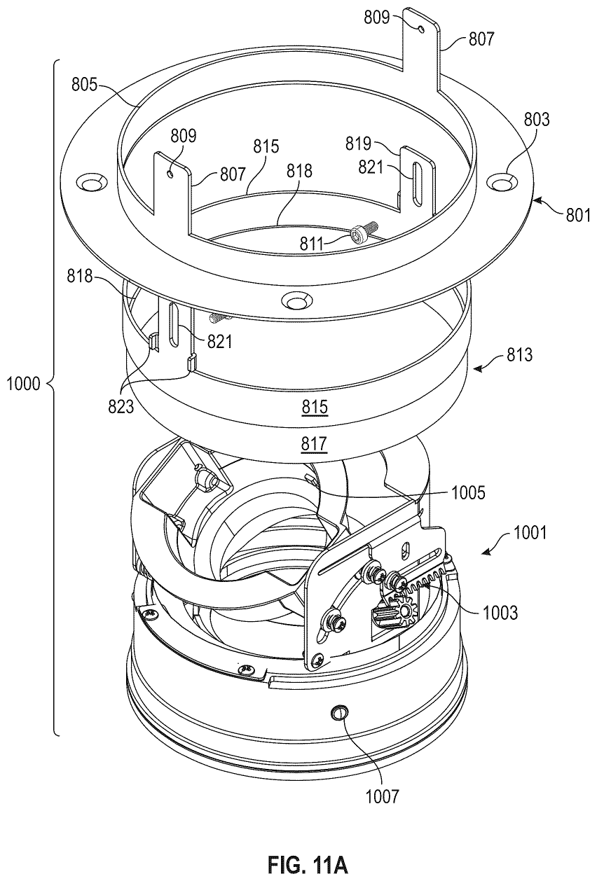

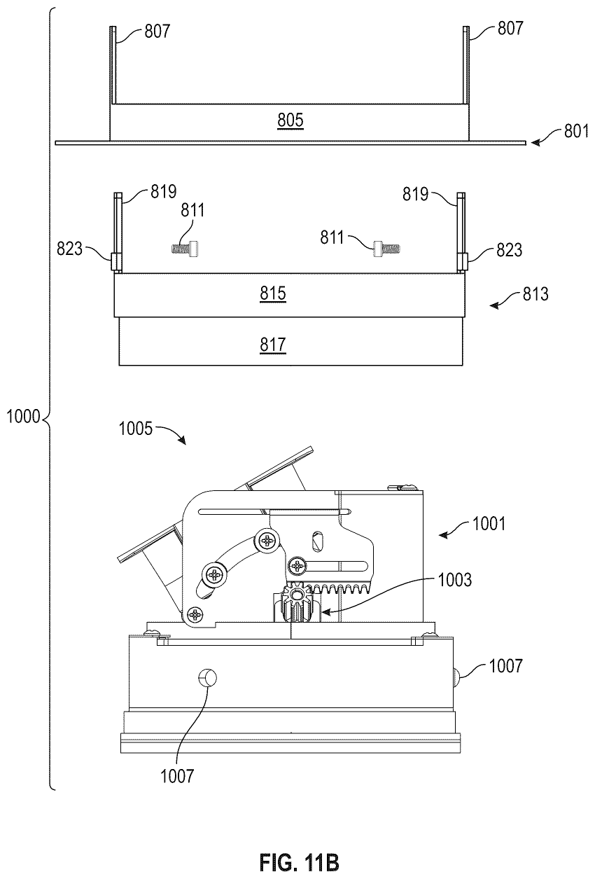

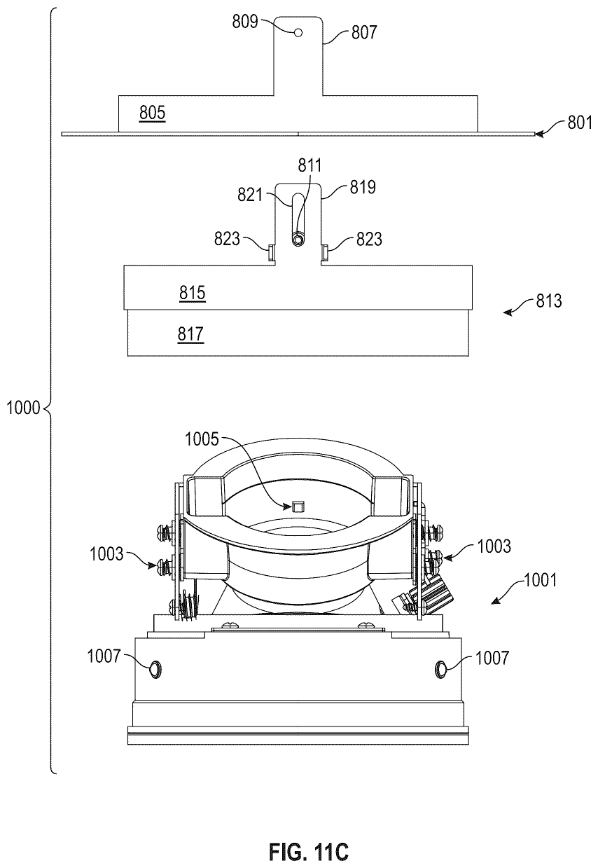

Continuing discussing FIG. 10A, FIG. 10B, FIG. 10C, and FIG. 10D, in some embodiments, a portion of a given flangeless-trim-assembly 1001 (e.g., its connector(s) 1007) may removably and fixedly attach onto ledge 818 of adjustable-collar 813; and a region of that same given flangeless-trim-assembly 1001 (e.g., its holder 1005) may removably and fixedly attach to a given light-module. In some embodiments, flangeless-trim-assembly 1001 may be an assembly that forms a flangeless-trim in a ceiling recessed lighting application; such that when flangeless-trim-assembly 1001 may be installed in and mostly above a given ceiling, only its reflector 1201 portions may be visible to an observer located below that ceiling with the installed flangeless-trim-assembly 1001 (see e.g., FIG. 12B). In some embodiments, flangeless-trim-assembly 1001 may comprise: articulation-means 1003, holder 1005, reflector 1201, and connector(s) 1007. In some embodiments, holder 1005 may be located in an upper region of flangeless-trim-assembly 1001 and may be configured to removably and fixedly attach to a bottom portion of a given light-module via a twist-lock motion. In some embodiments, holder 1005 may not be located in the articulation-means 1003. In some embodiments, at least some lower portions of flangeless-trim-assembly 1001 may comprise its reflector 1201 (e.g., shown in FIG. 12B). In some embodiments, reflector 1201 may be configured to reflecting at least some light emitted by the light-module that may be attached above at holder 1005. In some embodiments, flangeless-trim-assembly 1001 may comprise one or more connector(s) 1007. In some embodiments, connector(s) 1007 may complementary, removably, and/or fixedly attach onto ledge 818 of adjustable-collar 813 (or right above ledge 818, with connector(s) 1007 physically touching an inside surface of upper-sidewall 815 and/or physically touching a top of ledge 818). Note, connector(s) 1007 may be best shown in FIG. 11A, FIG. 11B, FIG. 11C, and/or in FIG. 10D. In some embodiments, at least a portion of a given connector 1007 may be a solid and substantially hemispherical shape (e.g., formed from a rounded/curved screw/bolt head or the like), that may fit onto a given ledge 818 (of adjustable-collar 813) and/or protrude over ledge 818 when flangeless-trim-assembly 1001 may be (removably) attached to adjustable-collar 813. In some embodiments, a given connector 1007 may be located on an exterior cylindrical sidewall of a lower portion of flangeless-trim-assembly 1001 (below the articulation-means 1003) and with the substantially hemispherical shape of the given connector 1007 facing outwards. In some embodiments, flangeless-trim-assembly 1001 may comprise two or more connectors 1007. In some embodiments, flangeless-trim-assembly 1001 may comprise three connectors 1007. In some embodiments, when flangeless-trim-assembly 1001 may comprise two or more connectors 1007, then those two or more connectors 1007 may be located equidistant from each other on an exterior cylindrical sidewall of a lower portion of flangeless-trim-assembly 1001 and with the substantially hemispherical shape of the given connector 1007 facing outwards. In some embodiments, to (removably) attach flangeless-trim-assembly 1001 to adjustable-collar 813, the installer may only have to push flangeless-trim-assembly 1001 into an internal-volume (of adjustable-collar 813) until one or more connector(s) 1007 seat onto ledge 818 (protrude over ledge 818) of adjustable-collar 813. See FIG. 10A, FIG. 10B, FIG. 10C, and FIG. 10D for flangeless-trim-assembly 1001; and see also FIG. 11A, FIG. 11B, and FIG. 11C for flangeless-trim-assembly 1001.

FIG. 11A is a top perspective exploded view of assembly 1000 showing adapter-assembly 800 in a dissembled configuration (without dust-cover 825) and showing flangeless-trim-assembly 1001 in an assembled configuration but separated from adapter-assembly 800 components. FIG. 11B is a front exploded view (or a rear exploded view) of assembly 1000 showing adapter-assembly 800 in a dissembled configuration (without dust-cover 825) and showing flangeless-trim-assembly 1001 in an assembled configuration but separated from adapter-assembly 800 components. FIG. 11C is a right-side exploded view (or a left-side exploded view) of assembly 1000 showing adapter-assembly 800 in a dissembled configuration (without dust-cover 825) and showing flangeless-trim-assembly 1001 in an assembled configuration but separated from adapter-assembly 800 components. In some embodiments, the exploded views of FIG. 11A, FIG. 11B, and/or FIG. 11C show that when the flangeless-trim-assembly 1001 is (removably) connected to adjustable-collar 813, that the exterior cylindrical sidewall of the lower portion of flangeless-trim-assembly 1001 (below the articulation-means 1003) where the connectors 1007 are located may fit inside of adjustable-collar 813, with that exterior cylindrical sidewall of the lower portion of flangeless-trim-assembly 1001 (below the articulation-means 1003) where the connectors 1007 are located, fitting inside of upper-sidewall 815 and with the connectors 1007 located above ledge 818 when flangeless-trim-assembly 1001 is (removably) connected to adjustable-collar 813. In some embodiments, the exploded views of FIG. 11A, FIG. 11B, and/or FIG. 11C show that when adjustable-collar 813 is (removably) connected to annular-disk 801, that adjustable-collar 813 may up and/or inside of collar 805, and then a given mechanical-fastener 811 may be connected to a given hole 809 and connected to a given slot 821 on one side of adapter-assembly 800.

FIG. 12A may be a right-side view (or left-side view) of assembly 1000 wherein assembly 1000 may be fixedly attached to a section (portion and/or region) of a ceiling 300. Specifically, adapter-assembly 800 (of assembly 1000) may be fixedly attached to a section (portion and/or region) of a ceiling 300. FIG. 12A also includes sectional-line 12B-12B. In some embodiments, adapter-assembly 800 (with or without dust-cover 825) may be configured to be (fixedly) attached to ceiling 300. In some embodiments, aperture(s) 803 of annular-disk 801 (via mechanical-fastener(s) 303 fitting into aperture(s) 803 and into material of ceiling 300) may be configured to be (fixedly) attached to ceiling 300. In some embodiments, a bottom surface portion of annular-disk 801 may be configured to be (fixedly) attached to a top surface of ceiling 300. In some embodiments, a bottom surface portion of annular-disk 801 may be in direct physical contact with a top surface of ceiling 300. FIG. 12A shows annular-disk 801 (via its aperture(s) 803) that is fixedly attached to ceiling 300. FIG. 12A shows a bottom surface portion of a given annular-disk 801 that is fixedly attached to a top portion of ceiling 300. FIG. 12A shows a bottom surface portion of a given annular-disk 801 is in direct physical contact with a top portion of ceiling 300.

FIG. 12B may be a cross-sectional view through sectional-line 12B-12B of FIG. 12A. FIG. 12B may show a cross-sectional view through assembly 1000 and through a portion (section and/or region) of ceiling 300. FIG. 12B shows a bottom surface portion of a given annular-disk 801 is in direct physical contact with a top portion of ceiling 300. FIG. 12B shows a bottom surface portion of a given annular-disk 801 that is fixedly attached to a top portion of ceiling 300 using a mechanical-fastener 303 passing at least partially through a given aperture 803 (of annular-disk 801) and wherein a bottom portion of that same mechanical-fastener 303 may be driven into material of ceiling 300. In some embodiments, assembly 1000, flangeless-trim-subassembly 1001, and/or adapter-assembly 800 may comprise at least one mechanical-fastener 303 per a quantity of aperture(s) 803 of adapter-assembly 800 and/or of annular-disk 801. In some embodiments, mechanical-fastener 303 may fixedly attach to annular-disk 801 (via a given aperture 803 that the mechanical-fastener 303 at least partially passes through) to a top portion of ceiling 300. In some embodiments, at least a portion of mechanical-fastener 303 may pass through annular-disk 801 (via a given aperture 803 that the mechanical-fastener 303 at least partially passes through); and another portion of that same mechanical-fastener 303 may pass into material of ceiling 300 (anchoring into ceiling 300). In some embodiments, a total length of mechanical-fastener 303 may be configured to be less than thickness 301 (thickness 301 may be a thickness of ceiling 300). In some embodiments, mechanical-fastener 303 may enter annular-disk 801 (via a given aperture 803) and ceiling 300 from a top (upper) side of ceiling 300. FIG. 12B shows mechanical-fasteners 303 are used to secure annular-disk 801 (via its aperture(s) 803) to a top portion of ceiling 300 (e.g., by using at least one mechanical-fastener 303 per at least some of the aperture(s) 803). In some embodiments, mechanical-fastener 303 may not enter ceiling 300 and annular-disk 801 (via a given aperture 803) from a bottom (under) side of ceiling 300.

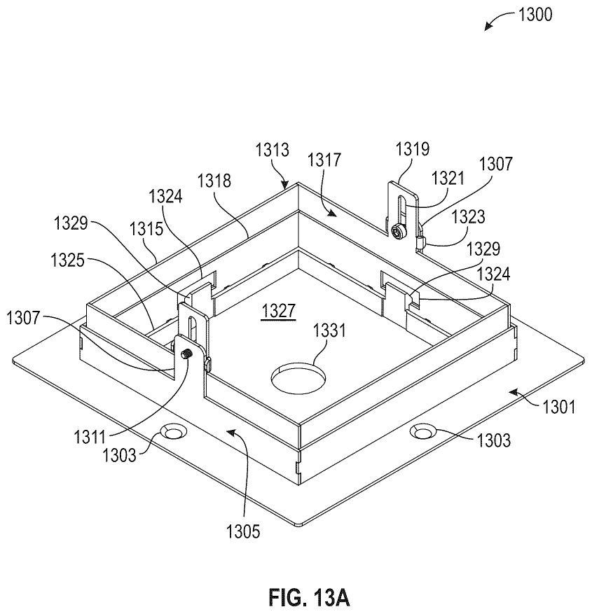

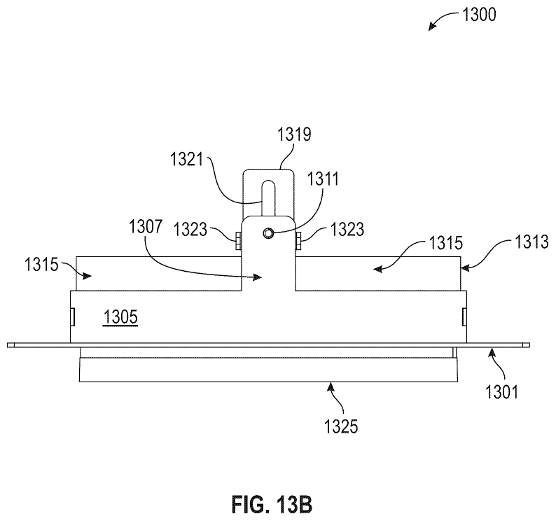

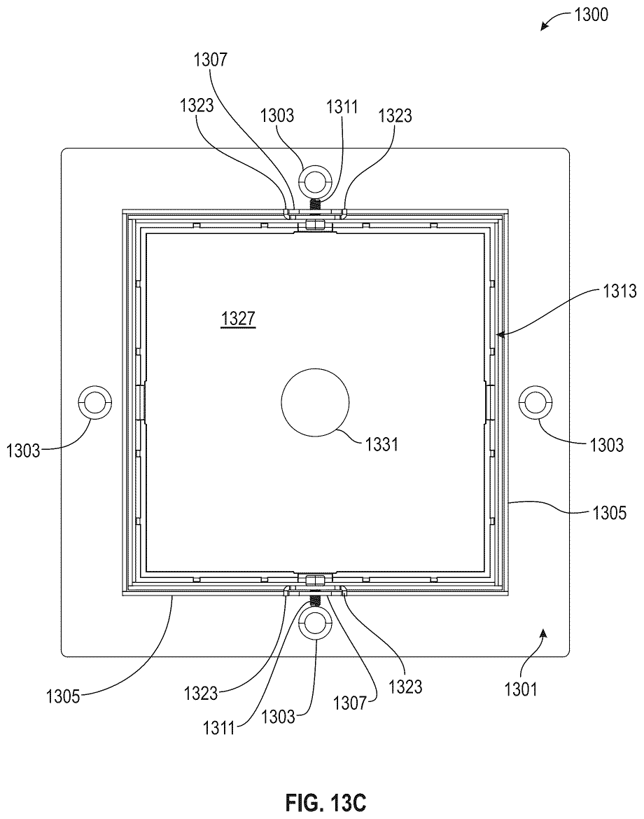

FIG. 13A is a top perspective view of an adapter-assembly 1300 according to at least one embodiment. FIG. 13B is a top view of adapter-assembly 1300. FIG. 13C is a right-side view (or a left-side view) of adapter-assembly 1300. In some embodiments, adapter-assembly 1300 may serve a same function, purpose, and/or goal as of adapter-assembly 800, except adapter-assembly 1300 and adapter-assembly 800 may have different structures, shapes (and dimensions) from each other. For example, and without limiting the scope of the present invention, where adapter-assembly 800 may have and/or use at least substantially (mostly) cylindrical shaped main (largest) components, adapter-assembly 1300 may have and/or use at least substantially (mostly) rectangular prism shaped main (largest) components. In some embodiments, in terms of parts (components) adapter-assembly 1300 may comprise an annular-disk 1301 (with a rectangular prism shape) and an adjustable-collar 1313 (with a rectangular prism shape). In some embodiments, in terms of parts (components) adapter-assembly 1300 may comprise annular-disk 1301, adjustable-collar 1313, and at least one mechanical-fastener 1311 (which may be the same as mechanical-fastener 811 in some embodiments). In some embodiments, in terms of parts (components) adapter-assembly 1300 may comprise annular-disk 1301, adjustable-collar 1313, and dust-cover 1325 (with a rectangular prism shape). In some embodiments, in terms of parts (components) adapter-assembly 1300 may comprise at least one of: annular-disk 1301, adjustable-collar 1313, mechanical-fastener 1311, and/or dust-cover 1325.

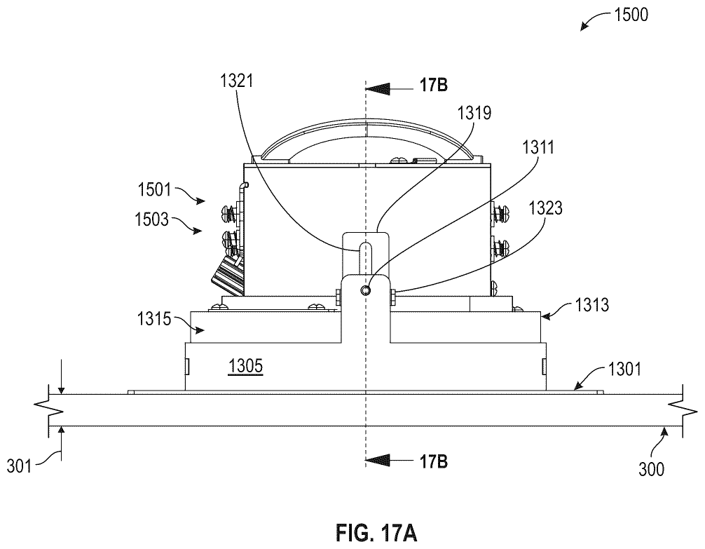

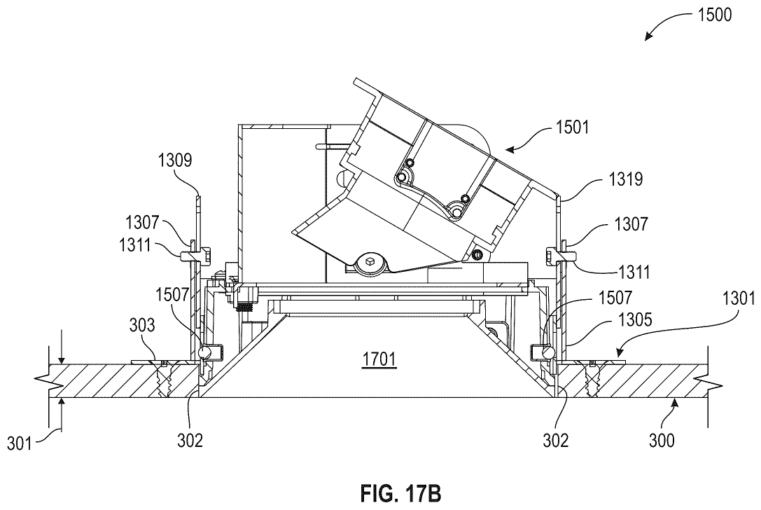

Continuing discussing FIG. 13A, FIG. 13B, and FIG. 13C, in some embodiments, annular-disk 1301 (flange-with-collar-member 1301) may be a part (component) that has a flat square/rectangular annular disk portion (flange-region) with a largest transverse width/length dimension of adapter-assembly 1300, wherein extending upwards from a largest and centered square/rectangular hole 1302 of square/rectangular annular-disk 1301 may be a square/rectangular collar 1305. In some embodiments, located in the flat square/rectangular annular disk portion of annular-disk 1301 may be at least one aperture 1303. In some embodiments, aperture 1303 may be through hole that extends all the way through a thickness of the flat square/rectangular annular disk portion of annular-disk 1301. In some embodiments, aperture 1303 may be to receive at least a portion of mechanical-fastener 303 therein for a purpose of fixedly attaching annular-disk 1301 to a top (upper) portion of ceiling 300 (e.g., as shown in FIG. 17A and/or FIG. 17B).

Continuing discussing FIG. 13A, FIG. 13B, and FIG. 13C, in some embodiments, annular-disk 1301 may comprise collar 1305. In some embodiments, collar 1305 may be a member of rectangular, square, and/or rectangular prism shaped four-sided sidewall that extends upwards from largest and centered hole 1302 of annular-disk 1301 by a uniform, fixed, finite, predetermined, and non-variably amount (aside from its tab(s) 1307 of collar 1305). In some embodiments, collar 1305 may have a height that is uniform, fixed, finite, predetermined, and non-variable (aside from tab(s) 1307 of collar 1305). In some embodiments, collar 1305 may have a thickness that is uniform, fixed, finite, predetermined, and non-variable. In some embodiments, collar 1305 may be free of holes, apertures, and/or slots. In some embodiments, extending from a top (upper side/upper surface) of collar 1305 may be at least one tab 1307. In some embodiments, extending from a top (upper side/upper surface) of collar 1305 may be at least two tabs 1307. In some embodiments, when collar 1305 may have (comprise) two or more tabs 1307, those tabs 1307 may be spaced and/or located equidistant from each other around/on collar 1305. In some embodiments, when collar 1305 may have (comprise) two tabs 1307, those tabs 1307 may be oppositely disposed from each other around/on collar 1305. In some embodiments, when collar 1305 may have (comprise) two tabs 1307, those tabs 1307 may be spaced and/or located 180 degrees from each other around/on collar 1305. In some embodiments, tab 1307 may be protrusion of material extending from a top (upper side/upper surface) of collar 1305. In some embodiments, tab 1307 may have (comprise) a height that is uniform, fixed, finite, predetermined, and/or non-variable. In some embodiments, tab 1307 may comprise at least one hole 1309. In some embodiments, hole 1309 may be located in tab 1307. In some embodiments, hole 1309 may be a through hole that passes entirely through a thickness of tab 1307. In some embodiments, the thickness of tab 1307 may be uniform, fixed, finite, predetermined, and/or non-variable. In some embodiments, hole 1309 may be located in an upper (top) portion of tab 1307 (disposed away from collar 1305). In some embodiments, hole 1309 may not be located in a lower (bottom) portion of tab 1307 (closer to collar 1305 than to a top of tab 1307). In some embodiments, hole 1309 may not be slot/slit. In some embodiments, hole 1309 may be configured to receive at least a portion of a mechanical-fastener 1311 therein. In some embodiments, annular-disk 1301 may comprise at least one of: aperture(s) 1303, collar 1305, tab(s) 1307, and/or hole(s) 1309. In some embodiments, annular-disk 1301 may comprise: aperture(s) 1303, collar 1305, tab(s) 1307, and/or hole(s) 1309.

Continuing discussing FIG. 13A, FIG. 13B, and FIG. 13C, in some embodiments, adapter-assembly 1300, annular-disk 1301, and/or adjustable-collar 1313 may comprise at least one mechanical-fastener 1311. In some embodiments, adapter-assembly 1300, annular-disk 1301, and/or adjustable-collar 1313 may comprise a quantity of mechanical-fastener(s) 1311 to match (equal) a quantity of hole(s) 1309 and/or a quantity of slot(s) 1321 (of adjustable-collar 1313). In some embodiments, mechanical-fastener 1311 may be selected from: a screw, a bolt, a rivet, a pin, a dowel, mechanical-fastener 811, a portion thereof, combinations thereof, and/or the like. In some embodiments, mechanical-fastener 1311 may be configured to receive a nut and/or a wing-nut. In some embodiments, adapter-assembly 1300, annular-disk 1301, and/or adjustable-collar 1313 may comprise a quantity of nuts and/or wing nuts to match (equal) a quantity of mechanical-fastener(s) 1311.

Continuing discussing FIG. 13A, FIG. 13B, and FIG. 13C, in some embodiments, (rectangular/square) adjustable-collar 1313 may be configured to be fixedly attached to annular-disk 1301, but may also be configured to vertically (up or down) be adjusted with respect to annular-disk 1301 and when a desired vertical placement is made to then be fixedly attached to annular-disk 1301 at that particular vertical placement using mechanical-fastener(s) 1311, hole(s) 1309, and slot(s) 1321 (and optionally nuts/wing nuts). In some embodiments, adjustable-collar 1313 may mostly (substantially) be a hollow rectangular prism shaped member. In some embodiments, the hollow rectangular prism shaped member of adjustable-collar 1313 may comprise an upper-sidewall 1315 and a lower lower-sidewall 1317. In some embodiments, the top portion of lower-sidewall 1317 may attach to (connect to) the bottom portion of upper-sidewall 1315. In some embodiments, upper-sidewall 1315 may be made up of four sidewalls in a hollow rectangular prism shape. In some embodiments, lower-sidewall 1317 may be made up of four sidewalls in a hollow rectangular prism shape. In some embodiments, upper-sidewall 1315 and lower-sidewall 1317 are integrally connected to each other such that adjustable-collar 1313 is a single article of manufacture. In some embodiments, upper-sidewall 1315 may be a solid (four sided) sidewall located on an upper region of adjustable-collar 1313. In some embodiments, lower-sidewall 1317 may be a mostly (substantially) solid (four sided) sidewall located on a lower region of adjustable-collar 1313 (lower-sidewall 1317 may be solid except where cutouts [windows] 1324 are located). In some embodiments, upper-sidewall 1315 and/or lower-sidewall 1317 may be free from holes, apertures, and/or slots (except where cutouts [windows] 1324 are located in lower-sidewall 1317). In some embodiments, upper-sidewall 1315 and lower-sidewall 1317 may be oppositely disposed from each other, with upper-sidewall 1315 on top of lower-sidewall 1317 (or with lower-sidewall 1317 beneath upper-sidewall 1315). In some embodiments, upper-sidewall 1315 may have a thickness that is uniform, finite, fixed, predetermined, and/or non-variable. In some embodiments, lower-sidewall 1317 may have a thickness that is uniform, finite, fixed, predetermined, and/or non-variable. In some embodiments, the thickness of upper-sidewall 1315 may be the same or different from the thickness of lower-sidewall 1317. In some embodiments, an outside-transverse-width/length of upper-sidewall 1315 may be larger than an outside-transverse-width/length of lower-sidewall 1317. In some embodiments, an inside-transverse-width/length of upper-sidewall 1315 may be larger than an inside-transverse-width/length of lower-sidewall 1317. In some embodiments, the outside-transverse-width/length of upper-sidewall 1315 may be uniform, fixed, finite, predetermined, and/or non-variable. In some embodiments, the inside-transverse-width/length of upper-sidewall 1315 may be uniform, fixed, finite, predetermined, and/or non-variable. In some embodiments, the outside-transverse-width/length of upper-sidewall 1315 may be larger than the inside-transverse-width/length of upper-sidewall 1315. In some embodiments, the outside-transverse-width/length of lower-sidewall 1317 may be uniform, fixed, finite, predetermined, and/or non-variable. In some embodiments, the inside-transverse-width/length of lower-sidewall 1317 may be uniform, fixed, finite, predetermined, and/or non-variable. In some embodiments, the outside-transverse-width/length of lower-sidewall 1317 may be larger than the inside-transverse-width/length of lower-sidewall 1317. In some embodiments, with respect to inside (internal) surfaces of upper-sidewall 1315 and lower-sidewall 1317, where lower-sidewall 1317 transitions into upper-sidewall 1315 may be a step 1318 or a ledge 1318 (or a shelf). In some embodiments, this step 1318 (or ledge 1318), at an internal (interior) transition from lower-sidewall 1317 to upper-sidewall 1315, may be configured to receive (and/or support) a portion of a prong 1329 (of dust-cover 1325); and/or step 1318 may be configured to receive (and/or support) a portion of connector(s) 1507 of flangeless-trim-assembly 1501.

Continuing discussing FIG. 13A, FIG. 13B, and FIG. 13C, in some embodiments, lower-sidewall 1317 (of adjustable-collar 1313) may comprise at least one window 1324. In some embodiments, at least one side of lower-sidewall 1317 may comprise at least one window 1324. In some embodiments, each side of lower-sidewall 1317 may comprise at least one window 1324. In some embodiments, at least one window 1324 may be located in a given side of lower-sidewall 1317. In some embodiments, a window 1324 may be located in a middle of a given side of lower-sidewall 1317 (with respect to a length of that given side). In some embodiments, window 1324 may be a window and/or a cutout in a portion (region/section) of a given side of lower-sidewall 1317. In some embodiments, window 1324 may be a window and/or a cutout in a portion (region/section) of a given side of lower-sidewall 1317, that passes entirely through a thickness of lower-sidewall 1317. In some embodiments, window 1324 may have a rectangle, rectangular, and/or a square opening. In some embodiments, a given window 1324 may comprise (have) a bottom ledge. In some embodiments, a shape of window 1324 may match and/or may be complementary to a shape of prong(s) 1329, such that a bottom ledge of window 1324 may be configured to (removably) receive and/or support a prong 1329 on top of that bottom ledge of a given window 1324. In some embodiments, a bottom ledge of a given window 1324 may be configured to receive (and/or support) a portion of a prong 1329 (of dust-cover 1325); and/or the bottom ledge of the given window 1324 may be configured to receive (and/or support) a portion of connector(s) 1507 of flangeless-trim-assembly 1501.

Continuing discussing FIG. 13A, FIG. 13B, and FIG. 13C, in some embodiments, adjustable-collar 1313, upper-sidewall 1315, and/or adapter-assembly 1300 may comprise at least one tab 1319. In some embodiments, adjustable-collar 1313, upper-sidewall 1315, and/or adapter-assembly 1300 may comprise at least two tabs 1319. In some embodiments, extending from a top of upper-sidewall 1315 may be at least one tab 1319. In some embodiments, extending from a top of upper-sidewall 1315 may be at least two tabs 1319. In some embodiments, when upper-sidewall 1315 may have (comprise) two or more tabs 1319, those tabs 1319 may be spaced and/or located equidistant from each other around/on upper-sidewall 1315. In some embodiments, when upper-sidewall 1315 may have (comprise) two tabs 1319, those tabs 1319 may be oppositely disposed from each other around/on upper-sidewall 1315. In some embodiments, when upper-sidewall 1315 may have (comprise) two tabs 1319, those tabs 1319 may be spaced and/or located 180 degrees from each other around/on upper-sidewall 1315. In some embodiments, tab 1319 may be a protrusion of material extending from a top of upper-sidewall 1315. In some embodiments, tab 1319 may have (comprise) a height that is uniform, fixed, finite, predetermined, and/or non-variable. In some embodiments, tab 1319 may comprise at least one slot 1321. In some embodiments, slot 1321 may be located in tab 1319. In some embodiments, slot 1321 may be a through slot that passes entirely through a thickness of tab 1319. In some embodiments, the thickness of tab 1319 may be uniform, fixed, finite, predetermined, and/or non-variable. In some embodiments, slot 1321 may be a vertical slot in tab 1319, wherein a length of slot 1321 may be parallel with a length (height) of tab 1319. In some embodiments, slot 1321 may be configured to receive at least a portion of a mechanical-fastener 1311 therein. In some embodiments, a given slot 1321 may be aligned with a given hole 1309 (of a given tab 1307 of annular-disk 1301) so that a given mechanical-fastener 1311 may be used to fixedly fasten that tab 1307 (with the given hole 1309) to that tab 1319 (with the given slot 1321). In some embodiments, slot 1321 may be entirely located within a given tab 1319. In some embodiments, a periphery (perimeter) of a given slot 1321 may be entirely enclosed by material of a given tab 1319. In some embodiments, a length of each tab 1319 may be vertically aligned and/or parallel with a length of a given tab 1307. In some embodiments, each tab 1319 may comprise a pair of guides 1323 (fences 1323). In some embodiments, a pair of guides 1323 (fences 1323) may be located on (attached to/connected to) to a given tab 1319. In some embodiments, a pair of guides 1323 (fences 1323), of a given tab 1319, may be spaced apart from each other by a width of given tab 1319. In some embodiments, a pair of guides 1323 (fences 1323), of a given tab 1319, may be spaced apart from each other by a width of a given tab 1307 (of annular-disk 1301). In some embodiments, a width of tab 1319 may be at least substantially (mostly) similar to a width of tab 1307 (of annular-disk 1301). In some embodiments, a pair of guides 1323 (fences 1323), of a given tab 1319, may be outwardly extending protrusions of material, that extend away from a center of adapter-assembly 1300, of annular-disk 1301, and/or of adjustable-collar 1313. In some embodiments, a pair of guides 1323 (fences 1323), of a given tab 1319, may be outwardly extending protrusions of material, that extend away from that given tab 1319 and towards a given tab 1307 of annular-disk 1301. In some embodiment, a pair of guides 1323 (fences 1323), of a given tab 1319, may be configured to vertically align (and to maintain that vertical alignment) a given tab 1307 (of annular-disk 1301) so that openings of hole 1309 and slot 1321 are in alignment with each other (for receiving mechanical-fastener 1311 in those aligned openings). In some embodiments, a given tab 1307 may fit in between a given pair of guides 1323 (fences 1323).

Continuing discussing FIG. 13A, FIG. 13B, and FIG. 13C, in some embodiments, dust-cover 1325 may be a dust cover that removably (temporarily) overs over a main (largest and centered) bottom opening of adjustable-collar 1313 and/or of annular-disk 1301, until a flangeless-trim-assembly 1501 may be installed into adjustable-collar 1313. In some embodiments, adapter-assembly 1300 may be fixedly mounted (installed) onto (a top of) a given ceiling 300 (e.g., as shown in FIG. 17A and/or in FIG. 17B); however, flangeless-trim-assembly 1501 may or may not be installed at a same time when adapter-assembly 1300 is mounted to ceiling 300. If adapter-assembly 1300 is mounted to ceiling 300 and a flangeless-trim-assembly 1501 is not yet installed into adjustable-collar 1313, then under that scenario adapter-assembly 1300 may optionally include (comprise) dust-cover 1325, with that dust-cover 1325 attached to adjustable-collar 1313 and covering over the main (largest and centered) bottom opening of adjustable-collar 1313 and/or of annular-disk 1301, to minimize dust intrusion into adapter-assembly 1300. When flangeless-trim-assembly 1501 is to be installed into adjustable-collar 1313, then dust-cover 1325 (if present) is removed from adjustable-collar 1313. In some embodiments, dust-cover 1325 may comprise at least mostly closed surface 1327 and at least one upward protruding (extending) prong 1329. In some embodiments, at least mostly closed surface 1327 may be at least substantially (mostly) flat, planar, and/or horizontal surface that is configured to minimize movement of dust past (through) at least mostly closed surface 1327. In some embodiments, at least mostly closed surface 1327 may comprise at least one hole 1331. In some embodiments, hole 1331 may be a through hole through a thickness of at least mostly closed surface 1327. In some embodiments, the thickness of at least mostly closed surface 1327 may be uniform, finite, fixed, predetermined, and/or non-variable. In some embodiments, hole 1331 may be sized and/or configured to removably (temporarily) receive at least a portion of at least one finger (or thumb) of an installer and may be how the installed removes dust-cover 1325 from adjustable-collar 1313. In some embodiments, extending upwards from an outer region of dust-cover 1325 may be at least one prong 1329. In some embodiments, extending upwards from an outer region of dust-cover 1325 may be one or more prongs 1329. In some embodiments, extending upwards from an outer region of dust-cover 1325 may be two or more prongs 1329. In some embodiments, extending upwards from an outer region of dust-cover 1325 may be three prongs 1329. In some embodiments, extending upwards from an outer region of dust-cover 1325 may be four prongs 1329. In some embodiments, when dust-cover 1325 may have (comprise) two or more prongs 1329, those prongs 1329 may be spaced and/or located equidistant from each other around/on an outer region of dust-cover 1325. In some embodiments, a portion of prong 1329 may be configured to removably latch (grab) onto ledge 1318 of adjustable-collar 1313 and/or onto a bottom ledge of a given window 1324 (of adjustable-collar 1313); and is thus how dust-cover 1325 may be removably attached to adjustable-collar 1313.

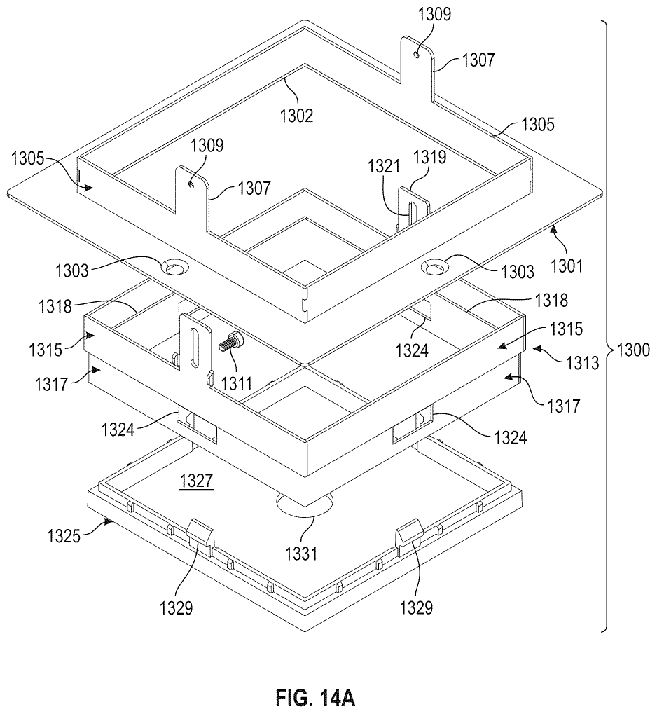

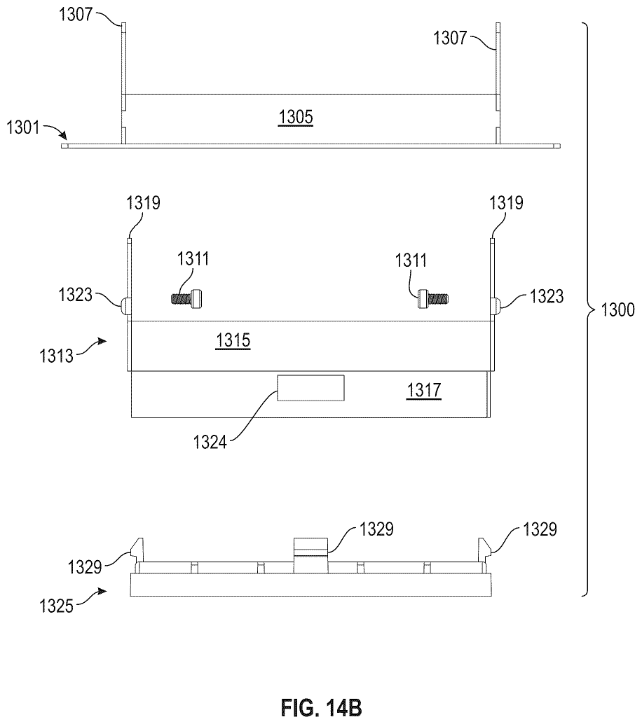

FIG. 14A is a top perspective exploded view of an adapter-assembly 1300 that shows annular-disk 1301, adjustable-collar 1313, mechanical-fastener(s) 1311, and/or dust-cover 1325 separated (dissembled) from each other. FIG. 14B is a right-side exploded view (or a left-side exploded view) of adapter-assembly 1300 that shows annular-disk 1301, adjustable-collar 1313, mechanical-fastener 1311, and/or dust-cover 1325 separated (dissembled) from each other.

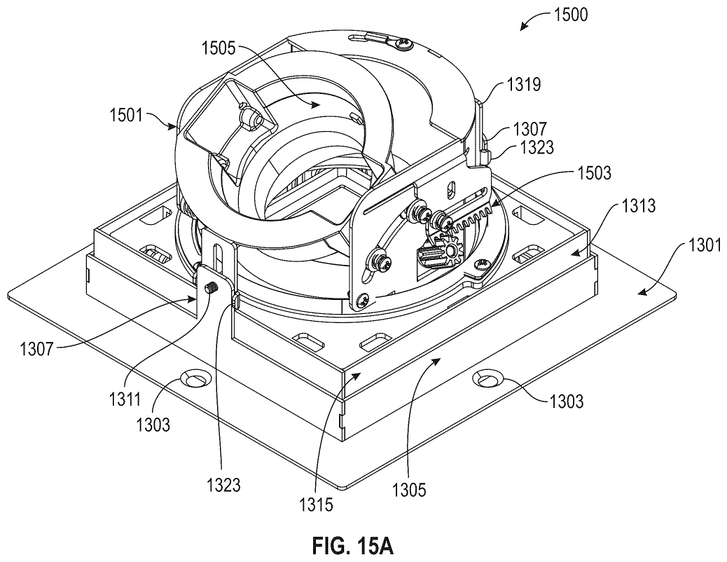

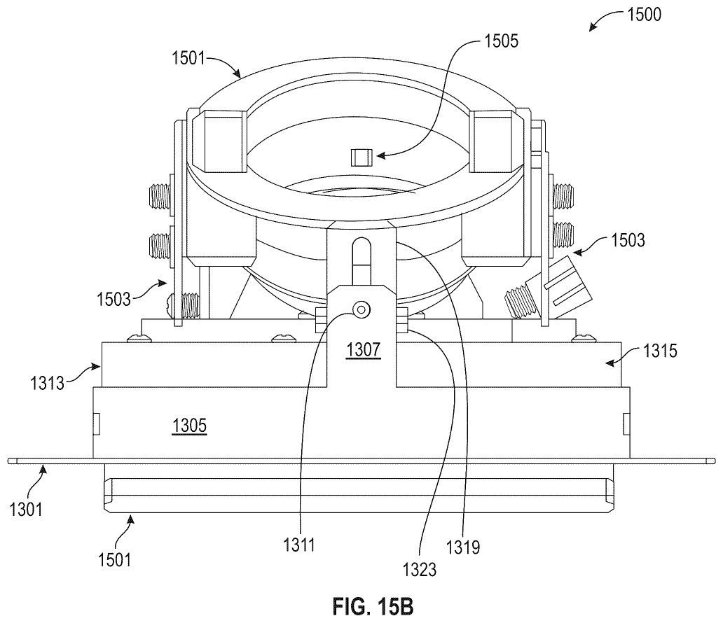

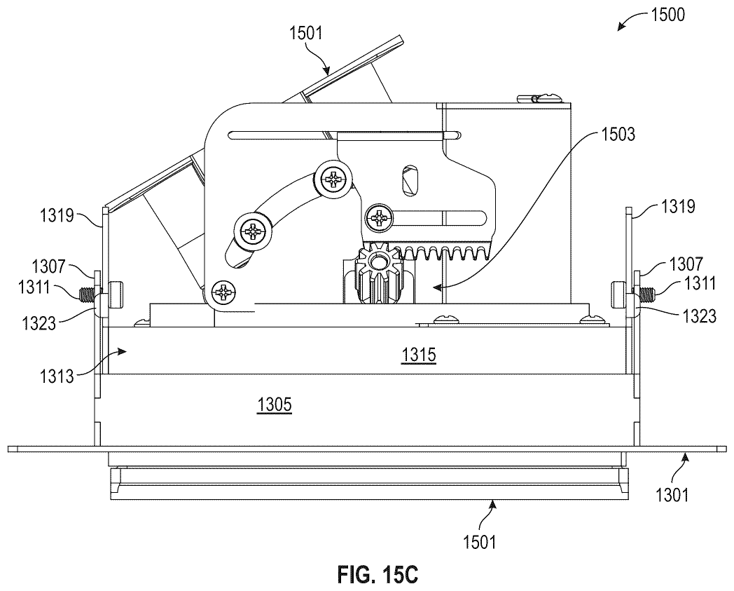

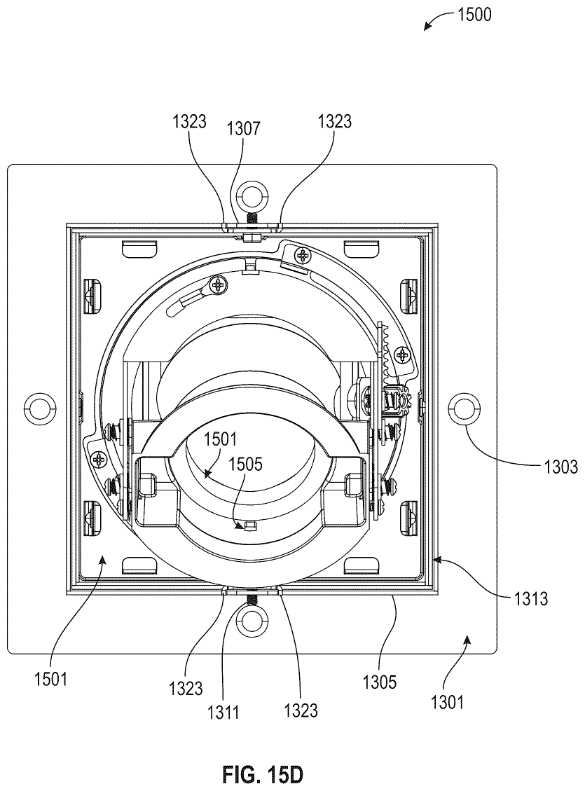

FIG. 15A is a top perspective view of an assembly 1500 according to at least one embodiment. FIG. 15B is a right-side view (or a left-side view) of assembly 1500. FIG. 15C is a front view (or a rear view) of assembly 1500. FIG. 15D is a top view of assembly 1500. In some embodiments, assembly 1500 may be assembly-of-adapter-and-trim 1500. In some embodiments, assembly 1500 may comprise one (1) adapter-assembly 1300 (without dust-cover 1325) and one (1) flangeless-trim-assembly 1501 that are (removably) attached to each other. In some embodiments, flangeless-trim-assembly 1501 may be similar to flangeless-trim-assembly 1001, i.e., in functioning as a flangeless trim member and that may receive attachment of a given light-module and that may also attach to a given adapter; however, flangeless-trim-assembly 1501 may differ from flangeless-trim-assembly 1001 in that flangeless-trim-assembly 1501 may comprise means 1503 for adjusting a direction of how an attached light-module may shine light out from a bottom of flangeless-trim-assembly 1501. In some embodiments, flangeless-trim-assembly 1501 may differ from flangeless-trim-assembly 1001, by flangeless-trim-assembly 1501 having an at least substantially (mostly) overall/general rectangular prism shape (as opposed to the substantially [mostly] overall/general cylindrical shape of flangeless-trim-assembly 1001). In some embodiments, flangeless-trim-assembly 1501 may comprise: articulation-means 1503, holder 1505, connector(s) 1507, and/or reflector 1701. In some embodiments, articulation-means 1503 may be one or more gear(s), pinion(s), and/or rack(s) system(s) that permit articulation, rotation, pitch, and/or tilt of an orientation of holder 1505 (and a light-module that may be mounted to holder 1505 of flangeless-trim-assembly 1501).

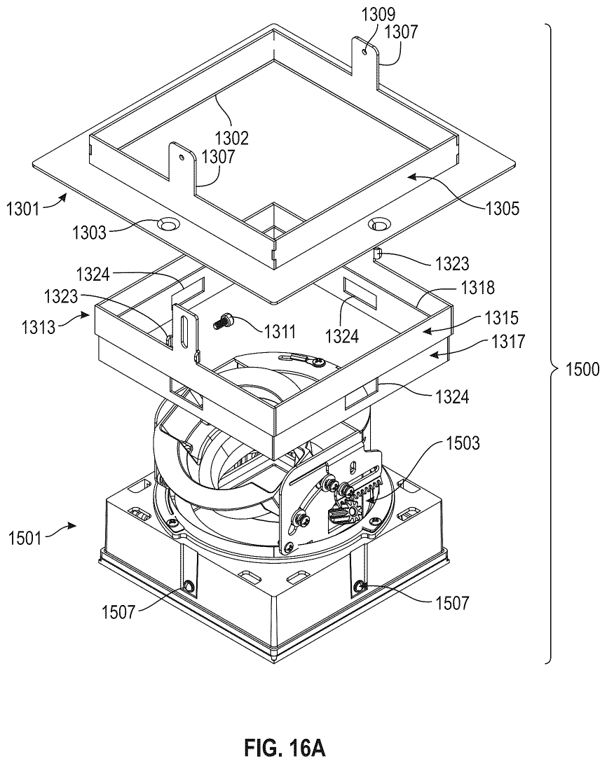

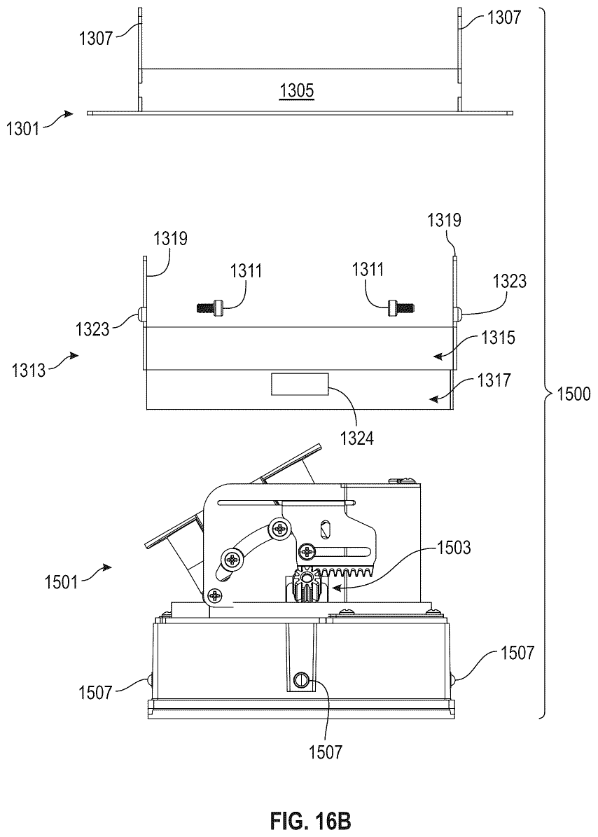

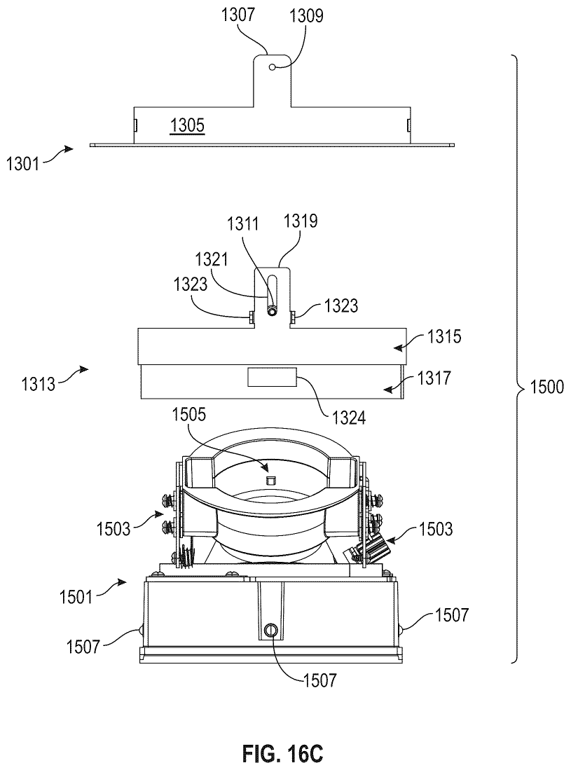

Continuing discussing FIG. 15A, FIG. 15B, FIG. 15C, and FIG. 15D, in some embodiments, a portion of a given flangeless-trim-assembly 1501 (e.g., its connector(s) 1507) may removably and fixedly attach onto ledge 1318 of adjustable-collar 1313 (and/or onto bottom ledges of windows 1324); and a region of that same given flangeless-trim-assembly 1501 (e.g., its holder 1505) may removably and fixedly attach to a given light-module. In some embodiments, flangeless-trim-assembly 1501 may be an assembly that forms a flangeless-trim in a ceiling recessed lighting application; such that when flangeless-trim-assembly 1501 may be installed in and mostly above a given ceiling, only its reflector 1701 portions may be visible to an observer located below that ceiling with the installed flangeless-trim-assembly 1501 (see e.g., FIG. 17B). In some embodiments, flangeless-trim-assembly 1501 may comprise: articulation-means 1503, holder 1505, reflector 1701, and connector(s) 1507. In some embodiments, holder 1505 may be located in an upper region of flangeless-trim-assembly 1501 and may be configured to removably and fixedly attach to a bottom portion of a given light-module via a twist-lock motion. In some embodiments, holder 1505 may not be located in the articulation-means 1503. In some embodiments, at least some lower portions of flangeless-trim-assembly 1501 may comprise its reflector 1701 (e.g., shown in FIG. 17B). In some embodiments, reflector 1701 may be configured to reflecting at least some light emitted by the light-module that may be attached above at holder 1505. In some embodiments, flangeless-trim-assembly 1501 may comprise one or more connector(s) 1507. In some embodiments, connector(s) 1507 may complementary, removably, and/or fixedly attach onto ledge 1318 of adjustable-collar 1313 (or right above ledge 1318, with connector(s) 1507 physically touching an inside surface of upper-sidewall 1315 and/or physically touching a top of ledge 1318). Note, connector(s) 1507 may be best shown in FIG. 16A, FIG. 16B, and/or FIG. 16C. In some embodiments, connector(s) 1507 may complementary, removably, and/or fixedly attach onto bottom ledge(s) of window(s) 1324 of adjustable-collar 1313 (or right above those bottom ledge(s) of window(s) 1324). In some embodiments, at least a portion of a given connector 1507 may be a solid and substantially (mostly) hemispherical (ball) shape (e.g., formed from a rounded/curved screw/bolt head or the like). In some embodiments, a half-ball and/or a hemisphere portion of a given connector 1507 may fit onto a given ledge 1318 (of adjustable-collar 1313) and/or protrude over ledge 1318 when flangeless-trim-assembly 1501 may be (removably) attached to adjustable-collar 1313. In some embodiments, a half-ball and/or a hemisphere portion of a given connector 1507 may fit onto a given bottom ledge of a given window 1324 (of adjustable-collar 1313) and/or protrude over that given bottom ledge of that given window 1324 when flangeless-trim-assembly 1501 may be (removably) attached to adjustable-collar 1313. In some embodiments, a given connector 1507 may be located on an exterior rectangular/square sidewall of a lower portion of flangeless-trim-assembly 1501 (below the articulation-means 1503) and with the substantially hemispherical shape of the given connector 1507 facing outwards. In some embodiments, flangeless-trim-assembly 1501 may comprise two or more connectors 1507. In some embodiments, flangeless-trim-assembly 1501 may comprise three connectors 1507. In some embodiments, flangeless-trim-assembly 1501 may comprise four connectors 1507. In some embodiments, when flangeless-trim-assembly 1501 may comprise two or more connectors 1507, then those two or more connectors 1507 may be located equidistant from each other on an exterior cylindrical sidewall of a lower portion of flangeless-trim-assembly 1501 and with the substantially hemispherical shape of the given connector 1507 facing outwards. In some embodiments, to (removably) attach flangeless-trim-assembly 1501 to adjustable-collar 1313, the installer may only have to push flangeless-trim-assembly 1501 into an internal-volume (of adjustable-collar 1313) until one or more connector(s) 1507 seat onto ledge 1318 (protrude over ledge 1318) of adjustable-collar 1313. In some embodiments, to (removably) attach flangeless-trim-assembly 1501 to adjustable-collar 1313, the installer may only have to push flangeless-trim-assembly 1501 into an internal-volume (of adjustable-collar 1313) until one or more connector(s) 1507 seat onto bottom ledge(s) of window(s) 1324 (and/or protrude over those bottom ledge9s) of window(s) 1324) of adjustable-collar 1313. See FIG. 15A, FIG. 15B, FIG. 15C, and FIG. 15D for flangeless-trim-assembly 1501; and see also FIG. 16A, FIG. 16B, and FIG. 16C for flangeless-trim-assembly 1501.

FIG. 16A is a top perspective exploded view of assembly 1500 showing adapter-assembly 1300 in a dissembled configuration (without dust-cover 1325) and showing flangeless-trim-assembly 1501 in an assembled configuration but separated from adapter-assembly 1300 components. FIG. 16B is a front exploded view (or a rear exploded view) of assembly 1500 showing adapter-assembly 1300 in a dissembled configuration (without dust-cover 1325) and showing flangeless-trim-assembly 1501 in an assembled configuration but separated from adapter-assembly 1300 components. FIG. 16C is a right-side exploded view (or a left-side exploded view) of assembly 1500 showing adapter-assembly 1300 in a dissembled configuration (without dust-cover 1325) and showing flangeless-trim-assembly 1501 in an assembled configuration but separated from adapter-assembly 1300 components. In some embodiments, the exploded views of FIG. 16A, FIG. 16B, and/or FIG. 16C show that when the flangeless-trim-assembly 1501 is (removably) connected to adjustable-collar 1313, that the exterior (rectangular) sidewall of the lower portion of flangeless-trim-assembly 1501 (below the articulation-means 1503) where the connectors 1507 are located may fit inside of adjustable-collar 1313, with that exterior (rectangular) sidewall of the lower portion of flangeless-trim-assembly 1501 (below the articulation-means 1503) where the connectors 1507 are located, fitting inside of upper-sidewall 1315 and with the connectors 1507 located above bottom ledges of windows 1324 (and/or above ledge 1318) when flangeless-trim-assembly 1501 is (removably) connected to adjustable-collar 1313. In some embodiments, the exploded views of FIG. 16A, FIG. 16B, and/or FIG. 16C show that when adjustable-collar 1313 is (removably) connected to annular-disk 1301, that adjustable-collar 1313 may up and/or inside of collar 1305, and then a given mechanical-fastener 1311 may be connected to a given hole 1309 and connected to a given slot 1321 on one side of adapter-assembly 1300.

FIG. 17A may be a right-side view (or left-side view) of assembly 1500 wherein assembly 1500 may be fixedly attached to a section (portion and/or region) of a ceiling 300. Specifically, adapter-assembly 1300 (of assembly 1500) may be fixedly attached to a section (portion and/or region [e.g., a top side]) of a ceiling 300. FIG. 17A also includes sectional-line 17B-17B. In some embodiments, adapter-assembly 1300 (with or without dust-cover 1325) may be configured to be (fixedly) attached to ceiling 300. In some embodiments, aperture(s) 1303 of annular-disk 1301 (via mechanical-fastener(s) 303 fitting into aperture(s) 1303 and into material of ceiling 300) may be configured to be (fixedly) attached to ceiling 300. In some embodiments, a bottom surface portion of annular-disk 1301 may be configured to be (fixedly) attached to a top surface of ceiling 300. In some embodiments, a bottom surface portion of annular-disk 1301 may be in direct physical contact with a top surface of ceiling 300. FIG. 17A shows annular-disk 1301 (via its aperture(s) 1303) that is fixedly attached to ceiling 300. FIG. 17A shows a bottom surface portion of a given annular-disk 1301 that is fixedly attached to a top portion of ceiling 300. FIG. 17A shows a bottom surface portion of a given annular-disk 1301 is in direct physical contact with a top portion of ceiling 300.

FIG. 17B may be a cross-sectional view through sectional-line 17B-17B of FIG. 17A. FIG. 17B may show a cross-sectional view through assembly 1500 and through a portion (section and/or region) of ceiling 300. FIG. 17B shows a bottom surface portion of a given annular-disk 1301 is in direct physical contact with a top portion of ceiling 300. FIG. 17B shows a bottom surface portion of a given annular-disk 1301 that is fixedly attached to a top portion of ceiling 300 using a mechanical-fastener 303 passing at least partially through a given aperture 1303 (of annular-disk 1301) and wherein a bottom portion of that same mechanical-fastener 303 may be driven into material of ceiling 300. In some embodiments, assembly 1500, flangeless-trim-subassembly 1501, and/or adapter-assembly 1300 may comprise at least one mechanical-fastener 303 per a quantity of aperture(s) 1303 of adapter-assembly 1300 and/or of annular-disk 1301. In some embodiments, mechanical-fastener 303 may fixedly attach to annular-disk 1301 (via a given aperture 1303 that the mechanical-fastener 303 at least partially passes through) to a top portion of ceiling 300. In some embodiments, at least a portion of mechanical-fastener 303 may pass through annular-disk 1301 (via a given aperture 1303 that the mechanical-fastener 303 at least partially passes through); and another portion of that same mechanical-fastener 303 may pass into material of ceiling 300 (anchoring into ceiling 300). In some embodiments, a total length of mechanical-fastener 303 may be configured to be less than thickness 301 (thickness 301 may be a thickness of ceiling 300). In some embodiments, mechanical-fastener 303 may enter annular-disk 1301 (via a given aperture 1303) and ceiling 300 from a top (upper) side of ceiling 300. FIG. 17B shows mechanical-fasteners 303 are used to secure annular-disk 1301 (via its aperture(s) 1303) to a top portion of ceiling 300 (e.g., by using at least one mechanical-fastener 303 per at least some of the aperture(s) 1303). In some embodiments, mechanical-fastener 303 may not enter ceiling 300 and annular-disk 1301 (via a given aperture 1303) from a bottom (under) side of ceiling 300.

Note, in some embodiments, dust-cover 825 may be intentionally omitted from/in assembly-of-adapter-and-trim 1000; and/or dust-cover 825 may be intentionally omitted in FIGS. 10A through 12B, because in order to incorporate flangeless-trim-assembly 1001 into assembly-of-adapter-and-trim 1000, then dust-cover 825 must be removed (from adjustable-collar 813) to make room for flangeless-trim-assembly 1001.

Note, in some embodiments, dust-cover 1325 may be intentionally omitted from/in assembly-of-adapter-and-trim 1500; and/or dust-cover 1325 may be intentionally omitted in FIGS. 15A through 17B, because in order to incorporate flangeless-trim-assembly 1501 into assembly-of-adapter-and-trim 1500, then dust-cover 1325 must be removed (from adjustable-collar 1313) to make room for flangeless-trim-assembly 1501.

Because adapter 400, adapter 501, adapter-assembly 800, and/or adapter-assembly 1300 all have means (e.g., their respective vertical slots and complementary mechanical-fasteners) for adjusting to different thicknesses 301 of ceilings 300, then adapter 400, adapter 501, adapter-assembly 800, and/or adapter-assembly 1300 may all be used on ceilings 300 of different thicknesses 301 (within a predetermined range of ceilings 300 thicknesses 301).

In some embodiments, exterior and/or interior surfaces of sidewall 415, upper-sidewall 417, lower-sidewall 419, sidewall 509, flange-with-collar-member 801, collar 805, adjustable-collar 813 (except for guides 823), upper-sidewall 815 (except for guides 823), lower-sidewall 817, flange-with-collar-member 1301, collar 1305, adjustable-collar 1313 (except for guides 1323), upper-sidewall 1315 (except for guides 1323), and/or lower-sidewall 1317 may be free (devoid) of (orthogonal): projections, extrusions, extensions, bumps, humps, ridges, fins, nodules, and/or the like of material.

In some embodiments, aside from horizontal-slot(s) 407 and vertical-slot(s) 409, exterior and/or interior surfaces of sidewall 415, upper-sidewall 417, and/or lower-sidewall 419 may be free (devoid) of: hole, slots, slits, cutouts, and/or the like.

In some embodiments, aside from aperture(s) 513 and aperture(s) 514, exterior and/or interior surfaces of sidewall 509 may be free (devoid) of: hole, slots, slits, cutouts, and/or the like.

In some embodiments, aside from aperture(s) 803, exterior and/or interior surfaces of the flange-region of flange-with-collar-member 801 may be free (devoid) of: hole, slots, slits, cutouts, and/or the like.

In some embodiments, aside from hole(s) 809, exterior and/or interior surfaces of collar 805 may be free (devoid) of: hole, slots, slits, cutouts, and/or the like.

In some embodiments, aside from vertical-slot(s) 821, exterior and/or interior surfaces of adjustable-collar 813 may be free (devoid) of: hole, slots, slits, cutouts, and/or the like.

In some embodiments, aside from aperture(s) 1303, exterior and/or interior surfaces of the flange-region of flange-with-collar-member 1301 may be free (devoid) of: hole, slots, slits, cutouts, and/or the like.

In some embodiments, aside from hole(s) 1309, exterior and/or interior surfaces of collar 1305 may be free (devoid) of: hole, slots, slits, cutouts, and/or the like.

In some embodiments, aside from vertical-slot(s) 1321, exterior and/or interior surfaces of adjustable-collar 1313 may be free (devoid) of: hole, slots, slits, cutouts, and/or the like.

In some embodiments, exterior and/or interior surfaces of sidewall 415, upper-sidewall 417, lower-sidewall 419, sidewall 509, flange-with-collar-member 801, collar 805, adjustable-collar 813, upper-sidewall 815, lower-sidewall 817, flange-with-collar-member 1301, collar 1305, adjustable-collar 1313, upper-sidewall 1315, and/or lower-sidewall 1317 may be at least substantially (mostly) smooth, uniform, consistent, continuous, and/or unbroken.

Note, ceiling 300 may be a structural wall or a wood wall, in some embodiments.

In some embodiments, adapter 400 and/or 501 (adapter 400/501) may be configured to be (removably) attached to a given flangeless-trim-subassembly 101 and/or 551 (flangeless-trim-subassembly 101/551); and/or adapter 400/501 may be configured to be (removably) attached to at least a section (region/portion) of a given structural-ceiling 300. In some embodiments, the structural-ceiling 300 may be at least partially made out of wood. In some embodiments, the structural-ceiling 300 may be a wood ceiling. In some embodiments, adapter 400/501 may comprise one sleeve 401 and/or 503 (sleeve 401/503) and at least one L-bracket 403 and/or 515 (L-bracket 403/515). In some embodiments, adapter 400/501 may comprise one sleeve 401/503, at least one L-bracket 403/515, and at least one mechanical-fastener 405 and/or 529 (mechanical-fastener 405/529). In some embodiments, adapter 400/501 may comprise one sleeve 401/503, at least one L-bracket 403/515, and at least one mechanical-fastener 303. In some embodiments, adapter 400/501 may comprise one sleeve 401/503, at least one L-bracket 403/515, at least one mechanical-fastener 405/529, and at least one mechanical-fastener 303.

In some embodiments, sleeve 401/503 may be configured to house at least a majority of the flangeless-trim-subassembly 101/551 within a hollow interior volume of sleeve 401/503. In some embodiments, sleeve 401/503 may comprise this hollow interior volume. In some embodiments, sleeve 401/503 may comprise at least one sidewall 415 and/or 509 (sidewall 415/509). In some embodiments, the at least one sidewall 415/509 may at least substantially enclose the at least the majority of the flangeless-trim-subassembly 101/551 around (vertical) sides of the at least the majority of the flangeless-trim-subassembly 101/551. In some embodiments, sleeve 401/503 may comprise structure(s) (geometry) that is/are configured to receive an element of the flangeless-trim-subassembly 101/551 for attaching the flangeless-trim-subassembly 101/551 to sleeve 401/503.

In some embodiments, at least one L-bracket 403/515 may comprise a first-portion 423 and/or 517 (first-portion 423/517) and a second-portion 425 and/or 521 (second-portion 425/521). In some embodiments, first-portion 423/517 may be configured to be (removably and fixedly) attached to the structural-ceiling 300 (e.g., along with using at least one mechanical-fastener 303 for making that fixed attachment). In some embodiments, second-portion 425/521 may be configured to be (removably and vertically adjustably) attached to sleeve 401/503 (e.g., along with using at least one mechanical-fastener 405/529 for making that attachment). In some embodiments, the first-portion 423/517, of the at least one L-bracket 403/515, may be a horizontal-portion 423/517; and/or the second-portion 425/521, of the at least one L-bracket 403/515, may be a vertical-portion 425/521. In some embodiments, the at least one L-bracket 403/515 may comprise a linkage-portion 427 and/or 527 (linkage-portion 427/527). In some embodiments, the linkage-portion 427/527 joins the first-portion 423/517 to the second-portion 425/521. In some embodiments, the first-portion 423/517, of the at least one L-bracket 403/515, may comprise at least one through-hole 429 and/or 519 (through-hole 429/519) that is configured to receive at least a portion of a mechanical-fastener 303 therein for a purpose of securing the first-portion 423/517 to the structural-ceiling 300. In some embodiments, another portion of the mechanical-fastener 303 may pass (screw and/or anchor) into the structural-ceiling 300. In some embodiments, the second-portion 425/521, of the at least one L-bracket 403/515, may comprise at least one vertical-slot 433 and/or 525 (vertical-slot 433/525) that is configured to receive at least a portion of a mechanical-fastener 405/529 therein for a purpose of securing the second-portion 425/521 to sleeve 401/503. In some embodiments, another portion of the mechanical-fastener 405/529 passes into (through) (a sidewall of) sleeve 401/503. In some embodiments, the at least one vertical-slot 433/525, of the at least one L-bracket 403/515, may be configured to permit vertical sliding adjustment between sleeve 401/503 and the at least one L-bracket 403/515; however, once a desired vertical adjustment has been made, as between the L-bracket 403/515 and the sleeve 401/503, then that particular set desired vertical adjustment may be secured (fixed) so that no further vertical adjustment is possible (e.g., by tightening mechanical-fastener 405/529).

In some embodiments, with respect to adapter 400 and not adapter 501, the structure(s) (geometry) of sleeve 401, that may be configured to receive the element of the flangeless-trim-subassembly 101, may be at least one horizontal-slot 407 that may run in an at least substantially (mostly) horizontal direction on the at least one sidewall 415. In some embodiments, the element of the flangeless-trim-subassembly 101 may be at least one spring-clip 105 that is capable of fitting onto a bottom edge of the at least one horizontal-slot 407; and in some embodiments, the at least one horizontal-slot 407 may comprise this bottom edge. In some embodiments, the at least one sidewall 415 may comprise an upper-sidewall 417 and a lower-sidewall 419. In some embodiments, the at least one horizontal-slot 407 may be located in the lower-sidewall 419 below the upper-sidewall 417 and/or below transition 421. In some embodiments, the upper-sidewall 417 may be thicker than the lower-sidewall 419. In some embodiments, sleeve 401 may be at least a substantially (mostly) cylindrical member such that the at least one sidewall 415 may form a substantially cylindrical shape. In some embodiments, sleeve 401 may comprise at least one vertical-slot 409 that may run in an at least substantially (mostly) vertical direction on the at least one sidewall 415. In some embodiments, the at least one vertical-slot 409 may be configured to receive therein a linkage-portion 427 of the at least one L-bracket 403. In some embodiments, the at least one L-bracket 403 may comprise this linkage-portion 427. In some embodiments, the first-portion 423 may be located to an exterior of sleeve 401 (when L-bracket 403 may be in intended communication with sleeve 401). In some embodiments, the second-portion 425 may be located at least partially within the hollow interior volume of sleeve 401 (when L-bracket 403 may be in intended communication with sleeve 401). In some embodiments, the second-portion 425 may be located at least partially inside of sleeve 401 (when L-bracket 403 may be in intended communication with sleeve 401).

In some embodiments, with respect to adapter 501 and not adapter 400, sleeve 503 may be a substantially rectangular prism member such that the at least one sidewall 509 may be four sidewalls that forms a substantially rectangular prism shape. In some embodiments, the structure of sleeve 503, that may be configured to receive the element of the flangeless-trim-subassembly 551, may be at least one aperture 514 that is located in the at least one sidewall 509. In some embodiments, the element of the flangeless-trim-subassembly 551 is at least one connector 557 that is capable of fitting at least partially into the at least one aperture 514 (as in a ball in socket joint or the like).

In some embodiments, adapter 800 and/or 1300 (adapter 800/1300) may be configured to be (removably) attached to a flangeless-trim-subassembly 1001 and/or 1501 (flangeless-trim-subassembly 1001/1501) (and wherein adapter 800/1300 and flangeless-trim-subassembly 1001/1501 are vertically adjustable with respect to each other); and/or adapter 800/1300 may be configured to be (removably and fixedly) attached to at least a section (region/portion) of a given structural-ceiling 300. In some embodiments, adapter 800/1300 may comprise one flange-with-collar-member 801 and/or 1301 (flange-with-collar-member 801/1301) and one adjustable-collar-member 813 and/or 1313 (adjustable-collar-member 813/1313). In some embodiments, adapter 800/1300 may comprise one flange-with-collar-member 801/1301, one adjustable-collar-member 813/1313, and at least one mechanical-fastener 811 and/or 1311 (mechanical-fastener 811/1311). In some embodiments, adapter 800/1300 may comprise one flange-with-collar-member 801/1301, one adjustable-collar-member 813/1313, and at least one mechanical-fastener 303. In some embodiments, adapter 800/1300 may comprise one flange-with-collar-member 801/1301, one adjustable-collar-member 813/1313, at least one mechanical-fastener 811/1311, and at least one mechanical-fastener 303. In some embodiments, the flange-with-collar-member 801/1301 may comprise a flange-region and a collar-region 805 and/or 1305 (collar-region 805/1305). Note, reference numeral 801 may refer to the entire component part with its flange-region and its collar-region 805; or reference numeral 801 may refer to just the flange-region of flange-with-collar-member 801. Note, reference numeral 1301 may refer to the entire component part with its flange-region and its collar-region 1305; or reference numeral 1301 may refer to just the flange-region of flange-with-collar-member 1301. In some embodiments, the flange-region may be at least substantially flat (planar) and with a flange shape surrounding a largest-central-hole 802 and/or 1302 (largest-central-hole 802/1302) of the flange-with-collar-member 801/1301. In some embodiments, the flange-region may be configured to be fixedly attached the structural-ceiling 300 (e.g., via mechanical-fastener(s) 303). In some embodiments, the collar-region 805/1305 may be a sidewall (or at least one sidewall) that extends orthogonally upwards from the flange-region at the largest-central-hole 802/1302. In some embodiments, the collar-region 805/1305 may comprise at least one tab 807 and/or 1307 (tab 807/1307) with at least one hole 809 and/or 1309 (hole 809/1309). In some embodiments, the at least one tab 807/1307 may extend upwards from a top of the sidewall(s) (of the collar-region 805/1305). In some embodiments, adjustable-collar-member 813/1313 may comprise an upper-sidewall 815 and/or 1315 (upper-sidewall 815/1315) and a lower-sidewall 817 and/or 1317 (lower-sidewall 817/1317). In some embodiments, a transverse-dimension and/or a diameter of the upper-sidewall 815/1315 is larger than a transverse-dimension and/or a diameter of the lower-sidewall 817/1317. In some embodiments, extending from a top of (the uniform height portion of) the upper-sidewall 815/1315 is at least one protrusion 819 and/or 1319 (protrusion 819/1319). In some embodiments, the at least one protrusion 819/1319 is configured to be attached to the at least one hole 809/1309 of the at least one tab 807/1307 (via vertical-slot(s) 821/1321 and mechanical-fastener(s) 811/1311). In some embodiments, the adjustable-collar-member 813/1313 may comprise the at least one protrusion 819/1319. In some embodiments, the adjustable-collar-member 813/1313 (lower-sidewall 817/1317) may comprise structure(s) (geometry) that is configured to receive an element of a given flangeless-trim-subassembly 1001/1501 for (removably) attaching that flangeless-trim-subassembly 1001/1501 to the adjustable-collar-member 813/1313. In some embodiments, the flange-region (of flange-with-collar-member 801/1301) may comprise at least one aperture 803 and/or 1303 (aperture 803/1303) that is configured to receive at least a portion of a mechanical-fastener 303 therein for a purpose of securing that flange-region to the structural-ceiling 300; and in some embodiments, another portion of that mechanical-fastener 303 may pass (screw and/or anchor) into that structural-ceiling 300. In some embodiments, the at least one protrusion 819/1319 may comprise at least one vertical-slot 821 and/or 1321 (vertical-slot 821/1321). In some embodiments, the at least one vertical-slot 821/1321 is configured to receive at least a portion of a mechanical-fastener 811/1311 therein for a purpose of securing the at least one protrusion 819/1319 to the at least one tab 807/1307; and/or in some embodiments, another portion of that mechanical-fastener 811/1311 may pass into (through) the at least one hole 809/1309 of the at least one tab 807/1307. In some embodiments, the at least one vertical-slot 821/1321 is configured to permit vertical sliding adjustment between the flange-with-collar-member 801/1301 and the adjustable-collar-member 813/1313; however, once a desired vertical adjustment has been made, as between the tab 807/1307 and the protrusion 819/1319, then that particular set desired vertical adjustment may be secured (fixed) so that no further vertical adjustment is possible (e.g., by tightening mechanical-fastener 811/1311).

In some embodiments, the at least one protrusion 819/1319 may comprise at least one pair of guides (fences) 823 and/or 1323 (guides 823/1323). In some embodiments, the at least one pair of guides 823/1323 is configured to receive in between the at least one pair of guides 823/1323 at least a portion of the at least one tab 807/1307. In some embodiments, these pair of guides 823/1323 may facilitate vertical alignment and/or vertical sliding adjustment as between the tab 807/1307 and the protrusion 819/1319 (as between collar-region 805/1305 and upper-sidewall 815/1315) (or as between flange-with-collar-member 801/1301 and adjustable-collar-member 813/1313). In some embodiments, the structure of the adjustable-collar-member 813/1313, that is configured to receive the element of the flangeless-trim-subassembly 1001/1501, may be a ledge 818 and/or 1318 (ledge 818/1318) formed by a transition from (between) the lower-sidewall 817/1317 to (and) the upper-sidewall 815/1315. In some embodiments, the element of the flangeless-trim-subassembly 1001/1501 is at least one connector 1007 and/or 1507 (connector 1007/1507) that is capable of (removably) fitting at least partially onto the ledge 818/1318.

In some embodiments, the adapter 800/1300 may (optionally) comprise a (removable) dust-cover 825 and/or 1325 (dust-cover 825/1325) that is configured to be removably attached to the adjustable-collar-member 813/1313 via at least one prong 829 and/or 1329 (prong 829/1329) of the dust-cover 825/1325. In some embodiments, the at least one prong 829/1329 is configured to removably engage (attach to) the structure (e.g., ledge 818/1318 and/or window 1324) of the adjustable-collar-member 813/1313. In some embodiments, dust-cover 825/1325 may comprise the at least one prong 829/1329. In some embodiments, when the adapter 800/1300 may include dust-cover 825/1325, then dust-cover 825/1325 must be removed (from adjustable-collar-member 813/1313 [lower-sidewall 817/1317]) before attaching the adjustable-collar-member 813/1313 (lower-sidewall 817/1317) to flangeless-trim-subassembly 1001/1501.

In some embodiments, the flange-region and the collar-region 805/1305 are integral with each other, such that the flange-with-collar-member 801/1301 is a single article of manufacture. In some embodiments, the upper-sidewall 815/1315 and the lower-sidewall 817/1317 are integral with each other, such that the adjustable-collar-member 813/1313 is a single article of manufacture. In some embodiments, the flange-with-collar-member 801/1301 and the adjustable-collar-member 813/1313 are two separate component parts of the adapter 800/1300 (that are removably attachable to each other and/or that are vertically slidingly adjustable with each other).

In some embodiments, the at least one hole 809/1309 of the at least one tab 807/1307 and at least one vertical-slot 821/1321 of the at least one protrusion 819/1319 may be in vertical alignment with each other (e.g., when the flange-with-collar-member 801/1301 is removably attached to the adjustable-collar-member 813/1313). In some embodiments, at least two of the following may be in vertical alignment with each other: the at least one hole 809/1309 of the at least one tab 807/1307, at least one vertical-slot 821/1321 of the at least one protrusion 819/1319, or at least one window 1324 of the lower-sidewall 817/1317-e.g., when the flange-with-collar-member 801/1301 is removably attached to the adjustable-collar-member 813/1313.

In some embodiments, with respect to adapter 1300 but not adapter 800, the structure of the adjustable-collar-member 1313, that is configured to receive the element of the flangeless-trim-subassembly 1501, is at least one window 1324 located in the lower-sidewall 1317. In some embodiments, the element of the flangeless-trim-subassembly 1501 may be at least one connector 1507 that is capable of fitting onto a bottom edge of the at least one window 1324, wherein the at least one window 1324 comprises that bottom edge. In some embodiments, an outside perimeter of the flange-region (of flange-with-collar-member 1301) may be a parallelogram (square, rectangle, or the like) shape and the collar-region 1305 may be at least a substantially rectangular prism shape (e.g., with four sidewalls). In some embodiments, with respect to adapter 1300 but not adapter 800, the adjustable-collar-member 1313 may be at least substantially shaped as a hollow rectangular prism (e.g., formed from two rectangular prism sidewalls, rectangular prism upper-sidewall 1315 and rectangular prism lower-sidewall 1317).

In some embodiments, with respect to adapter 800 but not adapter 1300, an outside perimeter of the flange-region (of flange-with-collar-member 801) may be a circular shape and the collar-region 805 may be at least a substantially cylindrical shape (e.g., with a single cylindrical sidewall). In some embodiments, with respect to adapter 800 but not adapter 1300, the adjustable-collar-member 813 may be at least substantially cylindrical in shape (e.g., formed from two cylindrical sidewalls, cylindrical upper-sidewall 815 and cylindrical lower-sidewall 817).

In some embodiments, a system (kit) may comprise at least one assembly 100. In some embodiments, a system (kit) may comprise at least one adapter 400 and at least one flangeless-trim-subassembly 101. In some embodiments, a system (kit) may comprise at least one assembly 500. In some embodiments, a system (kit) may comprise at least one adapter 501 and at least one flangeless-trim-subassembly 551. In some embodiments, a system (kit) may comprise at least one assembly 1000. In some embodiments, a system (kit) may comprise at least one adapter 800 and at least one flangeless-trim-subassembly 1001. In some embodiments, a system (kit) may comprise at least one assembly 1500. In some embodiments, a system (kit) may comprise at least one adapter 1300 and at least one flangeless-trim-subassembly 1501.

Adapters for use with structural ceilings, like wood ceilings, for use in recessed lighting applications with flangeless-trim-assemblies, as well as, systems (kits) that comprise such adapter(s) have been described. The foregoing description of the various exemplary embodiments of the invention has been presented for the purposes of illustration and disclosure. It is not intended to be exhaustive or to limit the invention to the precise form disclosed. Many modifications and variations are possible in light of the above teaching without departing from the spirit of the invention.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. An adapter that is configured to be attached to a flangeless-trim-subassembly and that is configured to be attached to a structural-ceiling, wherein the adapter comprises:
a sleeve that is configured to house at least a majority of the flangeless-trim-subassembly within a hollow interior volume of the sleeve, wherein the sleeve comprises the hollow interior volume, wherein the sleeve comprises at least one sidewall, wherein the at least one sidewall at least substantially encloses the at least the majority of the flangeless-trim-subassembly around sides of the at least the majority of the flangeless-trim-subassembly, wherein the sleeve comprises structure that is configured to receive an element of the flangeless-trim-subassembly for attaching the flangeless-trim-subassembly to the sleeve; and
at least one L-bracket that comprises a first-portion and a second-portion, wherein the first-portion is configured to be attached to the structural-ceiling, wherein the second-portion is configured to be attached to the sleeve.

2. The adapter according to claim 1, wherein the structure of the sleeve, that is configured to receive the element of the flangeless-trim-subassembly, is at least one horizontal-slot that runs in an at least substantially horizontal direction on the at least one sidewall.

3. The adapter according to claim 2, wherein the element of the flangeless-trim-subassembly is at least one spring-clip that is capable of fitting onto a bottom edge of the at least one horizontal-slot, wherein the at least one horizontal-slot comprises the bottom edge.

4. The adapter according to claim 2, wherein the at least one sidewall comprises an upper-sidewall and a lower-sidewall, wherein the at least one horizontal-slot is located in the lower-sidewall below the upper-sidewall.

5. The adapter according to claim 1, wherein the at least one sidewall comprises an upper-sidewall and a lower-sidewall, wherein the upper-sidewall is thicker than the lower-sidewall.

6. The adapter according to claim 1, wherein the sleeve is a substantially cylindrical member such that the at least one sidewall forms a substantially cylindrical shape.

7. The adapter according to claim 1, wherein the sleeve comprises at least one vertical-slot that runs in an at least substantially vertical direction on the at least one sidewall.

8. The adapter according to claim 7, wherein the at least one vertical-slot is configured to receive therein a linkage-portion of the at least one L-bracket, wherein the at least one L-bracket comprises the linkage-portion.

9. The adapter according to claim 1, wherein the first-portion, of the at least one L-bracket, is a horizontal-portion; and the second-portion, of the at least one L-bracket, is a vertical-portion.

10. The adapter according to claim 1, wherein the at least one L-bracket comprises a linkage-portion, wherein the linkage-portion joins the first-portion to the second-portion.

11. The adapter according to claim 10, wherein the first-portion is located to an exterior of the sleeve, wherein the second-portion is located at least partially within the hollow interior volume of the sleeve.

12. The adapter according to claim 1, wherein the first-portion, of the at least one L-bracket, comprises at least one through-hole that is configured to receive at least a portion of a mechanical-fastener therein for a purpose of securing the first-portion to the structural-ceiling, wherein another portion of the mechanical-fastener passes into the structural-ceiling.

13. The adapter according to claim 1, wherein the second-portion, of the at least one L-bracket, comprises at least one vertical-slot that is configured to receive at least a portion of a mechanical-fastener therein for a purpose of securing the second-portion to the sleeve, wherein another portion of the mechanical-fastener passes into the sleeve.

14. The adapter according to claim 13, wherein the at least one vertical-slot, of the at least one L-bracket, is configured to permit vertical sliding adjustment between the sleeve and the at least one L-bracket.

15. The adapter according to claim 1, wherein the sleeve is a substantially rectangular prism member such that the at least one sidewall is four sidewalls that forms a substantially rectangular prism shape.

16. The adapter according to claim 1, wherein the structure of the sleeve, that is configured to receive the element of the flangeless-trim-subassembly, is at least one aperture that is located in the at least one sidewall.

17. The adapter according to claim 16, wherein the element of the flangeless-trim-subassembly is at least one connector that is capable of fitting at least partially into the at least one aperture.

18. The adapter according to claim 1, wherein the structural-ceiling is at least partially made out of wood.

19. An adapter that is configured to be attached to a flangeless-trim-subassembly and that is configured to be attached to a structural-ceiling, wherein the adapter comprises:
a flange-with-collar-member, wherein the flange-with-collar-member comprises a flange-region and a collar-region, wherein the flange-region is at least substantially flat and with a flange shape surrounding a largest-central-hole of the flange-with-collar-member, wherein the flange-region is configured to be fixedly attached the structural-ceiling; wherein the collar-region is a sidewall that extends orthogonally upwards from the flange-region at the largest-central-hole, wherein the collar-region comprises at least one tab with at least one hole, wherein the at least one tab extends upwards from a top of the sidewall; and
an adjustable-collar-member that comprises an upper-sidewall and a lower-sidewall, wherein a transverse-dimension of the upper-sidewall is larger than a transverse-dimension of the lower-sidewall, wherein extending from a top of the upper-sidewall is at least one protrusion, wherein the at least one protrusion is configured to be attached to the at least one hole of the at least one tab, wherein the adjustable-collar-member comprises the at least one protrusion;
wherein the adjustable-collar-member comprises structure that is configured to receive an element of the flangeless-trim-subassembly for attaching the flangeless-trim-subassembly to the adjustable-collar-member.

20. The adapter according to claim 19, wherein the flange-region comprises at least one aperture that is configured to receive at least a portion of a mechanical-fastener therein for a purpose of securing the flange-region to the structural-ceiling, wherein another portion of the mechanical-fastener passes into the structural-ceiling.

21. The adapter according to claim 19, wherein the at least one protrusion comprises at least one vertical-slot.

22. The adapter according to claim 21, wherein the at least one vertical-slot is configured to receive at least a portion of a mechanical-fastener therein for a purpose of securing the at least one protrusion to the at least one tab, wherein another portion of the mechanical-fastener passes into the at least one hole of the at least one tab.

23. The adapter according to claim 22, wherein the at least one vertical-slot is configured to permit vertical sliding adjustment between the flange-with-collar-member and the adjustable-collar-member.

24. The adapter according to claim 19, wherein the at least one protrusion comprises at least one pair of guides.

25. The adapter according to claim 24, wherein the at least one pair of guides is configured to receive in between the at least one pair of guides at least a portion of the at least one tab.

26. The adapter according to claim 19, wherein the structure of the adjustable-collar-member, that is configured to receive the element of the flangeless-trim-subassembly, is a ledge formed by a transition from the lower-sidewall to the upper-sidewall.

27. The adapter according to claim 26, wherein the element of the flangeless-trim-subassembly is at least one connector that is capable of fitting at least partially onto the ledge.

28. The adapter according to claim 19, wherein the adapter further comprises a dust-cover that is configured to be removably attached to the adjustable-collar-member via at least one prong of the dust-cover.

29. The adapter according to claim 28, wherein the at least one prong is configured to removably engage the structure of the adjustable-collar-member.

30. The adapter according to claim 19, wherein the flange-region and the collar-region are integral with each other, such that the flange-with-collar-member is a single article of manufacture.

31. The adapter according to claim 19, wherein the upper-sidewall and the lower-sidewall are integral with each other, such that the adjustable-collar-member is a single article of manufacture.

32. The adapter according to claim 19, wherein the flange-with-collar-member and the adjustable-collar-member are two separate component parts of the adapter.

33. The adapter according to claim 19, wherein the at least one hole of the at least one tab and at least one vertical-slot of the at least one protrusion are in vertical alignment with each other.

34. The adapter according to claim 19, wherein at least two of the following are in vertical alignment with each other: the at least one hole of the at least one tab, at least one vertical-slot of the at least one protrusion, or at least one window of the lower-sidewall.

35. The adapter according to claim 19, wherein the structure of the adjustable-collar-member, that is configured to receive the element of the flangeless-trim-subassembly, is at least one window located in the lower-sidewall.

36. The adapter according to claim 35, wherein the element of the flangeless-trim-subassembly is at least one connector that is capable of fitting onto a bottom edge of the at least one window, wherein the at least one window comprises the bottom edge.

37. The adapter according to claim 19, wherein an outside perimeter of the flange-region is a parallelogram shape and the collar-region is at least a substantially rectangular prism shape.

38. The adapter according to claim 19, wherein an outside perimeter of the flange-region is a circular shape and the collar-region is at least a substantially cylindrical shape.
